(19) United States
(12) Patent Application Publication
(10) Pub. No.: US 2007/0172605 A1
(43) Pub. Date: Jul. 26, 2007

(54) Cellulose acylate film, polarizing plate and liquid crystal display

(75) Inventors: Sumio Ohtani, Minami-Ashigara-shi (JP); Hiroyuki Kawanishi, Minami-Ashigara-shi (JP); Yosuke Nishiura, Odawara-shi (JP); Takako Nishiura, Odawara-shi (JP)

Correspondence Address: BUCHANAN, INGERSOLL & ROONEY PC, POST OFFICE BOX 1404, ALEXANDRIA, VA, 22313-1404, US

(73) Assignee: FUJI PHOTO FILM CO., LTD., Minami-ashigara-shi (JP)

(21) Appl. No.: 10/590,655

(22) PCT Filed: Feb. 24, 2005
(86) PCT No.: PCT/JP05/03544

§ 371 Date: Feb. 20, 2007

(30) Foreign Application Priority Data
Feb. 25, 2004 (JP) 2004-049142
Jun. 14, 2004 (JP) 2004-175077

(51) Int. Cl. C09K 19/00

(52) U.S. Cl. 428/1.31

(57) ABSTRACT

To provide a cellulose acylate film which exhibits excellent retardation values both in the film plane and along the direction perpendicular to the film plane, and undergoes less change in the retardation values by environmental humidity, and a polarizing plate using this film, a polarizing plate using the film, and a liquid crystal display undergoing less change in viewing angle characteristics, the cellulose acylate film satisfies formulae (I), (II), (V) and (VI), wherein Re(630) and Rth(630) is defined in the specification:
2.00≦DS2+DS3+DS6≦3.00 (I)
DS6/(DS2+DS3+DS6)≧0.315 (II)
46≦Re(630)≦200 (V)
70≦Rth(630)≦350 (VI)

### TECHNICAL FIELD

The present invention relates to a cellulose acylate film, and a polarizing plate and a liquid crystal display using the same.

### BACKGROUND ART

Liquid crystal displays are widely utilized for a personal computer, a monitor for a mobile device and a television for their various advantages such as that they can be driven at a low voltage and a low consumptive electric power and that they permit reduction in thickness. As to mode of such liquid crystal displays, various modes have been proposed which are different from each other in alignment state of liquid crystal within a liquid crystal cell. Heretofore, TN mode wherein liquid crystal molecules are aligned in an about 90° twisted state from the lower substrate of a liquid crystal cell toward the upper substrate thereof has been a main mode.

In general, a liquid crystal display is constituted by a liquid crystal cell, an optical compensatory sheet and a polarizer. The optical compensatory sheet is used for preventing coloration of an image or for enlarging a viewing angle and, as the optical compensatory sheet, a stretched birefringent film or a film comprising a transparent film having coated thereon a liquid crystal is used. For example, Japanese Patent No. 2,587,398 discloses a technique of enlarging a viewing angle by applying, to a TN mode liquid crystal cell, an optical compensatory sheet obtained by coating a discotic liquid crystal on a triacetyl cellulose film, orienting and fixing the liquid crystal. However, with liquid crystal displays to be used for large-sized televisions which are expected to view from various angles, requirement for viewing angle dependence is so strict that even the aforesaid technique still fails to satisfy the requirement. Thus, liquid crystal displays of a different mode from the TN mode, such as IPS (In-Plane Switching) mode, OCB (Optical Compensatory Bend) mode or VA (Vertically Aligned) mode, have been studied. In particular, liquid crystal displays of VA mode show a high contrast and can be produced in a comparatively high yield, thus having attracted attention as liquid crystal displays for use in TV.

A cellulose acylate film has a characteristic that, in comparison with other polymer films, it has a high optical isotropy (a low retardation value). Accordingly, a cellulose acetate film is usually used for uses requiring a high optical isotropy, such as a protective film for a polarizing plate.

On the other hand, an optical compensatory sheet (a retardation film) for a liquid crystal display requires a high optical anisotropy (a high retardation value). In particular, an optical compensatory sheet for VA requires an in-plane retardation (Re) of from 30 to 300 nm and a retardation in the thickness direction (Rth) of from 70 to 400 nm. Therefore, a synthetic film having a high retardation value, such as a polycarbonate film or a polysulfone film has usually been used as the optically compensatory sheet.

As is described above, it has been a generally accepted principle in the technical field of optical materials to use a synthetic polymer film in the case where an optical anisotropy (a high retardation value) is required for a polymer film and to use a cellulose acetate film in the case where an optical isotropy is required.

Exploding the conventional generally accepted principle, EP 0 911 656 A2 discloses a cellulose acetate film having an enough high retardation value to be used in the use where a high optical anisotropy is required. In the document, in order to realize a high retardation value using a cellulose triacetate film, an aromatic compound having at least 2 aromatic rings, in particular, a compound having a 1,3,5-triazine ring is added to the film, and the resulting film is stretched.

Generally, cellulose triacetate is a difficulty stretchable high molecular material and it is known to be difficult to impart a high birefringence to the material. In the document, a large birefringence can be obtained by simultaneously orienting the additive upon stretching, thus a high retardation value being realized. Since this film can also function as a protective film of a polarizing plate, it provides the advantage that an inexpensive thin liquid crystal display can be produced.

JP-A-2002-71957 discloses an optical film which contains a cellulose ester having an acyl group containing 2 to 4 carbon atoms as a substituent and satisfying formulae 2.0≦A+B≦3.0 and A≦2.4 at the same time wherein A represents a substitution degree by acetyl group and B represents a substitution degree by propionyl group or butyryl group, and which satisfies formula of 0.0005≦Nx−Ny≦0.0050 wherein Nx represents a refractive index of slow axis at a wavelength of 590 nm and Ny represents a refractive index of fast axis. JP-A-2002-270442 discloses a polarizing plate to be used in a VA mode liquid crystal display, which has a polarizer and an optically biaxial, mixed fatty acid cellulose ester film, with the optically biaxial, mixed fatty acid cellulose ester film being interposed between a liquid crystal cello and the polarizer.

The techniques described in the above-mentioned documents are advantageous in the point that they can provide an inexpensive and thin liquid crystal display. In recent years, however, a much higher retardation value has been required, and thus it has become necessary to increase the amount of the retardation-producing agent or to enhance stretching ratio. However, it has become difficult to realize a desired retardation value due to bleeding of the additive or breakage upon stretching. Also, liquid crystal displays have come to be used in many cases under various conditions, and the cellulose ester film obtained by the above-mentioned techniques has involved the problem that its optical compensatory function varies under such conditions. In particular, the cellulose ester film is influenced by surrounding changes, particularly change in humidity, upon its lamination onto a liquid crystal cell to suffer change in its Re retardation value and its Rth retardation value, leading to change in its optical compensatory ability. It has been desired to solve this problem.

### DISCLOSURE OF THE INVENTION

An object of the invention is to provide a cellulose acylate film exhibiting excellent retardation values both in the film plane and along the direction perpendicular to the film plane, and undergoing less change in the retardation values by environmental humidity, and a polarizing plate using this film.

Another object of the invention is to provide a liquid crystal display undergoing less change in viewing angle characteristics.

These objects are attained by the following means.

1. A cellulose acylate film, which comprises a cellulose acylate having a glucose unit of cellulose, wherein a hydroxyl group of the glucose unit is substituted by an acyl group having 2 or more carbon atoms,

wherein

DS2, DS3 and DS6 respectively representing degrees of substitution of the hydroxyl groups at 2, 3 and 6 positions of the glucose unit by the acyl group satisfy formulae (I) and (II), and

Re(λ) and Rth(λ) defined by formulae (III) and (IV) satisfy formulae (V) and (VI):
2.00≦DS2+DS3+DS6≦3.00 (I)
DS6/(DS2+DS3+DS6)≧0.315 (II)
Re(λ)=(nx−ny)×d (III)
Rth(λ)={(nx+ny)/2−nz}×d (IV)
46≦Re(630)≦200 (V)
70≦Rth(630)≦350 (VI)

wherein Re(λ) is a retardation value by nm in a film plane of the cellulose acylate film with respect to a light having a wavelength of λ nm;

Rth(λ) is a retardation value by mm in a direction perpendicular to the film plane of the cellulose acylate film with respect to the light having the wavelength of λ nm;

nx is a refractive index in a slow axis direction in the film plane;

ny is a refractive index in a fast axis direction in the film plane;

nz is a refractive index in the direction perpendicular the film plane; and

d is a thickness of the cellulose acylate film.

2. The cellulose acylate film as described in item 1, wherein Rth(λ) satisfies formula (VII):
160≦Rth(630)≦350 (VII)
3. The cellulose acylate film as described in item 1 or 2, wherein the acyl group is an acetyl group.
4. The cellulose acylate film as described in any one of items 1 to 3, which comprises a retardation-producing agent comprising one of a rod-like compound and a discotic compound.
5. The cellulose acylate film as described in any one of items 1 to 4, which comprises at least one of a plasticizer, an ultraviolet absorber and a peeling accelerator.
6. The cellulose acylate film as described in any one of items 1 to 5, which has a thickness of from 40 to 110 μm.
7. The cellulose acylate film as described in any one of items 1 to 6, which has an additive amount of from 10 to 30% by weight, the additive amount being based on a weight of the cellulose acylate.
8. The cellulose acylate film as described in any one of items 1 to 7, which has ΔRe of 12 nm or less and ΔRth of 32 nm or less, wherein ΔRe represents a difference between a Re value at 25° C. and 10% RH and another Re value at 25° C. and 80% RH, and ΔRth represents a difference between a Rth value at 25° C. and 10% RH and another Rth value at 25° C. and 80% RH.
9. The cellulose acylate film as described in any one of items 1 to 8, which has an equilibrium moisture content at 25° C. and 80% RH of 3.4% or less.
10. The cellulose acylate film as described in any one of items 1 to 9, which has a water vapor permeability of from 400 g/m²·24 hr to 2,300 g/m²·24 hr in terms of a film thickness of 80 μm, the water vapor permeability being measured at 60° C. and 95% RH for 24 hours.
11. The cellulose acylate film as described in any one of items 1 to 10, which undergoes change in weight of from 0 to 5% when allowed to stand for 48 hours under a condition of 80° C. and 90% RH.
12. The cellulose acylate film as described in any one of items 1 to 11, which undergoes change in dimension of from −2 to +2% when allowed to stand for 24 hours under each of a condition of 60° C. and 90% RH and another condition of 90° C. and 3% RH.
13. The cellulose acylate film as described in any one of items 1 to 12, which has a glass transition temperature Tg of from 80 to 180° C.
14. The cellulose acylate film as described in any one of items 1 to 13, which has an elastic modulus of from 1,500 to 5,000 MPa.
15. The cellulose acylate film as described in any one of items 1 to 14, which has a photoelastic coefficient of 50×10⁻³ cm²/dyne or less.
16. The cellulose acylate film as described in any one of items 1 to 14, which has a haze of from 0.01 to 2%.
17. The cellulose acylate film as described in any one of items 1 to 14, which comprises a silicon dioxide particle having a secondary average particle size of from 0.2 to 1.5 μm.
18. The cellulose acylate film as described in any one of items 1 to 17, wherein Re₍₆₃₀₎ and Rth₍₆₃₀₎ at 25° C. and 60% RH satisfy formulae (A) to (C):
46≦Re₍₆₃₀₎≦100 (A)
Rth₍₆₃₀₎=a−5.9Re₍₆₃₀₎ (B)
520≦a≦600 (C)
19. The cellulose acylate film as described in any one of items 1 to 18, wherein when Re and Rth measured at 25° C. and 60% RH with respect to different wavelengths satisfy formulae (D) and (E):
0.90≦Rth₍₄₅₀₎/Rth₍₅₅₀₎≦1.10 and 0.90≦Rth₍₆₅₀₎/Rth₍₅₅₀₎≦1.10 (D)
0.90≦Rth₍₄₅₀₎/Rth₍₅₅₀₎≦1.25 and 0.90≦Rth₍₆₅₀₎/Rth₍₅₅₀₎≦1.10 (E)
20. A polarizing plate comprising:

a polarizer; and

a protective film comprising a cellulose acylate film described in any one of items 1 to 19.

21. The polarizing plate as described in item 20, which satisfies at least one of formulae (a) to (d):
40.0≦TT≦45.0 (a)
30.0≦PT≦40.0 (b)
CT≦2.0 (c)
95.0≦P (d)

wherein TT represents a single plate transmittance at 25° C. and 60% RH;

PT represents a parallel transmittance at 25° C. and 60% RH;

CT represents a cross transmittance at 25° C. and 60% RH; and

P represents a polarization degree at 25° C. and 60% RH.

22. The polarizing plate as described in item 20 or 21, which satisfies at least one of formulae (e) to (g):
CT₍₃₈₀₎≦2.0 (e)
CT₍₄₁₀₎≦1.0 (f)
CT₍₇₀₀₎≦0.5 (g)

wherein CT(λ) represents a cross transmittance at the wavelength of λ nm.

23. The polarizing plate as described in any one of items 20 to 22, which satisfies at least one of formulae (j) and (k):
−6.0≦ΔCT≦6.0 (j)
−10.0≦ΔP≦0.0 (k)

wherein ΔCT and ΔP represents a change in cross transmittance and polarization degree, respectively, in a test that the polarizing plate is allowed to stand at 60° C. and 95% RH for 500 hours; and the change means a value calculated by subtracting a measurement value before the test from a measurement value after the test.

24. The polarizing plate as described in any one of items 20 to 23, which comprises at least one of a hard coat layer, an antiglare layer and an antireflective layer.

25. The polarizing plate as described in any one of items 20 to 24, which is packaged in a moisture-proofed bag, wherein the moisture-proofed bag has an internal humidity of from 43 to 70% RH at 25° C.

26. The polarizing plate as described in any one of items 20 to 204, which is packaged in a moisture-proofed bag, wherein the moisture-proofed bag has a first humidity within a range of ±15% RH with respect to a second humidity, when the polarizing plate is superposed on a liquid crystal cell at the second humidity.

27. A liquid crystal display comprising:

a liquid crystal cell of OCB-mode or VA-mode; and

at least one of a cellulose acylate film described in any one of items 1 to 19 and a polarizing plate described in any one of items 20 to 26.

28. The liquid crystal display as described in item 22, wherein the liquid crystal cell is a liquid crystal cell of VA-mode, and

the liquid crystal display contains only one cellulose acylate film described in any one of items 1 to 19 or only one polarizing plate described in any one of items 20 to 26.

29. The liquid crystal display as described in item 27, which comprises a backlight,

wherein the liquid crystal cell is a liquid crystal cell of VA-mode, and

the at least one of the cellulose acylate film and the polarizing plate is between the liquid crystal cell and the backlight.

### ADVANTAGES OF THE INVENTION

The polarizing plate of the invention shows excellent retardation values both in the film plane and along the direction perpendicular to the film plane.

Also, the liquid crystal display of the invention undergoes less change in viewing angle characteristics.

### BRIEF DESCRIPTION OF THE DRAWINGS

FIG. 1 is a schematic view showing the method of superposing cellulose acylate films upon production of the polarizing plate of the invention.

FIG. 2 is a sectional view schematically showing the sectional structure of the polarizing plate of the invention.

FIG. 3 is a sectional view schematically showing the sectional structure of the polarizing plate of the invention.

### DETAILED DESCRIPTION OF THE INVENTION

The invention is described in detail below.

(Cellulose Acylate)

First, cellulose acylate to be preferably used in the invention is described in detail. Glucose units bound to each other through β-1,4 bond to constitute cellulose have a free hydroxyl group at the 2-, 3- and 6-positions thereof. Cellulose acylate is a polymer wherein part or all of the hydroxyl groups are esterified by an acyl group having 2 or more carbon atoms. The degree of substitution by the acyl group means the ratio of esterified hydroxyl group of cellulose at 2-, 3- or 6-position (when the hydroxyl group is 100% esterified, the degree of substitution is 1).

The whole degree of substitution, i.e., DS2+DS3+DS6, is preferably from 2.00 to 3.00, more preferably from 2.22 to 2.90, particularly preferably from 2.40 to 2.82. Also, DS6/(DS2+DS3+DS6) is preferably 0.320 or more, more preferably 0.322 or more, particularly preferably from 0.324 to 0.340. Here, DS2 represents a degree of substitution of the hydroxyl group at 2-position of glucose unit by an acyl group (hereinafter also referred to as “degree of substitution at 2-position), DS3 represents a degree of substitution of the hydroxyl group at 3-position of glucose unit by an acyl group (hereinafter also referred to as “degree of substitution at 3-position), and DS6 represents a degree of substitution of the hydroxyl group at 6-position of glucose unit by an acyl group (hereinafter also referred to as “degree of substitution at 6-position).

The acyl group to be used for the cellulose acylate of the invention is preferably an acetyl group. As to the kind of the acyl group to be used for the cellulose acylate of the invention, one kind of an acyl group may be used, or two or more kinds thereof may be used. In the case of using two or more kinds of acyl groups, one of them is preferably an acetyl group. The value of DSA+DSB, wherein DSA represents the sum of degrees of substitution of the hydroxyl groups at the 2-, 3- and 6-positions by the acetyl group and DSB represents the sum of degrees of substitution of the hydroxyl groups at the 2-, 3- and 6-positions by other acyl group than the acetyl group, is preferably from 2.2 to 2.86, particularly preferably from 2.40 to 2.80. Also, DSB is 1.50 or more, particularly preferably 1.7 or more. Further, the degree of substitution of hydroxyl group at 6-position accounts for 28% or more, more preferably 30% or more, still more preferably 31% or more, particularly preferably 32% or more of DSB. Also, there may be illustrated cellulose acylate films which have the value of DSA+DSB at the 6-position of cellulose acylate of 0.75 or more, preferably 0.80 or more, particularly 0.85 or more. These cellulose acylate films can provide a solution having a good solubility, in particular, a solution having a good solubility in a chlorine-free organic solvent. Further, a solution having a low viscosity and a good filtering property can be prepared.

The acyl group having 2 or more carbon atoms in the cellulose acylate of the invention is not particularly limited and may be an aliphatic group or an aryl group. Examples of cellulose acylate having thereof include an alkylcarbonyl, alkenylcarbonyl, aromatic carbonyl and aromatic alkylcarbonyl ester of cellulose, each of them optionally having a substituted group. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, iso-butanoyl, t-butanoyl, cyclohexanecarbonyl, oleoyl, benzoyl, naphthylcarbonyl and cinnamoyl. Of these, acetyl, propionyl, butanoyl, dodecanoyl, octadecanoyl, t-butanoyl, oleoyl, benzoyl, naphthylcarbonyl and cinnamoyl are more preferred, acetyl, propionyl and butanoyl are still more preferred, and acetyl is particularly preferred.

(Process for Synthesizing Cellulose Acylate)

Fundamental principle of the process for synthesizing cellulose is described in Migita et al., Mokuzai Kagaku, pp 180-190 (published by Kyoritsu Shuppan in 1968). Typical synthesizing process is a liquid phase acetylation process using a carboxylic acid anhydride, an acetic acid and a sulfuric acid catalyst. Specifically, pre-treating a cellulose raw material such as cotton fiber linter or wood pulp with a suitable amount of acetic acid, then adding to a previously cooled mixed solution for carboxylation to esterify and synthesize complete cellulose acylate (wherein sum of the degree of substitution by acyl group at 2-, 3- and 6-positions is almost 3.00). The above-mentioned mixed solution for carboxylation generally contains acetic acid as a solvent, carboxylic acid anhydride as an esterifying agent, and sulfuric acid as a catalyst. It is a common practice to use the carboxylic acid anhydride in a stoichiometrically excess amount based on the sum of the amount of cellulose to be reacted therewith and the amount of water existing within the reaction system. After completion of the acylation reaction, an aqueous solution of a neutralizing agent (e.g., carbonate, acetate or oxide of calcium, magnesium, iron, aluminum or zinc) is added to the reaction solution in order to hydrolyze excess carboxylic acid anhydride remaining within the reaction system and neutralize part of the esterification catalyst. Subsequently, the resultant complete cellulose acylate is saponified and aged by maintaining it at 50 to 90° C. in the presence of a small amount of an acetylation reaction catalyst (generally, remaining sulfuric acid) to convert the complete cellulose acylate to a cellulose acylate having a desired degree of substitution by the acyl group and a desired polymerization degree. At the point where a desired cellulose acylate is obtained, the catalyst remaining within the reaction system is completely neutralized, using a neutralizing agent as mentioned hereinbefore, or the cellulose acylate solution is thrown into water or dilute sulfuric acid (or water or dilute sulfuric acid is thrown into the cellulose acylate solution), thus cellulose acylate being separated. The separated cellulose acylate is washed and subjected to a stabilizing treatment to obtain cellulose acylate.

The cellulose acylate film of the invention is preferably a film wherein the film-constituting polymer component comprises a cellulose acylate substantially having the above-mentioned definition. The term “substantially” as used herein means 55% by weight or more of the polymer component (preferably 70% by weight ore more, more preferably 80% by weight or more). As a starting material for producing the film, cellulose acylate particles are preferably used. 90% by weight or more of the particles to be used have a particle size of preferably 0.5 to 5 mm. Also, 50% by weight or more of the particles to be used have a particle size of 1 to 4 mm. The cellulose acylate particles have a shape as spherical as possible.

The cellulose acylate to be preferably used in the invention has a viscosity-average polymerization degree of from 200 to 700, preferably from 250 to 550, more preferably from 250 to 400, particularly preferably from 250 to 350. The average polymerization degree can be measured by the limiting viscosity method of Uda et al. (Kazuo Uda & Hideo Saito, Sen-i Gakkaishi, vol. 1, pp 105-120, 1962)). Further, detailed descriptions thereon are given in JP-A-9-95538.

Removal of the lower molecular component enhances the average molecular weight (polymerization degree), but reduces viscosity in comparison with common cellulose acylate, thus being useful. A cellulose acylate containing a less amount of a low molecular component can be obtained by removing a low molecular component from cellulose acylate synthesized in a common manner. Removal of a low molecular component can be conducted by washing cellulose acylate with a proper organic solvent. Additionally, in the case of producing a cellulose acylate containing a less amount of a low molecular component, it is preferred to adjust the amount of the sulfuric acid catalyst in the acetylation reaction to 0.5 to 25 parts by weight based on 100 parts by weight of cellulose. Adjustment of the amount of the sulfuric acid catalyst to the above-mentioned scope permits to synthesize a cellulose acylate also preferred in view of molecular weight distribution (uniform molecular weight distribution). Upon use for production of the cellulose acylate film of the invention, the cellulose acylate has a water content of preferably 2% by weight or less, more preferably 1% by weight or less, in particular 0.7% by weight or less. In general, cellulose acylate contains water, and the content is known to be 2.5 to 5% by weight. In order to reduce the water content to the above-described preferred level, cellulose acylate must be dried. The drying method is not particularly limited as long as the water content can be adjusted to the intended level.

As to the raw cotton and the synthesizing process of the cellulose acylate of the invention, detailed descriptions are given in Hatsumei Kyokai Kokai Giho (Kogi No. 2001-1745, issued on Mar. 15, 2001 by Hatsumei Kyokai), pp 7-12.

(Additives)

Various additives (e.g., a plasticizer, an ultraviolet-preventing agent (ultraviolet absorber), a deterioration-preventing agent, a retardation (optical anisotropy) controlling agent, fine particles, a peeling accelerator and an infrared absorber) can be added to the cellulose acylate solution of the invention depending upon the end use thereof in respective preparing steps. The additives may be in a solid or an oily state. That is, they are not particularly limited as to the melting point or the boiling point. For example, it may be employed to mix an ultraviolet absorbent having a melting point of 20° C. or less with an ultraviolet absorbent having a melting point of 20° C. or more and, similarly, to mix plasticizers. Such is described in, for example, JP-A-2001-151901. As the delamination-accelerating agent, ethyl citrates are illustrated. Further, examples of the infrared absorber are described in, for example, JP-A-2001-194522. As to the stage of adding the additives, they may be added in any stage of the dope-preparing steps. It is also possible to additionally provide a step for adding the additives as the final adjusting step in the dope-preparing process. Further, the addition amount of each material is not particularly limited as long as it exhibits its function. In the case where the cellulose acylate film is of a multilayered structure, the layers may be different from each other in the kind and amount of the additives. It is described in, for example, JP-A-2001-151902. Such technique is conventionally known. It is preferred to adjust the glass transition temperature, Tg, to 80 to 180° C. and the elastic modulus measured by a tensile testing machine to 1,500 to 3,000 MPa, by properly selecting the kinds and the addition amounts of these additives.

Further, materials described in detail in Hatsumei Kyokai Kokai Giho (Kogi No. 2001-1745 issued on Mar. 15, 2001 by Hatsumei Kyokai), p 16 et seq. are preferably used.

(Plasticizer)

The film of the invention preferably contains a plasticizer. Plasticizers to be used are not particularly limited, but it is preferred to use those plasticizers which are more hydrophobic than cellulose acylate, such as phosphates (e.g., triphenyl phosphate, tricresyl phosphate, cresyl diphosphate, octyl diphosphate, diphenylbiphenyl phosphate, trioctyl phosphate and tributyl phosphate), phthalates (e.g., diethyl phthalate, dimethoxyethyl phthalate, dimethyl phthalate, dioctyl phthalate, dibutyl phthalate and di-2-ethyl hexyl phthalate), and esters between glycol and acid (e.g., triacetin, tributyrin, butyl phthalyl butyl glycolate, ethyl phthalyl ethyl glycolate, methyl phthalyl ethyl glycolate and butyl phthalyl butyl glycolate) independently or in combination thereof. The plasticizer may be used in combination of two or more thereof as needed.

(Retardation-Producing Agent)

In the invention, a compound containing at least two aromatic rings may be used as a retardation-producing agent in order to produce a retardation value. The retardation-producing agent is used in an amount of from 0.05 to 20 parts by weight, more preferably from 0.1 to 10 parts by weight, still more preferably from 0.2 to 5 parts by weight, most preferably from 0.5 to 2 parts by weight, per 100 parts by weight of the polymer. Two or more kinds of the retardation-producing agents may be used in combination.

The retardation-producing agent has the maximum absorption in the wavelength region of 250 to 400 nm, and preferably has substantially no absorption in the visible region.

In the present specification, the term “aromatic ring” includes both aromatic hydrocarbon rings and aromatic hetero rings.

The aromatic hydrocarbon ring is particularly preferably a 6-membered ring (i.e., a benzene ring).

The aromatic hetero ring is generally an unsaturated hetero ring. The aromatic hetero ring is preferably a 5-membered ring, a 6-membered ring or a 7-membered ring, with a 5-membered ring and a 6-membered ring being more preferred. The aromatic hetero ring generally has a maximum number of double bonds. As the hetero atom, nitrogen atom, oxygen atom and sulfur atom are preferred, with nitrogen atom being particularly preferred. Examples of the aromatic hetero ring include a furan ring, a thiophene ring, a pyrrole ring, an oxazole ring, anisoxazole ring, a thiazole ring, an isothiazole ring, an imidazole ring, a pyrazole ring, a furazane ring, a triazole ring, a pyran ring, a pyridine ring, a pyridazine ring, a pyrimidine ring, a pyrazine ring and a 1,3,5-triazine ring.

Preferred examples of the aromatic ring include a benzene ring, a furan ring, a thiophene ring, a pyrrole ring, an oxazole ring, a thiazole ring, an imidazole ring, a triazole ring, a pyridine ring, a pyrimidine ring, a pyrazine ring and a 1,3,5-triazine ring, with a 1,3,5-triazine ring being particularly preferably used. Specifically, those compounds which are illustrated in, e.g., JP-A-2001-166144 can preferably be used.

The number of the aromatic rings that the retardation-producing agent has is preferably from 2 to 20, more preferably from 2 to 12, still more preferably from 2 to 8, most preferably from 2 to 6.

The bonding relations between the two aromatic rings can be classified into the cases of: (a) forming a condensed ring, (b) being directly connected to each other through a single bond and (c) being connected to each other through a linking group (a spiro bond not being formed since the rings are aromatic rings). The bonding relation may be any of (a) to (c).

In the case (a) of forming a condensed ring (condensed ring constituted by two or more aromatic rings), examples thereof include an indene ring, a naphthalene ring, an azulene ring, a fluorene ring, a phenanthrene ring, an anthracene ring, an acenaphthylene ring, a biphenylene ring, a naphthacene ring, a pyrene ring, an indole ring, an isoindole ring, a benzofuran ring, a benzothiophene ring, an indolizine ring, an benzoxazole ring, a benzothiazole ring, a benzimidazole ring, a benzotriazole ring, a purine ring, an indazole ring, a chromene ring, a quinoline ring, an isoquinoline ring, a quinolizine ring, a quinazoline ring, a cinnoline ring, a quinoxaline ring, a phthalazine ring, a pteridine ring, a carbazole ring, an acridine ring, a phenanthridine ring, a phenothiazine ring, a phenoxthine ring, a phenoxazine ring and a thianthrene ring. Among them, a naphthalene ring, an azulene ring, an indole ring, a benzoxazole ring, a benzothiazole ring, a benzimidazole ring, a benzotriazole ring and quinoline ring are preferred.

The single bond in case (b) is preferably a bond between two aromatic rings. Two aromatic rings may be connected to each other through two or more single bonds to form an aliphatic or non-aromatic hetero ring between the two aromatic rings.

The linking group in case (c) is also preferably connected to carbon atoms of the two aromatic rings. The lining group is preferably an alkylene group, an alkenylene group, an alkynylene group, —CO—, —O—, —NH—, —S— or a combination thereof. Examples of the linking group comprising the combination are illustrated below. Additionally, the left-right relation of the following examples may be in reverse.

c1: —CO—O—

c2: —CO—NH—

c3: —alkylene-O—

c4: —NH—CO—NH—

c5: —NH—CO—O—

c6: —O—CO—O—

c7: —O-alkylene-O—

c8: —CO-alkenylene-

C9: —CO-alkenylene-NH—

c10: —CO-alkenylene-O—

c11: -alkylene-CO—O-alkylene-O—CO-alkylene-

c12: —O-alkylene-CO—O-alkylene-O—CO-alkylene-O—

c13: —O—CO-alkylene-CO—O—

c14: —NH—CO-alkenylene-

c15: —O—CO-alkenylene-

The aromatic ring and the linking group may have a substituent.

Examples of the substituent include a halogen atom (F, Cl, Br and I), hydroxyl, carboxyl, cyano, amino, nitro, sulfo, carbamoyl, sulfamoyl, ureido, an alkyl group, an alkenyl group, an alkynyl group, an aliphatic acyl group, an aliphatic acyloxy group, an alkoxy group, an alkoxycarbonyl group, an alkoxycarbonylamino group, an alkylthio group, an alkylsulfonyl group, an aliphatic amido group, an aliphatic sulfonamido group, an aliphatic substituted amino group, an aliphatic substituted carbamoyl group, an aliphatic substituted sulfamoyl group, an aliphatic substituted ureido group and a non-aromatic hetero ring group.

The alkyl group contains preferably from 1 to 8 carbon atoms. A chain alkyl group is more preferable than a cyclic allyl group, with a straight chain alkyl group being particularly preferred. The alkyl group may further have a substituent (e.g., hydroxyl, carboxyl, an alkoxy group or an alkyl-substituted amino group). Examples of the alkyl group (including a substituted alkyl group) include methyl, ethyl, n-butyl, n-hexyl, 2-hydroxyethyl, 4-carboxybutyl, 2-methoxyethyl and 2-diethylaminoethyl.

The alkenyl group contains preferably from 2 to 8 carbon atoms. A chain alkenyl group is more preferable than a cyclic alkenyl group, with a straight chain alkenyl group being particularly preferred. The alkenyl group may further have a substituent. Examples of the alkenyl group include vinyl, allyl and 1-hexenyl.

The alkynyl group has preferably from 2 to 8 carbon atoms. A chain alkynyl group is more preferable than a cyclic alkynyl group, with a straight chain alkynyl group being particularly preferred. The alkynyl group may further have a substituent. Examples of the alkynyl group include ethynyl, 1-butynyl and 1-hexynyl.

The aliphatic acyl group contains preferably from 1 to 10 carbon atoms. Examples of the aliphatic acyl group include acetyl, propanoyl and butanoyl.

The aliphatic acyloxy group contains preferably from 1 to 10 carbon atoms. Examples of the aliphatic acyloxy group include acetoxy.

The alkoxy group contains preferably from 1 to 8 carbon atoms. The alkoxy group may further have a substituent (e.g., an alkoxy group). Examples of the alkoxy group (including a substituted alkoxy group) include methoxy, ethoxy, butoxy and methoxyethoxy.

The alkoxycarbonyl group contains preferably from 2 to 10 carbon atoms. Examples of the alkoxycarbonyl group include methoxycarbonyl and ethoxycarbonyl.

The alkoxycarbonylamino group contains preferably from 2 to 10 carbon atoms. Examples of the alkoxycarbonylamino group include methoxycarbonylamino and ethoxycarbonylamino.

The alkylthio group contains preferably from 1 to 12 carbon atoms. Examples of the alkylthio group include methylthio, ethylthio and octylthio.

The alkylsulfonyl group contains preferably from 1 to 8 carbon atoms. Examples of the alkylsulfonyl group include methanesulfonyl and ethanesulfonyl.

The aliphatic amido group contains preferably from 1 to 10 carbon atoms. Examples of the aliphatic amido group include acetamido group.

The aliphatic sulfonamido group contains preferably from 1 to 8 carbon atoms. Examples of the aliphatic sulfonamido group include methanesulfonamido, butanesulfonamido and n-octanesulfonamido.

The aliphatic substituted amino group contains preferably from 1 to 10 carbon atoms. Examples of the aliphatic substituted amino group include dimethylamino, diethylamino and 2-carboxyethylamino.

The aliphatic substituted carbamoyl group contains from 2 to 10 carbon atoms. Examples of the aliphatic substituted carbamoyl group include methylcarbamoyl and diethylcarbamoyl.

The aliphatic substituted sulfamoyl group contains preferably from 1 to 8 carbon atoms. Examples of the aliphatic substituted sulfamoyl group include methylsulfamoyl and diethylsulfamoyl.

The aliphatic substituted ureido group contains preferably from 2 to 10 carbon atoms. Examples of the aliphatic substituted ureido group include methylureido.

Examples of the non-aromatic hetero ring group include piperidino and morpholino.

The molecular weight of the retardation-producing agent is preferably from 300 to 800.

In the invention, rod-like compounds having a linear molecular structure can preferably be used as well as the compounds having a 1,3,5-triazine ring (or discotic compounds). The term “linear molecular structure” as used herein means that the molecular structure of the rod-like compound is linear when the compound is thermodynamically in the most stable structure. The thermodynamically most stable structure can be determined by structural analysis of crystal or calculation of molecular orbital. For example, a molecular structure that minimizes the heat to be generated by the compound can be determined by using a molecular orbital-calculating soft (e.g., WinMOPAC2000 made by Fujitsu Co., Ltd.). The phrase “molecular structure being linear” means that, in the thermodynamically most stable structure determined by the above-mentioned calculation, the angle constituted by the main chain of the molecular structure is 140° or more.

As the rod-like compound having at least two aromatic rings, those compounds are preferred which are represented by the following formula (I):
Ar¹-L¹-Ar² Formula (1):

In the above formula (1), Ar¹ and Ar² each independently represents an aromatic group.

In the present specification, an aromatic group includes an aryl group (an aromatic hydrocarbon group), a substituted aryl group, an aromatic hetero ring group and a substituted aromatic hetero ring group.

An aryl group and a substituted aryl group are more preferred than an aromatic hetero ring and a substituted aromatic hetero ring. The hetero ring in the aromatic hetero ring group is generally unsaturated. The aromatic hetero ring group is preferably a 5-, 6- or 7-membered ring, more preferably a 5- or 6-membered ring. The aromatic hetero ring group generally has a maximum number of double bonds. As the hetero atom, nitrogen atom, oxygen atom or sulfur atom is preferred, with nitrogen atom or sulfur atom being more preferred.

Preferred examples of the aromatic ring in the aromatic group include a benzene ring, a furan ring, a thiophene ring, a pyrrole ring, an oxazole ring, a thiazole ring, an imidazole ring, a triazole ring, a pyridine ring, a pyrimidine ring and a pyrazine ring, with a benzene ring being particularly preferred.

Examples of the substituent for the substituted aryl group and the substituted aromatic hetero ring group include a halogen atom (F, Cl, Br or I), hydroxyl, carboxyl, cyano, an alkylamino group (e.g., methylamino, ethylamino, butylamino or dimethylamino), nitro, sulfo, carbamoyl, an alkylcarbamoyl group (e.g., N-methylcarbamoyl, N-ethylcarbamoyl or N,N-dimethylcarbamoyl), sulfamoyl, an alkylsulfamoyl group (e.g., N-methylsulfamoyl, N-ethylsulfamoyl or N,N-dimethylsulfamoyl), ureido, an alkylureido group (e.g., N-methylureido, N,N-dimethylureido or N,N,N′-trimethylureido), an alkyl group (e.g., methyl, ethyl, propyl, butyl, pentyl, heptyl, octyl, ixopropyl, s-butyl, t-amyl, cyclohexyl or cyclopentyl), an alkenyl group (e.g., vinyl, allyl or hexenyl), an alkynyl group (e.g., ethynyl or butynyl), an acyl group (formyl, acetyl, butyryl, hexanoyl or lauryl), an acyloxy group (e.g., acetoxy, butyryloxy, hexanoyloxy or lauryloxy), an alkoxy group (e.g., methoxy, ethoxy, propoxy, butoxy, pentyloxy, heptyloxy or octyloxy), an aryloxy group (e.g., phenoxy), an alkoxycarbonyl group (e.g., methoxycarbonyl, ethoxycarbonyl, propoxycarbonyl, pentyloxycarbonyl or heptyloxycarbonyl), an aryloxycarbonyl group (e.g., phenoxycarbonyl), an alkoxycarbonylamino group (e.g., butoxycarbonylamino or hexyloxycarbonylamino), an alkylthio group (e.g., methylthio, ethylthio, propylthio, butylthio, pentylthio, heptylthio or octylthio), an arylthio group (e.g., phenylthio), an alkylsulfonyl group (e.g., methylsulfonyl, ethylsulfonyl, propylsulfonyl, butylsulfonyl, pentylsulfonyl, heptylsulfonyl or octylsulfonyl), an amido group (e.g., acetamido, butyramido, hexylamido or laurylamido) and a non-aromatic hetero ring group (e.g., morpholino or pirazinyl).

Among them, a halogen atom, cyano, carboxyl, hydroxyl, amino, an alkylamino group, an acyl group, an acyloxy group, an amido group, an alkoxycarbonyl group, an alkoxy group, an alkylthio group and an alkyl group are preferred.

The alkyl moiety of then alkylamino group, alkoxycarbonyl group, alkoxy group and alkylthio group and the alkyl group may further have a substituent. Examples of the substituent for the allyl moiety and the alkyl group include a halogen atom, hydroxyl, carboxyl, cyano, amino, an alkylamino group, nitro, sulfo, carbamoyl, an alkylcarbamoyl group, sulfamoyl, an alkylsulfamoyl group, ureido, an alkylureido group, an alkenyl group, an alkynyl group, an acyl group, an acyloxy group, an alkoxy group, an aryloxy group, an alkoxycarbonyl group, an aryloxycarbonyl group, an alkoxycarbonylamino group, an alkylthio group, an arylthio group, an alkylsulfonyl group, an amido group and a non-aromatic hetero ring group. As the substituent for the alkyl moiety and the alkyl group, a halogen atom, hydroxyl, amino, an alkylamino group, an acyl group, an acyloxy group, an acylamino group, an alkoxycarbonyl group and an alkoxy group are preferred.

In formula (1), L¹ represents a linking group selected from among an allylene group, an alkenylene group, an alkynylene group, —O—, —CO— and a group comprising a combination thereof.

The alkylene group may have a cyclic structure. As a cyclic alkylene group, cyclohexylene is preferred, with 1,4-cyclohexylene being particularly preferred. As a chain alkylene group, a straight chain alkyl group is more preferred than a branched alkylene group.

The alkylene group has preferably from 1 to 20 carbon atoms, more preferably from 1 to 15 carbon atoms, still more preferably from 1 to 10 carbon atoms, yet more preferably from 1 to 8 carbon atoms, most preferably from 1 to 6 carbon atoms.

As the alkenylene group and the alkynylene group, those which have a chain structure are more preferred than those which have a cyclic structure, and those which have a straight chain structure are more preferred than those which have a branched structure.

The alkenylene group and the alkynylene group have preferably from 2 to 10 carbon atoms, more preferably from 2 to 8 carbon atoms, still more preferably from 2 to 6 carbon atoms, yet more preferably from 2 to 4 carbon atoms, most preferably 2 (vinylene or ethynylene) carbon atoms.

The arylene group has preferably from 6 to 20 carbon atoms, more preferably from 6 to 16 carbon atoms, still more preferably from 6 to 12 carbon atoms.

In the molecular structure of formula (1), the angle formed by Ar¹ and Ar² sandwiching L¹ is preferably 140° or more.

As the rod-like compound, those compounds which are represented by the following formula (2) are more preferred.
Ar¹-L²-X-L³-Ar² Formula (2)

In the above formula (2), Ar¹ and Ar² each independently represents an aromatic group.

The definition and examples of the aromatic group are the same as with Ar¹ and Ar⁷ in formula (1).

In formula (2), L² and L³ each independently represents a divalent linking group selected from among an alkylene group, —O—, —CO— and a group comprising a combination thereof.

As the alkylene group, an alkylene group having a chain structure is more preferred than an alkylene group having a cyclic structure, with an alkylene group having a straight chain structure being more preferred than an alkylene group having a branched chain structure.

The alkylene group has preferably from 1 to 10 carbon atoms, more preferably from 1 to 8 carbon atoms, still more preferably from 1 to 6 carbon atoms, yet more preferably from 1 to 4 carbon atoms, most preferably 1 or 2 (methylene or ethylene) carbon atoms.

L² and L³ each represents particularly preferably —O—CO— or —CO—O—.

In formula (2), X represents 1,4-cyclohexylene, vinylene or ethynylene.

Specific examples of the compound represented by formula (1) are shown below.

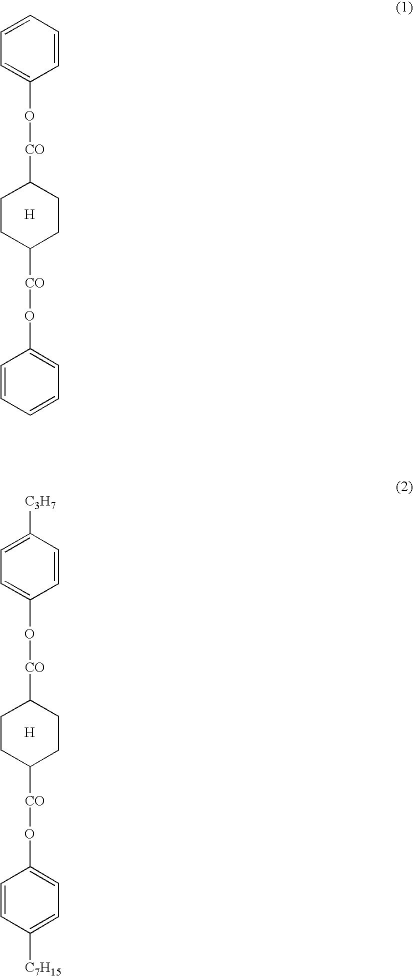

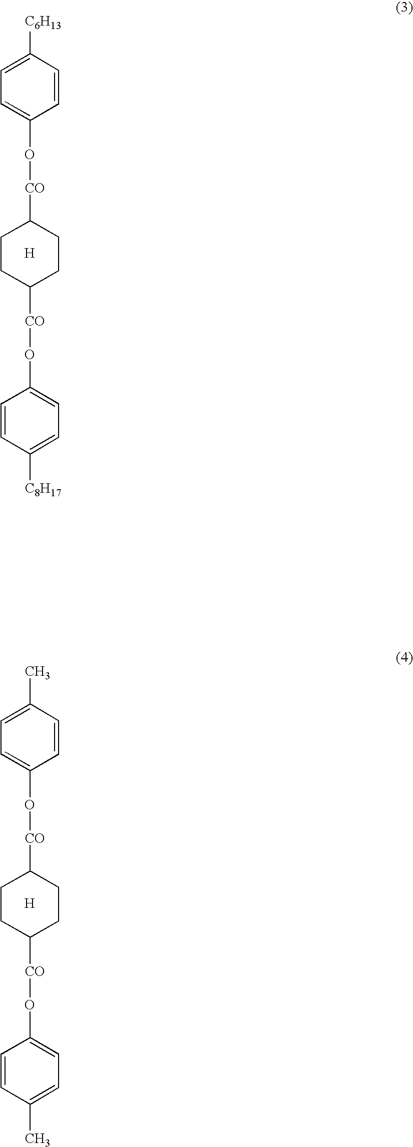

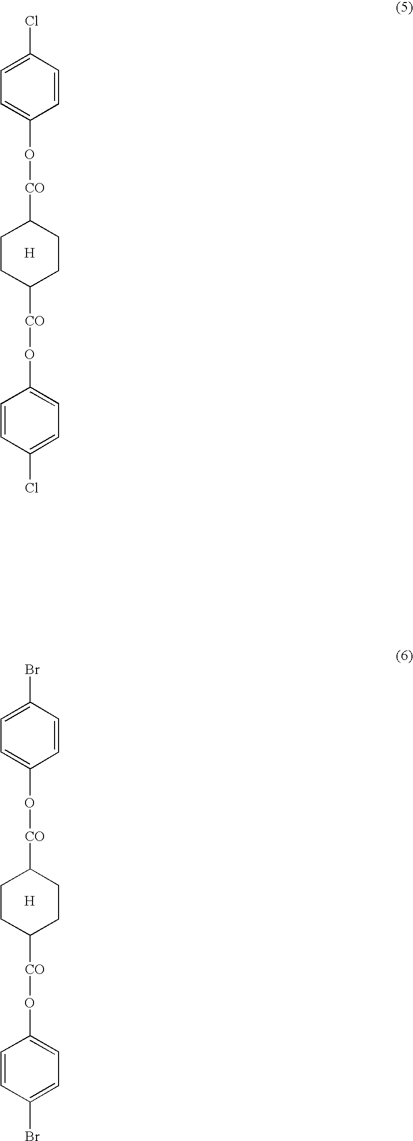

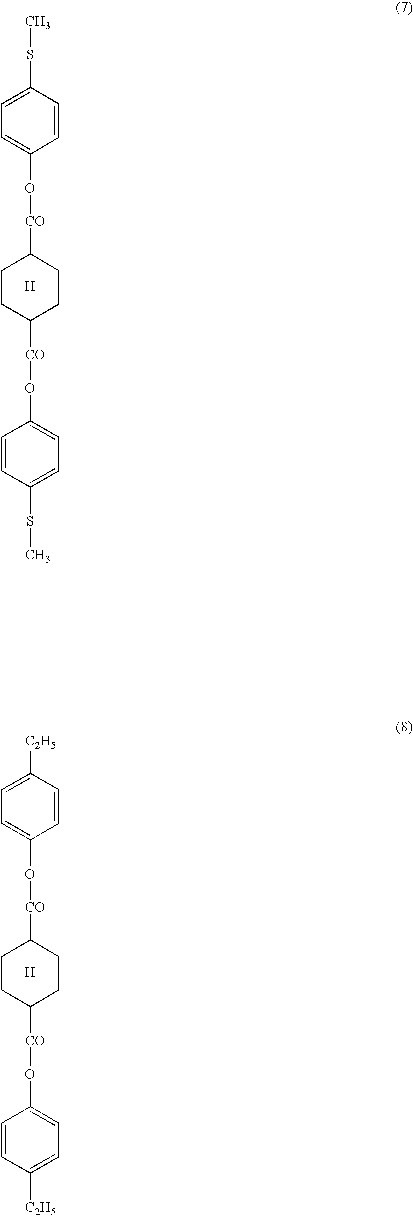

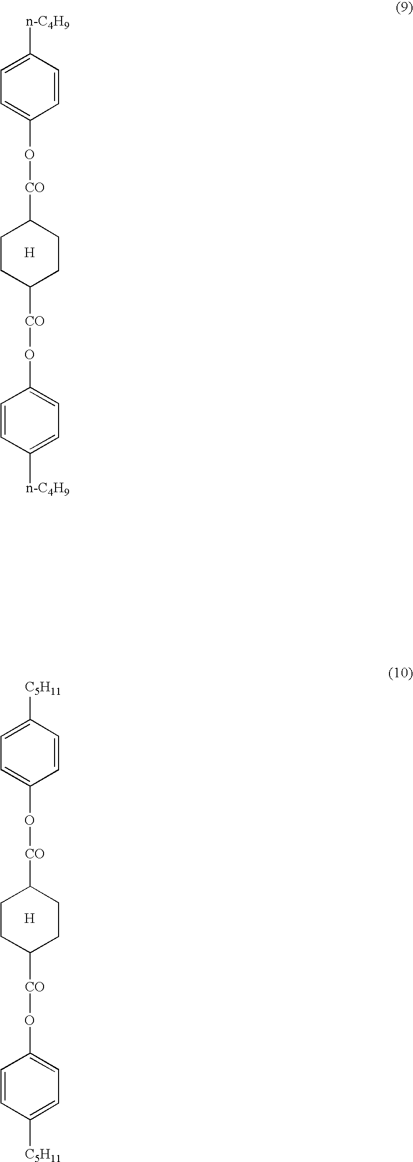

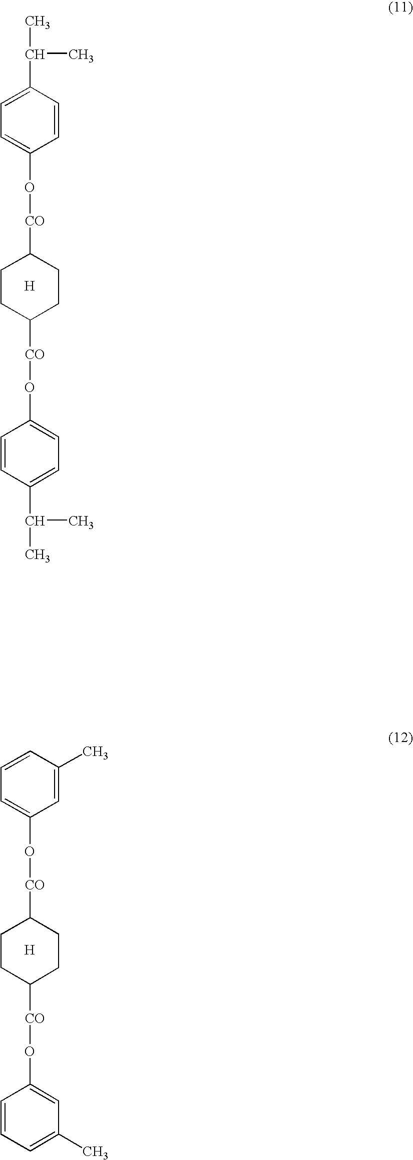

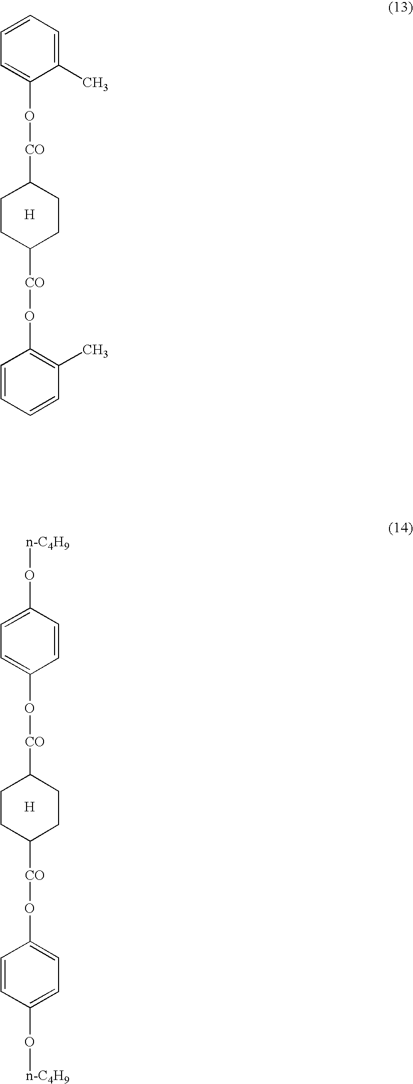

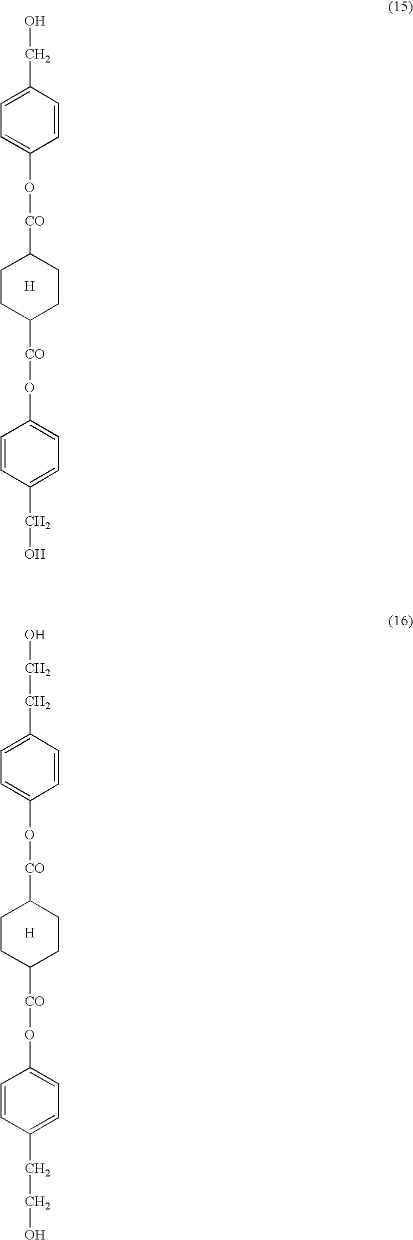

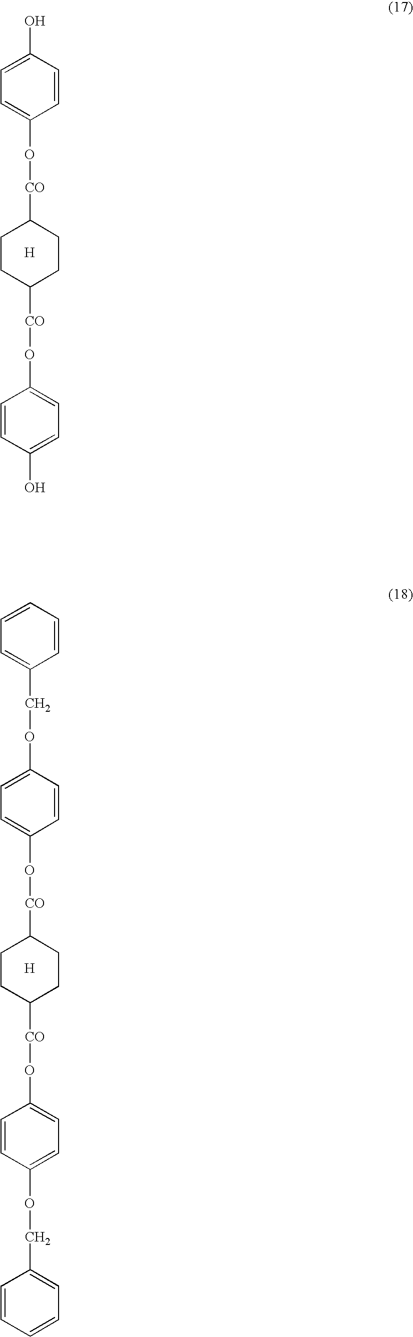

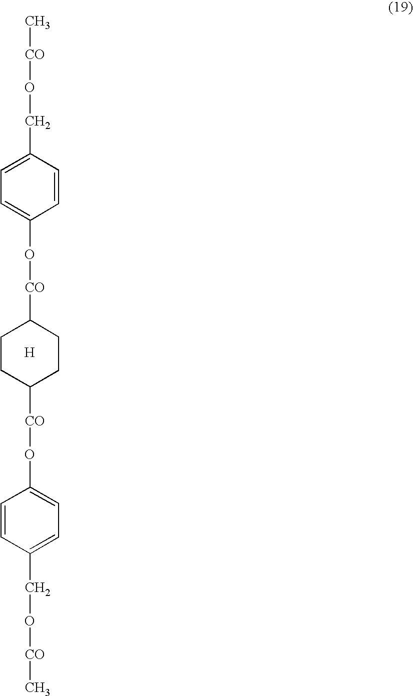

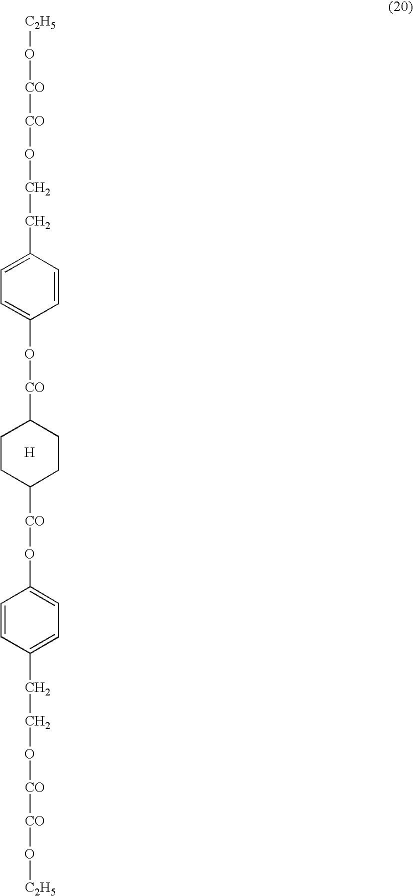

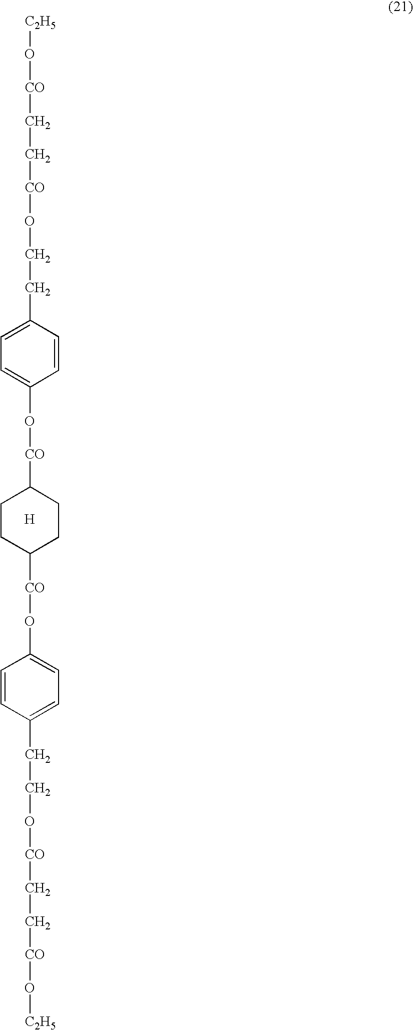

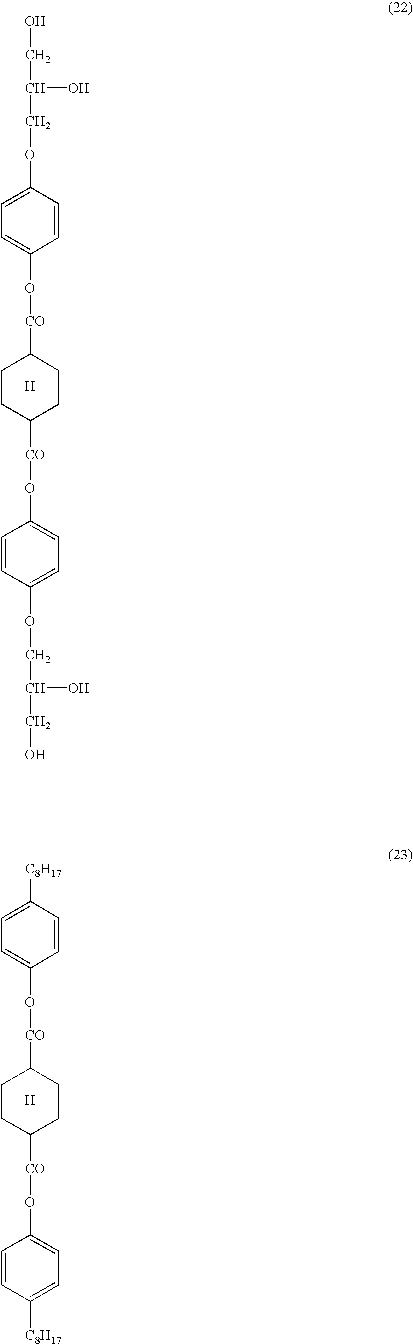

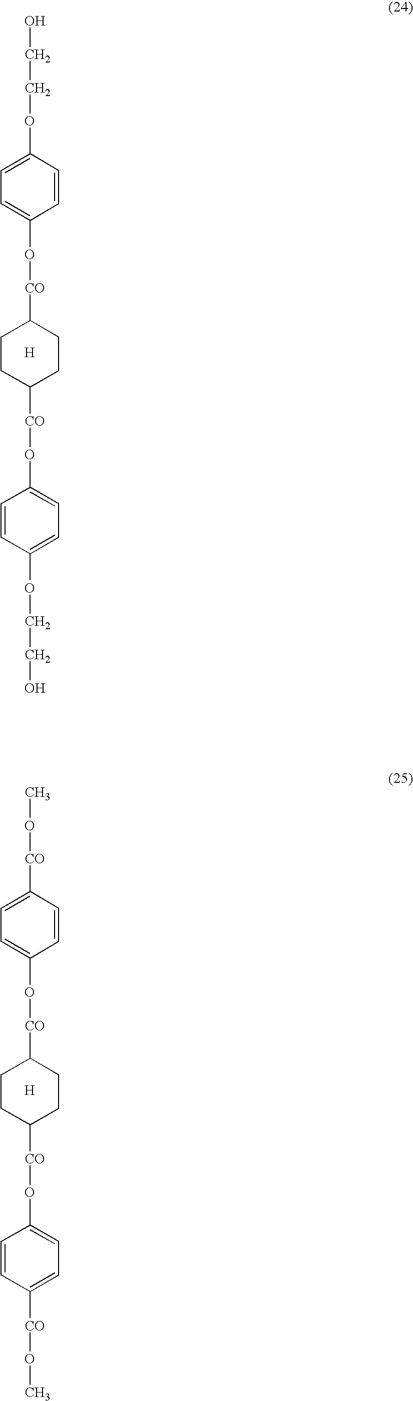

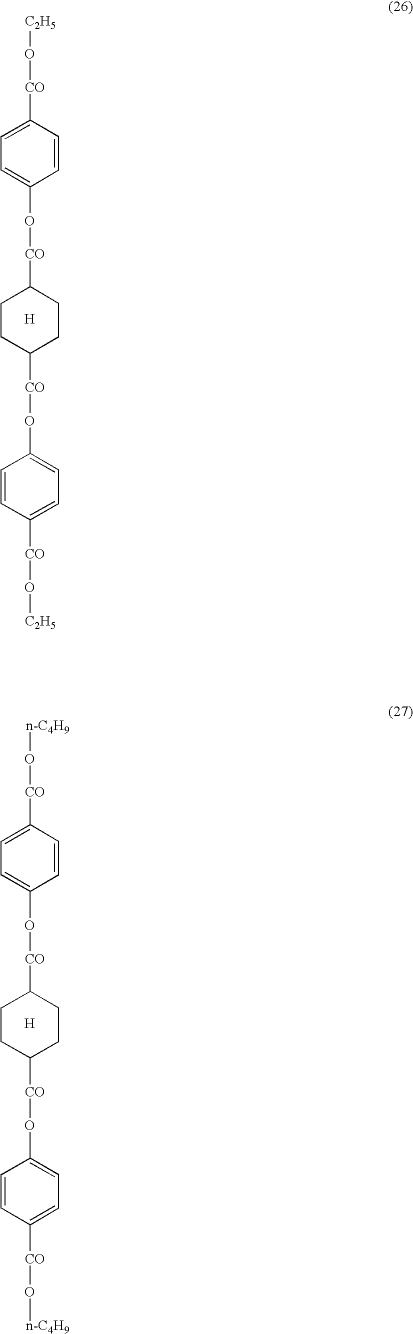

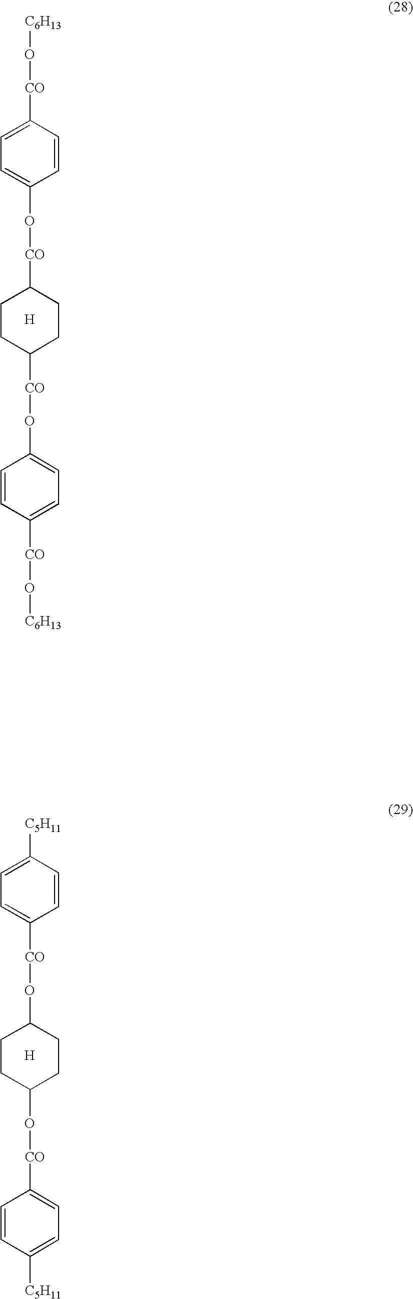

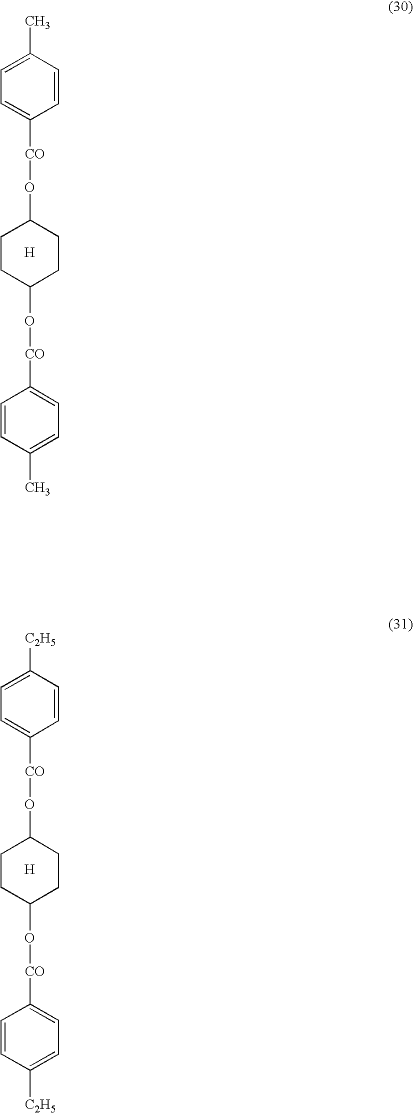

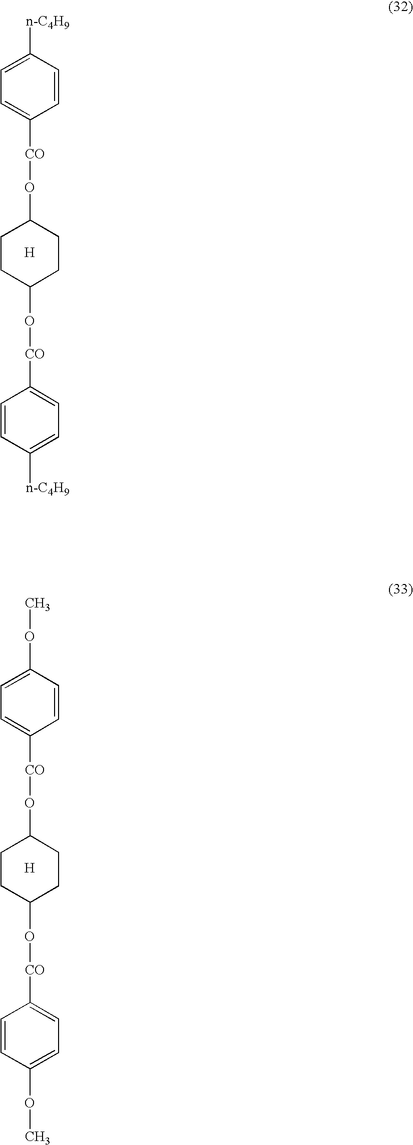

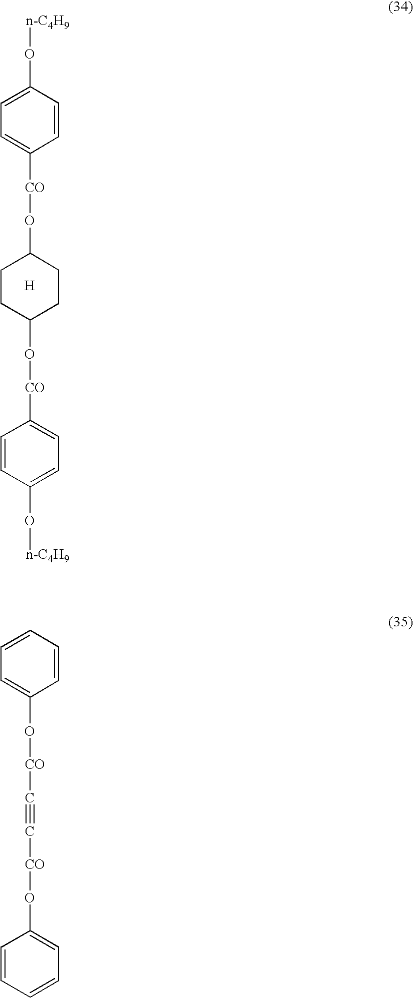

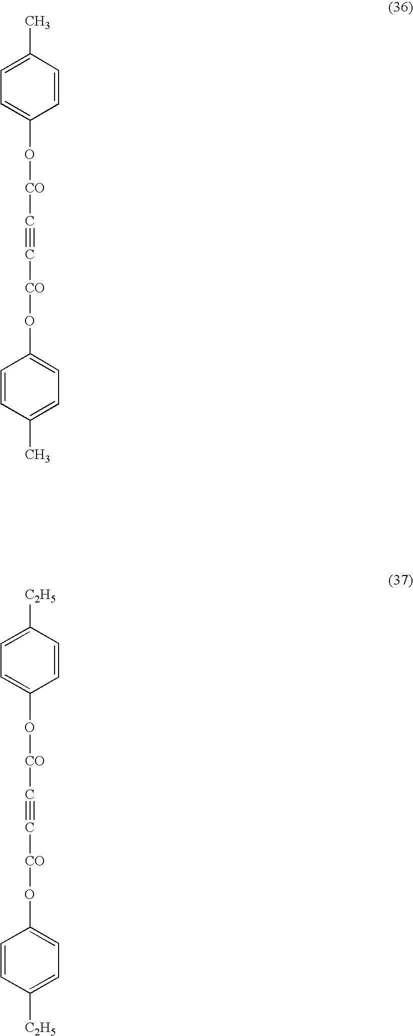

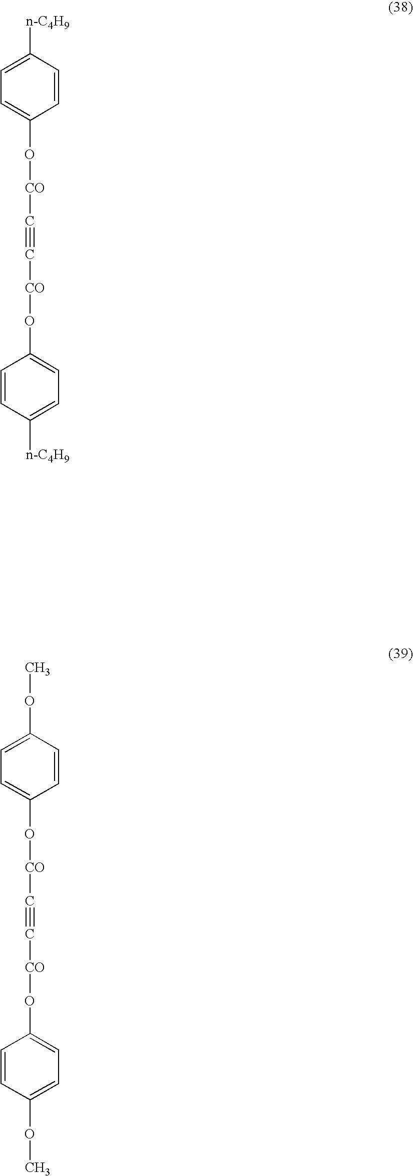

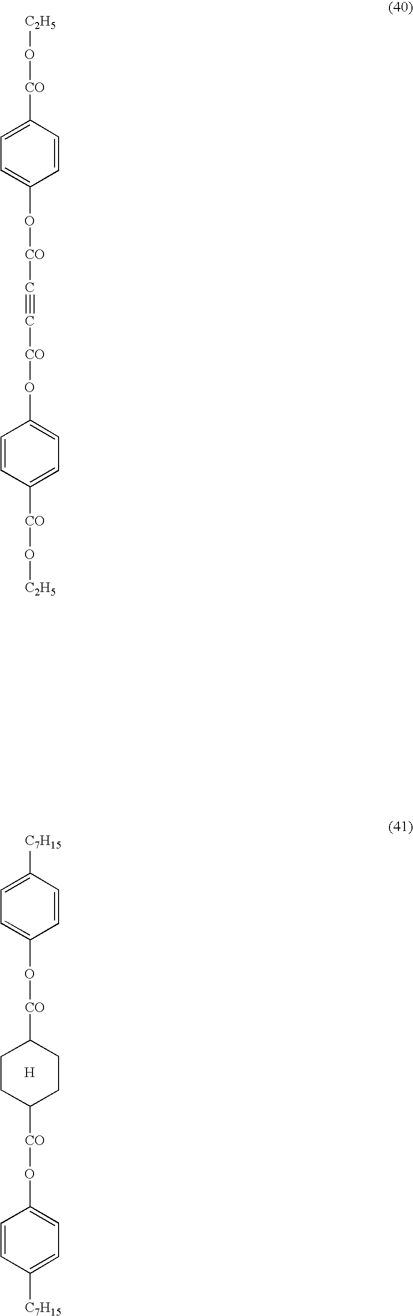

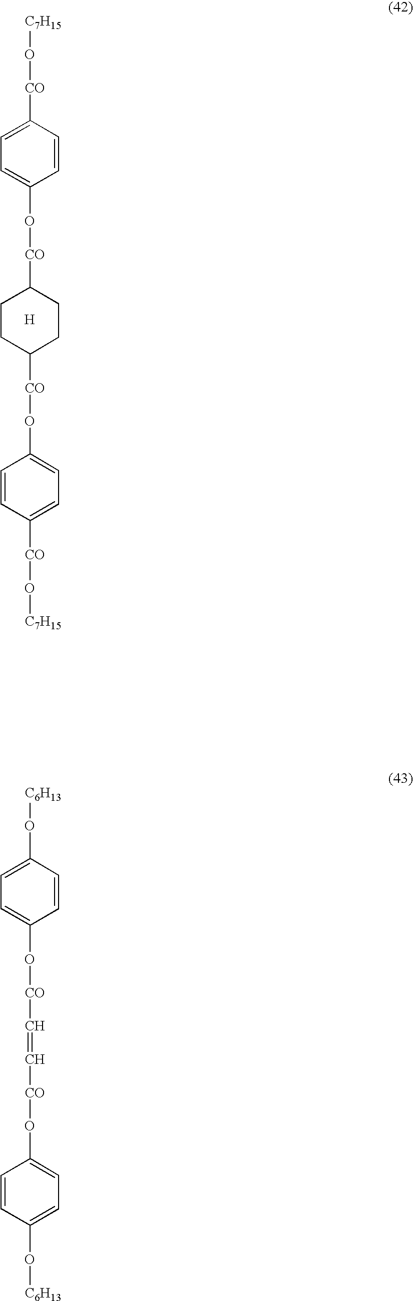

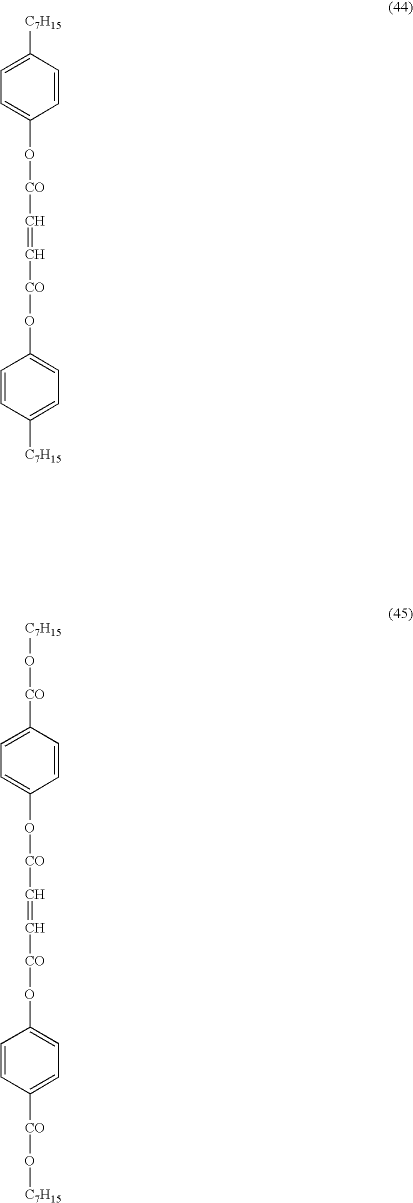

Specific examples (1) to (34), (41) and (42) have two asymmetric carbon atoms; one at 1-position and the other at 4-position of the cyclohexane ring. However, specific examples (1), (4) to (34), (41) and (42) have a symmetric meso type molecular structure, and hence there exist no optical isomers (which are optically active) and exist only geometrical isomers (trans- and cis-isomers). A trans-isomer (1-trans) and a cis-isomer (1-cis) of the specific example (1) are shown below.

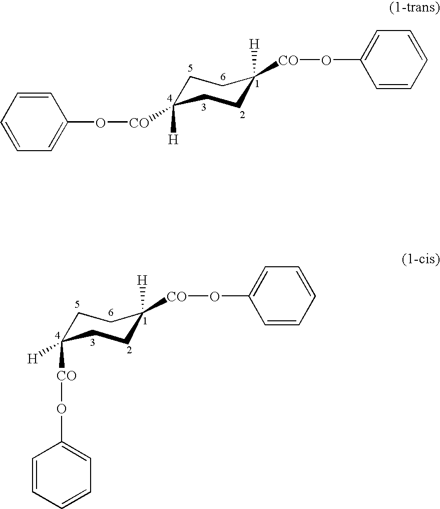

As has been described hereinbefore, the rod-like compound preferably has a linear molecular structure. Thus, trans-isomers are more preferred than cis-isomers.

The specific examples (2) and (3) include optical isomers (4 kinds of isomers in all) in addition to the geometrical isomers. As to the geometrical isomers, trans-isomers are similarly more preferred than cis-isomers. As to the optical isomers, there exists no superiority or inferiority, and any of D-isomer, L-isomer and racemate may be used.

With the specific examples (43) to (45), the vinylene bond located at the center produces a trans-isomer and a cis-isomer. The trans-isomers are more preferred than the cis-isomers because of the same reason as described above.

Other preferred compounds are illustrated below.

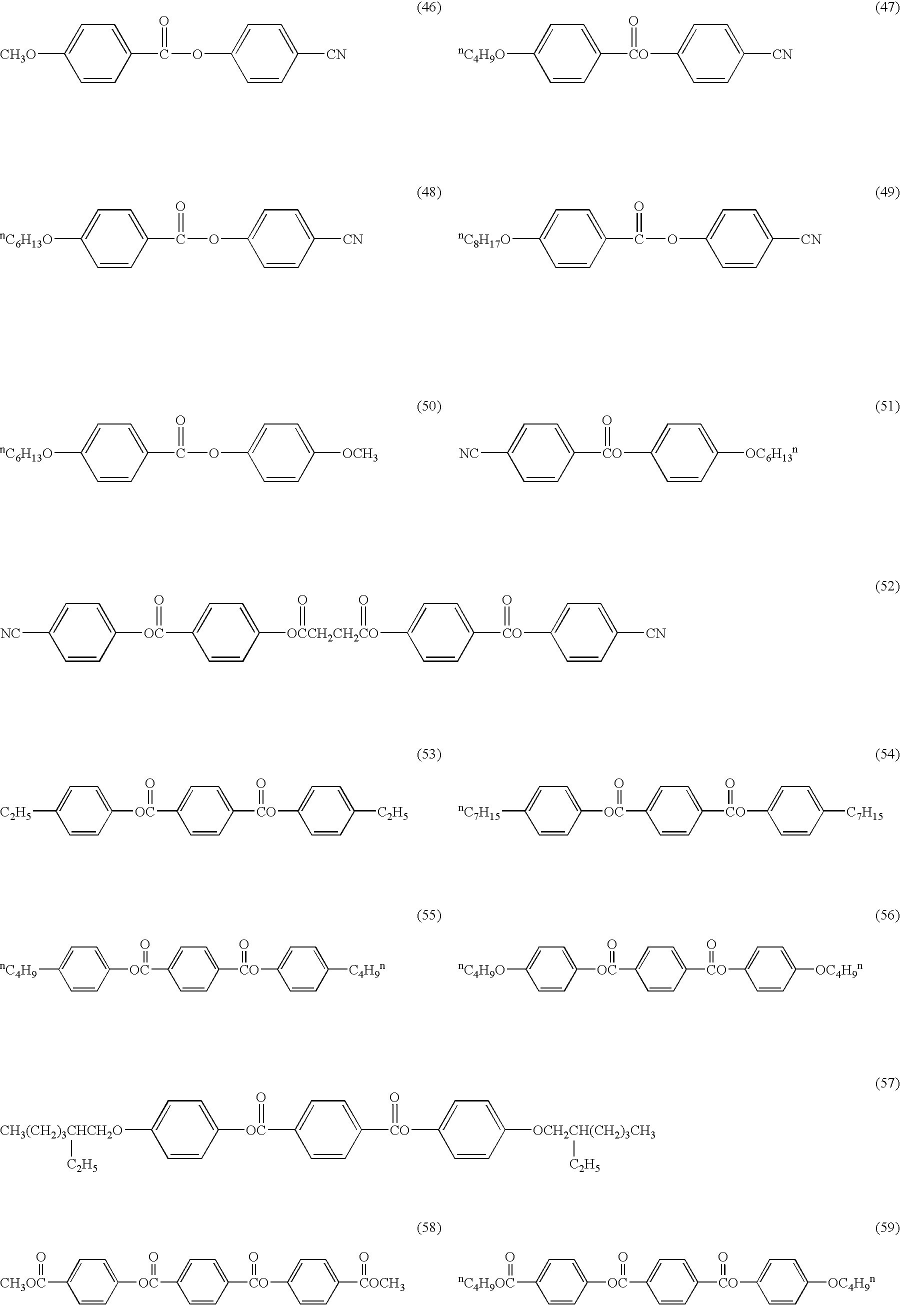

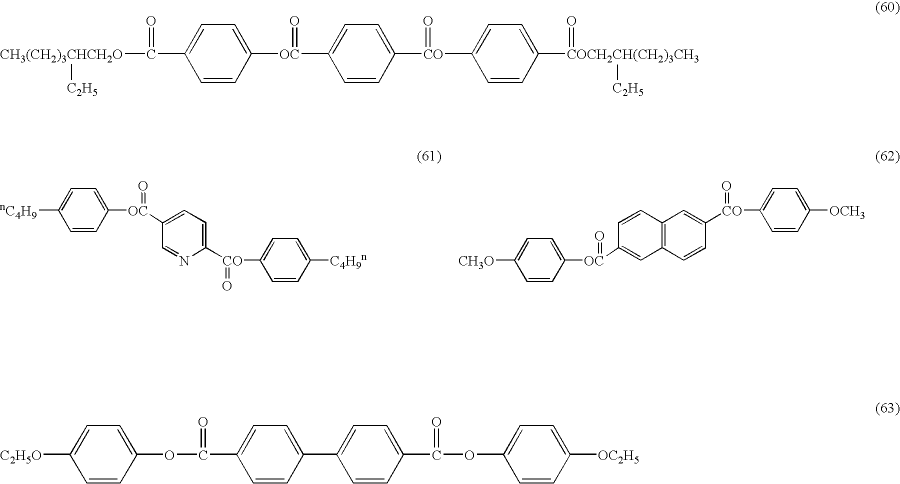

Two or more of the rod-like compounds having the maximum absorption wavelength (λmax) as a solution in UV ray absorption spectrum shorter than 250 nm may be used in combination thereof.

The rod-like compounds can be synthesized by reference to processes described in literatures. Examples of the literatures include Mol. Cryst. Lig. Cryst., vol. 53, p. 229 (1979), ibid., vol. 89, p. 93 (1982), ibid., vol. 145, p. 111 (1987), ibid., vol. 170, p. 43 (1989), J. Am. Chem. Soc., vol. 113, p. 1349 (1991), ibid., vol. 118, p. 5346 (1996), ibid., vol. 92, p. 1582 (1970), J. Org. Chem., vol. 40, p. 420 (1975), and Tetrahedron, vol. 48, No. 16, p. 3437 (1992).

The addition amount of the retardation-producing agent is preferably from 0.1 to 30% by weight, more preferably from 0.5 to 20% by weight, based on the amount of the polymer.

The aromatic compound is used in an amount of preferably from 0.01 to 20 parts by weight per 100 parts by weight of cellulose acetate. The aromatic compound is used in an amount of more preferably from 0.05 to 15 parts by weight still more preferably from 0.1 to 10 parts by weight, per 100 parts by weight of cellulose acetate. Two or more of the compounds may be used in combination thereof.

Next, an organic solvent for dissolving the cellulose acylate of the invention is described.

(Chlorine-Containing Solvent)

In preparing a solution of the cellulose acylate of the invention, a chlorine-containing organic solvent is preferably used as a main solvent. In the invention, the chlorine-containing organic solvent is not particularly limited as to the kind as long as it dissolves cellulose acylate and the solution permits satisfactory casting and filming. Preferred examples of the chlorine-containing organic solvent include dichloromethane and chloroform, with dichloromethane being particularly preferred. It causes no particular problem to mix other organic solvent than the chlorine-containing organic solvent. In such case, it is necessary to use dichloromethane in an amount of at least 50% by weight. The chlorine-free organic solvent to be used in combination with the chlorine-containing organic solvent is described below. That is, as the chlorine-free organic solvent, those solvents which are selected from among esters, ketones, ethers, alcohols and hydrocarbons containing from 3 to 12 carbon atoms are preferred. The esters, ketones, ethers and alcohols may have a cyclic structure. Those compounds which have two or more functional groups of ester, ketone and ether (i.e., —O—, —CO— and —COO—) may also be used as a solvent. Also, the compounds may have at the same time other functional group such as an alcoholic hydroxyl group. With compounds having two or more kinds of functional groups, the number of carbon atoms should be within the scope of the number of carbon atoms of the compound having one of the functional group. Examples of esters having from 3 to 12 carbon atoms include ethyl formate, propyl formate, pentyl formate, methyl acetate, ethyl acetate and pentyl acetate. Examples of ketones having from 3 to 12 carbon atoms include acetone, methyl ethyl ketone, diethyl ketone, diisobutyl ketone, cyclopentanone, cyclohexanone and methylcyclohexanone. Examples of ethers having from 3 to 12 carbon atoms include diisopropyl ether, dimethoxymethane, dimethoxyethane, 1,4-dioxane, 1,3-dioxolan, tetrahydrofuran, anisole and phenetole. Examples of the organic solvent having two or more functional groups include 2-ethoxyethyl acetate, 2-methoxyethanol and 2-butyoxyethanol.

As the alcohol to be used in combination with the chlorine-containing organic solvent, any of straight-chained, branched and cyclic alcohols may be used, with saturated aliphatic hydrocarbon alcohols being preferred. Examples of the alcohol include methanol, ethanol, 1-propanol, 2-propanol, 1-butanol, 2-butanol, t-butanol, 1-pentanol, 2-methyl-2-butanol and cyclohexanol. Additionally, fluorine-containing alcohols may also be used as the alcohol. Examples thereof include 2-fluoroethanol, 2,2,2-trifluoroethanol and 2,2,3,3-tetrafluoro-1-propanol. Further, hydrocarbons may be straight-chained, branched or cyclic. Either of aromatic hydrocarbons and aliphatic hydrocarbons may be used. The aliphatic hydrocarbons may be saturated or unsaturated. Examples of the hydrocarbons include cyclohexane, hexane, benzene, toluene and xylene.

As a combination with the chlorine-containing organic solvent which is a preferred main solvent of the invention, there are illustrated the following combinations which, however, are not limitative at all.

dichloromethane/methanol/ethanol/butanol (80/10/5/5; parts by weight)

dichloromethane/acetone/methanol/propanol (80/10/5/5; parts by weight)

dichloromethane/methanol/butanol/cyclohexane (80/10/5/5; parts by weight)

dichloromethane/methyl ethyl ketone/methanol/butanol (80/10/5/5; parts by weight)

dichloromethane/acetone/methyl ethyl ketone/ethanol/isopropanol (75/8/5/5/7; parts by weight)

dichloromethane/cyclopentanone/methanol/isopropanol (80/7/5/8; parts by weight)

dichloromethane/methyl acetate/butanol (80/10/10; parts by weight)

dichloromethane/cyclohexanone/methanol/hexane (70/20/5/5; parts by weight)

dichloromethane/methyl ethyl ketone/acetone/methanol/ethanol (50/20/20/5/5; parts by weight)

dichloromethane/1,3-dioxolan/methanol/ethanol (70/20/5/5; parts by weight)

dichloromethane/dioxane/acetone/methanol/ethanol (60/20/10/5/5; parts by weight)

dichloromethane/acetone/cyclopentanone/ethanol/isobutanol/cyclohexane (65/10110151515; parts by weight)

dichloromethane/methyl ethyl ketone/acetone/methanol/ethanol (70/10/10/5/5; parts by weight)

dichloromethane/acetone/ethyl acetate/ethanol/butanol/hexane (65/10/10/5/5/5; parts by weight)

dichloromethane/methyl acetoacetate/methanol/ethanol (65/20/10/5; parts by weight)

dichloromethane/cyclopentanone/ethanol/butanol (65/20/10/5; parts by weight)

(Chlorine-Free Solvent)

Next, chlorine-free organic solvents to be preferably used in preparing a solution of the cellulose acylate of the invention are described below. In the invention, the chlorine-free organic solvent is not particularly limited as to the kind as long as it dissolves cellulose acylate and the solution permits satisfactory casting and filming. As the chlorine-free organic solvent to be used in the invention, solvents selected from among esters, ketones and ethers having from 3 to 12 carbon atoms are preferred. The esters, ketones and ethers may have a cyclic structure. Those compounds which have two or more functional groups of ester, ketone and ether (i.e., —O—, —CO— and —COO—) may also be used as a main solvent. Also, the compounds may have other functional group such as an alcoholic hydroxyl group. With the main solvents having two or more kinds of functional groups, the number of carbon atoms should be within the scope of the number of carbon atoms of the compound having one of the functional group. Examples of esters having from 3 to 12 carbon atoms include ethyl formate, propyl formate, pentyl formate, methyl acetate, ethyl acetate and pentyl acetate. Examples of ketones having from 3 to 12 carbon atoms include acetone, methyl ethyl ketone, diethyl ketone, diisobutyl ketone, cyclopentanone, cyclohexanone and methylcyclohexanone. Examples of ethers having from 3 to 12 carbon atoms include diisopropyl ether, dimethoxymethane, dimethoxyethane, 1,4-dioxane, 1,3-dioxolan, tetrahydrofuran, anisole and phenetole. Examples of the organic solvent having two or more functional groups include 2-ethoxyethyl acetate, 2-methoxyethanol and 2-butyoxyethanol.

The chlorine-free organic solvent to be used for cellulose acylate is selected from various viewpoints described hereinbefore, and is preferably as follows. That is, a preferred solvent for the cellulose acylate of the invention is a mixture of three or more solvents different from each other. A first solvent is at least one solvent selected from among methyl acetate, ethyl acetate, methyl formate, ethyl formate, acetone, dioxolan and dioxane or a mixture solution thereof, a second solvent is selected from among ketones and acetoacetates having from 4 to 7 carbon atoms, and the third solvent is selected from among alcohols and hydrocarbons having from 1 to 10 carbon atoms, preferably from among alcohols having from 1 to 8 carbon atoms. Additionally, in the case where the first solvent is a mixture solution of two or more solvents, the second solvent may be omitted. Further, the first solvent is preferably methyl acetate, acetone, methyl formate, ethyl formate or a mixture thereof, and the second solvent is preferably methyl ethyl ketone, cyclopentanone, cyclohexanone, methyl acetoacetate or a mixture thereof.

The third solvent of alcohol may be straight-chained, branched or cyclic. A saturated aliphatic hydrocarbon alcohol is preferred. The hydroxyl group of the alcohol may be any of primary to tertiary hydroxyl groups. Examples of the alcohol include methanol, ethanol, 1-propanol, 2-propanol, 1-butanol, 2-butanol, t-butanol, 1-pentanol, 2-methyl-2-butanol and cyclohexanol. Additionally, fluorine-containing alcohols may also be used as the alcohol. Examples thereof include 2-fluoroethanol, 2,2,2-trifluoroethanol and 2,2,3,3-tetrafluoro-1-propanol. Further, hydrocarbons may be straight-chained, branched or cyclic. Either of aromatic hydrocarbons and aliphatic hydrocarbons may be used. The aliphatic hydrocarbons may be saturated or unsaturated. Examples of the hydrocarbons include cyclohexane, hexane, benzene, toluene and xylene. These alcohols and hydrocarbons to be used as the third solvent may be independently used or may be a mixture of two or more of them, and are not particularly limited. Specific alcohol compounds preferred as the third solvent include methanol, ethanol, 1-propanol, 2-propanol, 1-butanol, 2-butanol and cyclohexanol, and specific hydrocarbon compounds preferred include cyclohexane and hexane. Particularly preferred are methanol, ethanol, 1-propanol, 2-propanol and 1-butanol.

The mixed solvent composed of three kinds of solvents contains preferably from 20 to 95% by weight of the first solvent, from 2 to 60% by weight of the second solvent and from 2 to 30% by weight of the third solvent. More preferably, the mixed solvent contains from 30 to 90% by weight of the first solvent, from 3 to 50% by weight of the second solvent and from 3 to 25% by weight of the third, alcohol solvent. Particularly preferably, the mixed solvent contains from 30 to 90% by weight of the first solvent, from 3 to 30% by weight of the second solvent and from 3 to 15% by weight of the third, alcohol solvent. Additionally, in the case where the first solvent is a mixed solution and the second solvent is omitted, the mixed solvent contains preferably from 20 to 90% by weight of the first solvent, from 20 to 90% by weight of the second solvent and from 5 to 30% by weight of the third solvent and, more preferably, the mixed solvent contains from 30 to 86% by weight of the first solvent, and from 7 to 25% by weight of the third solvent. The chlorine-free organic solvents to be used in the invention are described in more detail in Hatsumei Kyokai Kokai Giho (Kogi No. 2001-1745, issued on Mar. 15, 2001 by Hatsumei Kyokai) on pages 12 to 16. Preferred combinations of the chlorine-free organic solvent to be employed in the invention are illustrated below which, however, are not limitative at all.

methyl acetate/acetone/methanol/ethanol/butanol (75/10/5/5/5; parts by weight)

methyl acetate/acetone/methanol/ethanol/propanol (75/10/5/5/5; parts by weight)

methyl acetate/acetone/methanol/butanol/cyclohexane (75/10/5/5/5; parts by weight)

methyl acetate/acetone/ethanol/butanol (81/8/7/4; parts by weight)

methyl acetate/acetone/ethanol/butanol (82/10/4/4; parts by weight)

methyl acetate/acetone/ethanol/butanol (80/10/4/6; parts by weight)

methyl acetate/methyl ethyl ketone/methanol/butanol (80/10/5/5; parts by weight)

methyl acetate/acetone/methyl ethyl ketone/ethanol/isopropanol (75/8/5/5/7; parts by weight)

methyl acetate/cyclopentanone/methanol/isopropanol (80/7/5/8; parts by weight)

methyl acetate/acetone/butanol (85/10/5; parts by weight)

methyl acetate/cyclopentanone/acetone/methanol/butanol (60/15/14/5/6; parts by weight)

methyl acetate/cyclohexanone/methanol/hexane (70/20/5/5; parts by weight)

methyl acetate/methyl ethyl ketone/acetone/methanol/ethanol (50/20/20/5/5; parts by weight)

methyl acetate/1,3-dioxolan/methanol/ethanol (70/20/5/5; parts by weight)

methyl acetate/dioxan/acetone/methanol/ethanol (60/20/10/5/5; parts by weight)

methyl acetate/acetone/cyclopentanone/ethanol/isobutanol/cyclo-hexane (65/10/10/5/5/5; parts by weight)

methyl formate/methyl ethyl ketone/acetone/methanol/ethanol (50/20/20/5/5; parts by weight)

methyl formate/acetone/ethyl acetate/ethanol/butanol/hexane (65/10/10/5/5/5; parts by weight)

acetone/methyl acetoacetate/methanol/ethanol (65/20/10/5; parts by weight)

acetone/cyclopentanone/ethanol/butanol (65/20/10/5; parts by weight)

acetone/1,3-dioxolan/ethanol/butanol (65/20/10/5; parts by weight)

1,3-dioxolan/cyclohexanone/methyl ethyl ketone/methanol/butanol (55/20/10/5/5/5; parts by weight)

Further, the cellulose acylate solution may be prepared by the following method.

A cellulose acylate solution is prepared by using a mixture of methyl acetate/acetone/ethanol/butanol (81/8/7/4; parts by weight) and, after filtration and concentration, additionally adding thereto 2 parts by weight of butanol.

A cellulose acylate solution is prepared by using a mixture of methyl acetate/acetone/ethanol/butanol (84/10/4/2; parts by weight) and, after filtration and concentration, additionally adding thereto 4 parts by weight of butanol.

A cellulose acylate solution is prepared by using a mixture of methyl acetate/acetone/ethanol (84/10/6; parts by weight) and, after filtration and concentration, additionally adding thereto 5 parts by weight of butanol.

(Properties of the Cellulose Acylate Solution)

The cellulose acylate solution of the invention is preferably a 10 to 30% by weight solution in an organic solvent, more preferably a 13 to 27% by weight solution, particularly preferably a 15 to 25% by weight solution. In order to adjust the concentration of cellulose acylate to such concentration level, the concentration level may be attained at the stage of dissolving cellulose acylate, or a solution of a lower concentration level (for example, 9 to 14% by weight) previously prepared may be converted to a solution of a higher concentration by a concentrating step to be described hereinafter. Further, a cellulose acylate solution of a higher concentration level previously prepared may be converted to a cellulose acylate solution of a predetermined lower concentration by adding various additives. Any method may be employed with no particular problems as long as the concentration of cellulose acylate is adjusted to the above-mentioned range.

Next, the molecular weight of aggregates of cellulose acylate in a 0.1 to 5% by weight dilute solution in the organic solvent of the same formulation as that of the cellulose acylate solution is preferably from 150,000 to 15,000,000, more preferably from 180,000 to 9,000,000. This molecular weight of the aggregates can be determined by the static light-scattering method. Dissolution of cellulose acylate is conducted so that the square radius of inertia to be determined at the same time becomes preferably from 10 to 200 nm, more preferably from 20 to 200 mm. Also, it is preferred to conduct dissolution so that the second virial coefficient becomes within the range of from −2×10⁻⁴ to 4×10⁻⁴, more preferably from −2×10⁻⁴ to 2×10⁻⁴.

Here, definitions of the molecular weight of aggregates, square radius of inertia and second virial coefficient are given below. These were measured by using the static light-scattering method according to the following methods. Although the measurements were conducted in a dilute region for reasons of apparatus, the values obtained by the measurements reflect the behavior of dope in a high concentration region of the invention. First, cellulose acylate to be measured was dissolved in a solvent for dope to prepare solutions of 0.1% by weight, 0.2% by weight, 0.3% by weight and 0.4% by weight, respectively. Additionally, in order to prevent absorption of moisture, cellulose acylate used was dried at 120° C. for 2 hours before weighing, and the measurements were conducted at 25° C. and 10%/RH. Dissolution was conducted according to the method employed upon preparing the dope (method of dissolving at ordinary temperature, method of dissolving under cooling or method of dissolving at an elevated temperature). Subsequently, the resulting solutions and the used solvent were filtered through a 0.2 μm, Teflon-made filter. The static light scattering of the thus filtered solutions was measured at 25° C. in the range of from 30° to 140° at 10° intervals using a light scattering-measuring apparatus (DLS-700; manufactured by Otsuka Denshi K.K.). The resulting data were analyzed by the BERRY plotting method. Additionally, as refractive index necessary for this analysis, refractive index of the solvent determined by the Abbé's refractometer system was used, and concentration gradient of refractive index (dn/dc) was measured by means of a differential refractometer (DRM-1021; manufactured by Otsuka Denshi K.K.) using the solvent and the solution used for light-scattering measurement.

(Preparation of Dope)

As to preparation of the cellulose acylate solution (dope) of the invention, the dissolving method is not particularly limited, and dissolution can be performed at room temperature, or by a method of dissolving under cooling or a method of dissolving at an elevated temperature or, further, by a combination of these methods. With respect to these methods, methods for preparing a cellulose acylate solution are described in, for example, JP-A-5-163301, JP-A-61-106628, JP-A-58-127737, JP-A-9-95544, JP-A-10-95854, JP-A-10-45950, JP-A-2000-53784, JP-A-11-322946, JP-A-11-322947, JP-A-2-276830, JP-A-2000-273239, JP-A-11-71463, JP-A-04-259511, JP-A-2000-273184, JP-A-11-323017 and JP-A-11-302388. These methods of dissolving cellulose acylate in an organic solvent can properly be applied to the invention as long as they are within the scope of the invention. Detailed descriptions on them, particularly on the chlorine-free solvent system, are given in Katsumei Kyokai Kokai Giho (Kogi No. 2001-1745, issued on Mar. 15, 2001 by Hatsumei Kyokai), on pages 22 to 25. Further, the cellulose acylate dope solution of the invention is usually concentrated and filtered as Likewise described in detail in Hatsumei Kyokai Kokai Giho (Kogi No. 2001-1745, issued on Mar. 15, 2001 by Hatsumei Kyokai), on page 25. Additionally, in the case of dissolving at an elevated temperature, dissolution is conducted in most cases at a temperature of, or higher than, a boiling point of the organic solvent used. In this case, dissolution is conducted under pressure.

The cellulose acylate solution of the invention has a viscosity and a dynamic storage modulus within certain ranges, respectively. 1 ml of a sample solution was subjected to the measurement using a rheometer (CLS 500) and Steel Cone of 4 cm/2° in diameter (both made by TA Instruments Co.). The static non-Newtonian viscosity at 40° C.° (n*; unit: Pa·s) and the storage modulus at −5° C. (G′; unit: Pa) were determined by measuring under the conditions of 2° C./min within the range of from 40° C. to −10° C. in Oscillation Step/Temperature Ramp.

Additionally, the temperature of the sample solution was maintained at a constant level of the measurement-initiating temperature before initiation of the measurement. In the invention, the viscosity at 40° C. is preferably from 1 to 400 Pa·s, more preferably from 10 to 200 Pa·s, and the dynamic storage modulus at 15 C is preferably 500 Pa or more, more preferably from 100 to 1,000,000. Further, the dynamic storage modulus at a low temperature is preferably as large as possible. For example, in the case where the temperature of a casting support is −5° C., the dynamic storage modulus at −5° C. is preferably from 10,000 to 1,000,000 Pa and, in the case where the temperature of the support is −50° C., the dynamic storage modulus at −50° C. is preferably from 10,000 to 5,000,000.

As has been mentioned hereinbefore, concentration of the cellulose acylate solution is characterized in that a highly concentrated dope can be obtained. A highly concentrated cellulose acylate solution having an excellent stability can be obtained without concentrating procedure. Further, it is also possible to dissolve cellulose acylate in a low concentration, then concentrate by some concentrating means. Methods for concentration are not particularly limited but, for example, concentration can be conducted by a method of introducing a lowly concentrated solution between a cylinder and a rotation locus of the periphery of a blade provided in the cylinder and rotating in the peripheral direction, and producing a temperature difference from the solution to evaporate the solvent and obtain a highly concentrated solution (e.g., JP-A-4-259511), or by a method of jetting a heated, lowly concentrated solution into a vessel through a nozzle, whereby the solvent is flash-distilled while the solution travels from the nozzle to the inner wall of the vessel, and at the same time withdrawing the solvent vapor from the vessel and a highly concentrated solution from the bottom (e.g., U.S. Pat. Nos. 2,541,012, 2,858,229, 4,414,341 and 4,504,355).

Prior to casting, it is preferred to filter the solution through a suitable filtering material such as wire gauze for removing foreign matters such as insoluble substances, dirt and impurities. A filter of 0.1 to 100 μm in absolute filtering accuracy is used for filtration of the cellulose acylate solution, with a filter of 0.5 to 25 μm in absolute filtering accuracy being more preferably used. The thickness of the filter is preferably from a 0.1 to 10 mm, more preferably from 0.2 to 2 mm. Upon filtering, the filtering pressure to be applied is preferably 16 kgf/cm² or less, more preferably 12 kgf/cm² or less, still more preferably 10 kgf/cm² or less, particularly preferably 2 kgf/cm² or less. As a filtering material, conventionally known materials such as glass fiber, cellulose fiber, filter paper and fluorine-containing resins (e.g., tetrafluoroethylene resin) can preferably be used and, particularly preferably, ceramics and metals can be used. The viscosity of the cellulose acylate solution immediately before filming may be any value as long as the solution can be cast upon filming, and is usually adjusted to be within the range of from 10 Pa·s to 2,000 Pa·s, more preferably from 30 Pa·s to 1,000 Pa·s, still more preferably from 40 Pa·s to 500 Pa·s. Additionally, the temperature upon filming is not particularly limited and may be a temperature upon casting, but is preferably from −5 to 70° C., more preferably from −5 to 55° C.

(Filming)

The process for producing film using the cellulose acylate solution is described below. As the process and apparatus for producing the cellulose acylate film of the invention, a filming process of casting the solution and a filming apparatus for casting the solution, which have conventionally been used for producing cellulose triacetate film, are used. A dope (cellulose acylate solution) prepared in a dissolving machine (tank) is once stored in a storage tank and foam contained in the dope is removed to prepare a final solution. The resulting dope is discharged through a dope-discharging outlet through, for example, a pressure type fixed delivery gear pump capable of precisely delivering a fixed amount of the solution depending upon rotation number to a pressure type die, and the solution is uniformly cast onto an endlessly traveling metal support provided in the casting stage through a slit of the pressure type die and, at the peeling point where the metal support almost makes a round, the half-dried dope film (also called “web”) is peeled from the metal support The both ends of the resultant web are gripped with clips, and the web was conveyed by means of a tenter with maintaining the width. Subsequently, the web is conveyed by means of rolls in a drying apparatus to complete drying, followed by rolling up the web in a predetermined length. The combination of the tenter and the rolls in the drying apparatus is varied depending upon the purposes thereof. In the solution-casting, filming method employed for producing silver halide photographic light-sensitive materials or functional protective films for use in an electronic display, a coating apparatus is often additionally provided for surface-processing of the film for forming, for example, a subbing layer, an antistatic layer, an anti-halation layer and a protective layer. Respective steps are simply described below which, however, are not limitative at all.

First, the thus prepared cellulose acylate solution (dope) is formed into a cellulose acylate film by the solvent casting method wherein the dope is cast onto a drum or a band to evaporate the solvent and form a film. The concentration of the dope is preferably adjusted to 5 to 40% by weight in terms of solids before casting. The surface of the drum or band preferably has a mirror finish. The dope is cast onto the drum or band having a surface temperature of preferably 30° C. or less. The temperature of the metal support is particularly preferably from −10° C. to 20° C. Further, techniques described in JP-A-2000-301555, JP-A-2000-301558, JP-A-7-32391, JP-A-3-193316, JP-A-5-86212, JP-A-62-37113, JP-A-2-276607, JP-A-55-14201, JP-A-2-111511 and JP-A-2-208650 can be applied to the invention.

(Multi-Layer Casting)

The cellulose acylate solution may be cast onto a metal support of smooth band or drum as a single layer solution, or two or more cellulose acylate solutions may be cast. In the case of casting a plurality of cellulose acylate solutions, the solutions may be cast through respective plural slits provided at intervals in the direction of travel of the metal support to form a film as a laminate. For example, processes described in JP-A-61-158414, JP-A-1-122419 and JP-A-11-198285 may be applied. Also, filming may be conducted by casting the cellulose acylate solution through two casting slits, which can be conducted by the processes described in, for example, JP-B-60-27562, JP-A-61-94724, JP-A-61-947245, JP-A-61-104813, JP-A-61-158413 and JP-A-6-136933. Also, a cellulose acylate film-casting process of enveloping a flow of a highly viscous cellulose acylate solution by a lowly viscous cellulose acylate solution, and co-extruding the highly viscous solution and the lowly viscous solution in such state, described in JP-A-56-162617, may be employed. Further, it is also a preferred embodiment to incorporate a poor solvent of alcohol component in the outer solution in more amount than in the inner solution as described in JP-A-61-94724 and JP-A-61-94725. Or, it is also possible to use two casting slits, delaminate a film formed on a metal support by casting through the first casting slit, then conduct second casting through the second slit onto the side which has been in contact with the metal support surface. This process is described in, for example, JP-B-44-20235. The solutions to be cast are not particularly limited and may be the same solution or may be different cellulose acylate solutions. In order to impart different functions to a plurality of cellulose acylate layers, it suffices to cast cellulose acylate solutions for respective functions through respective casting slits. It is also possible to cast the cellulose acylate solution simultaneously with other functional layers (e.g., an adhesive layer, a dye-containing layer, an antistatic layer, an anti-halation layer, a UV-absorbing layer and a polarizing layer).

In order to obtain a film of a necessary thickness, the conventional single layer solution has required to be extruded as a highly concentrated, highly viscous cellulose acylate solution. In such case, the cellulose acylate solution has such a poor solubility that solids have been formed, which often causes problems such as blobbing trouble and poor flatness. In order to solve the problems, a highly viscous solution can be simultaneously extruded through a plurality of casting slits onto a metal support, which not only serves to provide a film having an improved flatness and excellent surface properties but permits to use a highly concentrated cellulose acylate solution, thus drying load being reduced and production speed being increased.

In the case of co-casting, the thickness of the inside film and the thickness of the outside film are not particularly limited, but the thickness of the outside film is preferably from 1 to 50%, more preferably from 2 to 30%, based on the whole thickness. In the case of co-casting three or more layers, the thickness of the outside film is defined as sum of the thickness of the layer in contact with the metal support and the thickness of the layer in contact with the air. In the case of co-casting, a cellulose acylate film of a laminated structure can be formed by co-casting cellulose acylate solutions different from each other in the concentrations of the aforementioned additives (e.g., a plasticizer, an ultraviolet absorber and a matting agent). For example, a cellulose acylate film having a structure of skin layer/core layer/skin layer can be formed. For example, the matting agent can be incorporated in a more amount in the skin layer or in only the skin layer. The plasticizer and the ultraviolet absorber can be incorporated in more amounts in the core layer then in the skin layer, or may be incorporated only in the core layer. It is also possible to change the kind of the plasticizer and the ultraviolet absorber between the core layer and the skin layer. For example, it is possible to incorporate a low-volatile plasticizer and/or low-volatile ultraviolet absorber in the skin layer and to add a plasticizer excellent in plasticizing ability or a ultraviolet absorber excellent in UV ray-absorbing ability to the core layer. It is also a preferred embodiment to incorporate a peeling accelerator only in a skin layer on the metal support side. In order to gel the solution by cooling the metal support according to the cooled drum process, it is also preferred to add a poor solvent of alcohol to the skin layer in a more amount than to the core layer. The skin layer and the core layer may be different from each other in Tg, and it is preferred that Tg of the core layer is lower than Tg of the skin layer. Also, upon casting, the viscosity of the cellulose acylate-containing solution for the skin layer may be different from that for the core layer, and the viscosity of the solution for the skin layer is preferably smaller than that for the core layer, though the viscosity of the solution for the core layer may be smaller than that for the skin layer.

(Casting)

As a method of casting the solution, there are a method of uniformly extruding the previously prepared dope through a pressure die onto a metal support, a method of using a doctor blade wherein the thickness of the dope once cast onto the metal support is adjusted by means of a blade, and a method of using a reverse roll coater wherein the thickness is adjusted by means of a reversely rotating roll, with the pressure die-using method being preferred. The pressure die includes a coat hunger die type and a T die type, with either of them being preferably usable. Also, the cellulose acetate film can be prepared by various conventionally known cast-filming processes using the cellulose triacetate solution other than are illustrated hereinbefore. The same effects as are described in respective patent documents can be obtained by selecting the conditions in consideration of the difference in boiling point of the solvent used. As the endlessly traveling metal support to be used for producing the cellulose acylate film of the invention, a drum having a surface mirror-finished by chromium plating or a stainless steel belt (which may also be called “band”) having a surface mirror-finished by surface polishing may be used. As the pressure die to be used for producing the cellulose acylate film of the invention, one, two or more dies may be provided in the upstream region of the metal support, with one or two dies being preferably provided. In the case of providing two or more dies, the dope to be cast may be divided with various proportions for respective dies, and the dope may be delivered to respective dies in respective proportions using a plurality of a precise fixed deliver gear pumps. The temperature of the cellulose acylate solution to be used for casting is preferably from −10 to 55° C., more preferably from 25 to 50° C. In this case, the temperature may be the same during all steps, or may be different in respective steps. In the case where the temperature varies in respective steps, it suffices that the temperature is at a desired level immediately before casting.

(Drying)

As a method for drying the dope on the metal support in accordance with the production of the cellulose acylate film of the invention, there are generally illustrated a method of applying a hot air to the surface of the metal support (drum or belt), that is, to the surface of the web formed on the metal support, a method of applying a hot air from the back side of the drum or belt, and a heat-conducting method using a liquid wherein a temperature-controlled liquid is brought into contact with the back side (opposite side to the dope-cast side) of the drum or belt to thereby control the surface temperature, with the heat-conducting method of applying a liquid to back side of the belt or drum being preferred. The surface temperature of the metal support before casting may be any degree as long as it is below the boiling point of the solvent for the dope. In order to accelerate drying and remove flowability of the dope on the metal support, however, it is preferred to set the temperature at a level 1 to 10 degrees lower than the boiling point of the solvent having the lowest boiling point among the solvents used for the dope. However, this does not apply in the case where the cast dope is cooled and peeled without drying.

(Stretching Treatment)

Retardation of the cellulose acetate film of the invention can be adjusted by stretching treatment. Further, there is a method of positively stretching in the transverse direction, which is described in, for example, JP-A-62-115035, JP-A-4-152125, JP-A-4-284211, JP-A-4-298310 and JP-A-11-48271. In order to obtain a high in-plane retardation value of the cellulose acylate film, the produced film is stretched.

Stretching of the film is conducted at an ordinary temperature or under heating. The heating is conducted preferably at the glass transition temperature of the film or lower than that. Stretching of the film may be uniaxial stretching in the longitudinal or transverse direction, or may be simultaneous or sequential biaxial stretching. Stretching is conducted from 1 to 200%, preferably from 1 to 100%, particularly preferably from 1 to 50%. As to the birefringence of an optical film, the refractive index in the transverse direction is preferably larger than the refractive index in the longitudinal direction. Therefore, it is preferred to more stretch in the transverse direction. Also, the stretching treatment may be conducted during the film-producing steps, or the formed and wound raw film may be stretched. In the former case, stretching may be conducted in a state where the solvent remains. Stretching can be preferably conducted when the amount of residual solvent is from 2 to 30%.

The thickness of the finished (dried) cellulose acylate film of the invention varies depending upon the end use, but is usually in the range of from 5 to 500 μm, preferably in the range of from 20 to 300 μm, more preferably in the range of from 30 to 150 μm, still more preferably in the range of from 40 to 110 μm. In particular, the thickness is preferably from 40 to 110 μm for use in a VA liquid crystal display. Adjustment of the thickness can be conducted by adjusting the concentration of solids contained in the dope, gap between slits of dies, pressure for extruding from the die and speed of the metal support so that the desired thickness can be obtained. The width of the thus-obtained cellulose acylate film is preferably from 0.5 to 3 m, more preferably from 0.6 to 2.5 m, still more preferably from 0.8 to 2.2. As to the length of the film, it is preferred to wind up a film of 100 to 10,000 m in length per roll, more preferably 500 to 7,000 m, still more preferably 1,000 to 6,000 m. Upon winding up the film, it is preferred to provide knurling at least on one edge with a width of from 3 mm to 50 mm, preferably from 5 mm to 30 mm, and a height of from 0.5 to 500 μm, more preferably from 1 to 200 μm. This may be one side pressing or both sides pressing. Fluctuation in Re value in the transverse direction is preferably within ±5 m, more preferably within ±3 nm. Also, fluctuation in Rth value is preferably within ±10 nm, more preferably within ±5 nm. Further, fluctuation in Re value in the longitudinal direction and fluctuation in Rth value in the longitudinal direction are preferably within the ranges for those in the transverse direction. In order to maintain transparent appearance, the haze is preferably from 0.01 to 2%. Reduction of the haze can be attained by well dispersing fine particles of a matting agent added to thereby reduce the number of agglomerated particles or by using the matting agent only in the skin layer for decreasing the addition amount thereof.

(Optical Properties of the Cellulose Acylate Film)

As to optical properties of the cellulose acylate film of the invention, it is preferred that Re retardation value wherein Re is defined by formula (III): Re(λ)=(nx−ny)×d, and Rth retardation value wherein Rth is defined by formula (IV): Rth(λ)={(nx+ny)/2−nz}×d respectively satisfy the following formulae (V) and (VI):
46 nm≦Re(630)≦200 nm (V)
70 nm≦Rth(630)≦350 nm (VI)
(wherein Re(λ) represents a retardation value (unit: nm) in a film plane of the cellulose acylate film at a wavelength of λnm, Rth(λ) represents a retardation value (unit: nm) in the direction perpendicular to the film plane (thickness direction) at a wavelength of λnm, nx represents a refractive index within the film plane in the slow axis direction, ny represents a refractive index within the film plane in the fast axis direction, nz represents a refractive index in the thickness direction of the cellulose acylate film, and d represents a thickness of the cellulose acylate film).

Re(λ) can be measured by means of KOBRA 21ADH (manufactured by Oji Keisokukiki K.K.) with irradiating the film with a light of λnm in wavelength in the direction normal to the film. Also, Rth(λ) can be calculated based on three retardation values of the Re(λ), the retardation value measured by irradiating the film with a light of λnm in the direction +40° inclined with respect to the normal direction to the film with taking the inplane slow axis as the inclined axis, and the retardation value measured by irradiating the film with a light of λnm in the direction −40° inclined with respect to the normal direction to the film with taking the inplane slow axis as the inclined axis, by inputting 1.48 which is the hypothetical value of average refractive index and the film thickness.

More preferably, Re and Rth satisfy the following formulae (VII) and (VIII):
46 nm≦Re(630)≦100 nm (VII)
160 nm≦Rth(630)≦350 nm. (VIII)

With a VA type liquid crystal display using only one optical film and only one polarizing plate of the invention, it is preferred to satisfy the following formulae (IX) and (X) in addition to the formulae (VII) and (VIII):
Rth₍₆₃₀₎=a−5.9Re₍₆₃₀₎ nm (IX)
580≦a≦670 nm. (X)

The optimal calculated value of y intercept, a, of the straight line of formula (IX) is 560 nm and, as the value deviates downward from 560, the black luminance value of the VA liquid crystal display increases. As the value deviates upward from 560, Change in color tone, which depends on the viewing angle of the liquid crystal display, increases. That is, there arises light leakage and the display does not appear black. The formula (X) shows the acceptable range of the a value. With the VA type liquid crystal display device which uses only one polarizing plate, it is particularly preferred that 55 nm≦Re₍₆₃₀₎≦85 m and 535 nm≦a≦585 nm. Re₍₆₃₀₎ and Rth₍₆₃₀₎ vary depending upon the Δn·d value of the VA liquid crystal display device to be used. For example, when the Δn·d value of the VA liquid crystal display device is 350 nm, the most preferred Re₍₆₃₀₎and Rth₍₆₃₀₎are from 55 to 60 and from 185 to 275, respectively. When the Δn·d value of the VA liquid crystal display device is 300 nm, the most preferred Re₍₆₃₀₎and Rth₍₆₃₀₎are from 60 to 65 and from 160 to 240, respectively.

The optically characteristic values of Re and Rth change with variation in humidity, variation in weight due to passage of time at an elevated temperature and variation in dimension. The change in the Re value and Rth value is preferably minimized. In order to reduce change in optical characteristics due to variation in humidity, use of cellulose acylate having a large substitution degree at 6-position by the acyl group is employed. Also, various hydrophobic additives (e.g., a plasticizer, a retardation-producing agent and an ultraviolet absorber) are used for reducing water vapor permeability or equilibrium moisture content of the film. The water vapor permeability is preferably from 400 g to 2,300 g per m² for 24 hours under the conditions of 60° C. and 95% RH. The equilibrium moisture content measured at 25° C. and 80% RH is preferably 3.4% or less. Variations of optical characteristics when humidity at 25° C. is changed from 10% RH to 80% RH are preferably 12 nm or less in terms of the Re value and 32 nm or less in terms of the Rth value. The amount of the hydrophobic additive is preferably from 10 to 30% by weight, more preferably from 12 to 25% by weight, particularly preferably from 14.5% to 20% by weight, based on the weight of cellulose acylate. When the weight or dimension of the film changes due to volatilization or decomposition of the additive, the optical characteristics change. Therefore, variation of the film weight after being allowed to stand for 48 hours at 80° C. and 90% RH is preferably 5% or less. Likewise, variation of the film dimension after being allowed to stand for 24 hours at 60° C. and 90% RH or to stand for 24 hours at 90° C. and 3% RH is preferably from −2 to +2%. Also, even when dimension or weight of the film changes to some extent, a small photoelastic coefficient would reduce the variations of optical characteristics. Therefore, the photoelastic of the film is preferably 50×10⁻¹³ cm²/dyne or less.

(Polarizing Plate)

The polarizing plate comprises a polarizer and two transparent protective films, wherein the polarizing plate is between the two transparent protective films. The cellulose acylate film of the invention can be used as one of the protective films. As the other protective film, a common cellulose acetate film may be used. The polarizer includes an iodine-containing polarizer, a dye-containing polarizer using a dichroic dye, and a polyene-based polarizer. The iodine-containing polarizer and the dye-containing polarizer are generally produced by using a polyvinyl alcohol-based film. In the case of using the cellulose acylate film of the invention as a protective film for the polarizing plate, the method for preparing the polarizing plate is not particularly limited, and the polarizing plate may be prepared by a general method. There is a method of subjecting the resultant cellulose acylate film to an alkali treatment and superposing the film on both sides of a polarizer having been prepared by stretching a polyvinyl alcohol film in an iodine solution, using an aqueous solution of a completely saponified polyvinyl alcohol aqueous solution. In place of the alkali treatment, an easily adhesive processing as described in JP-A-6-94915 and JP-A-6-118232 may be employed. Examples of the adhesive to be used for adhering the treated surface of the protective film to the polarizer include polyvinyl alcohol-based adhesives such as polyvinyl alcohol-based adhesive and polyvinyl butyral-based adhesive and vinyl-based latexes such as butyl acrylate-based latex. The polarizing plate is constituted by the polarizer and the protective films for protecting both sides of the polarizer and, further, a protection film on one side of the polarizing plate and a separable film on the other side thereof. The protection film and the separable film are used for the purpose of protecting the polarizing plate upon shipping or checking the product. In this case, the protection film is superposed for the purpose of protecting the surface of the polarizing plate and is used on the side opposite to the side which is to be stacked onto a liquid crystal plate. Also, the separable film is used for the purpose of covering the adhesive layer to be laminated onto the liquid crystal plate and is used on the side which is to be stacked onto the liquid crystal plate.

The cellulose acylate film of the invention is preferably stacked onto the polarizer so that the transmission axis of the polarizer coincides with the slow axis of the cellulose acylate film of the invention. Additionally, it has been found by evaluation of the prepared polarizing plate under cross-Nicol position of the polarizing plate that, when the rectangular accuracy between the slow axis of the cellulose acylate film of the invention and the absorption axis (axis crossing at right angles with the transmission axis) is more than 1°, polarizing performance under cross-Nicol position of the polarizing plate is deteriorated so much that there arises filtering of light. In such occasion, a sufficient black level or a sufficient contrast can not be obtained when such polarizing plate is combined with a liquid crystal cell. Therefore, deviation between the direction of the main refractive index, nx, of the cellulose acylate film of the invention and the direction of the transmission axis of the polarizing plate is preferably within 1°, more preferably within 0.50.

It is preferable that the polarizing plate according to the invention fulfills at least one of the following formulae (a) to (d):
40.0≦TT≦45.0 (a)
30.0≦PT≦40.0 (b)
CT≦2.0 (c)
95.0≦P (d)
wherein TT represents a single plate transmittance at 25° C. and 60% RH; PT represents a parallel transmittance at 25° C. and 60% RH; CT represents a cross transmittance at 25° C. and 60% RH; and P represents a polarization degree at 25° C. and 60% RH.

It is still preferable that single plate transmittance TT, the parallel transmittance PT, the cross transmittance CT respectively fulfill the following relationships: 40.5≦TT≦45, 32≦PT≦39 and CT≦1.5, still preferably 41.0≦TT≦44.5, 34≦PT≦39.0 and CT≦1.3, respectively. The degree of polarization is preferably 95.0% or more, still protective film 96.0% or more and still preferably 97.0% or more.

It is preferable that the polarizing plate according to the invention fulfills at least one of the following formulae (e) to (g):
CT₍₃₈₀₎≦2.0 (e)
CT₍₄₁₀₎≦1.0 (f)
CT₍₇₀₀₎≦0.5 (g)
wherein CT(λ) represents a cross transmittance at a wavelength of λ nm.

It is still preferable that the polarizing plate according to the invention fulfills at least one of CT₍₃₈₀₎≦1.95, CT₍₄₁₀₎≦0.9 and CT₍₇₀₀₎≦0.49, and more still preferable that the polarizing plate according to the invention fulfills at least one of CT₍₃₈₀₎≦1.90, CT₍₄₁₀₎≦0.8 and CT₍₇₀₀₎≦0.48.

It is preferable that the polarizing plate of the present invention fulfills at least one of the following formulae (j) and (k):
−6.0≦ΔCT≦6.0 (j)
−10.0≦ΔP≦0.0 (k)
wherein ΔCT and ΔP represents a change in cross transmittance and polarization degree, respectively, in a test that the polarizing plate is allowed to stand at 60° C. and 95% RH for 500 hours; and the change means a value calculated by subtracting a measurement value before the test from a measurement value after the test.

−5.8≦ΔCT≦5.8 and −9.5≦ΔP≦0.0 are still preferable, and −5.6≦ΔCT≦5.6 and −9.0≦ΔP≦0.0 are still preferable.

It is preferable that the polarizing plate of the present invention fulfills at least one of formulae (h) and (i):
−6.0≦ΔCT≦6.0 (h)
−10.0≦ΔP≦0.0 (i)
wherein ΔCT and ΔP represents a change in cross transmittance and polarization degree, respectively, in a test that the polarizing plate is allowed to stand at 60° C. and 90% RH for 500 hours.

(It is preferable that the polarizing plate of the present invention fulfills at least one of formulae (l) and (m):
−6.0≦ΔCT≦6.0 (l)
−10.0≦ΔP≦0.0 (m)
+ wherein ΔCT and ΔP represents a change in cross transmittance and polarization degree, respectively, in a test that the polarizing plate is allowed to stand at 80° C. for 500 hours.

The single plate transmittance TT, the parallel transmittance PT and the cross transmittance CT of the polarizing plate are measured by using UV3100PC (manufactured by SHIMADZU CORPORATION) within a range of 380 nm to 780 nm. In each of TT, PT and CT, the mean of values measured 10 times (mean within a range of 400 nm to 700 mm) is adopted. The polarizing plate durability test is carried out in two modes including (1) the polarizing plate alone and (2) the polarizing plate bonded to a glass plate via a pressure-sensitive adhesive. To measure the polarizing plate alone, two samples each having the cellulose acylate film according to the invention inserted between two polarizers are prepared and located orthogonally. In the mode of bonding the polarizing plate to a glass plate, two samples (about 5 cm×5 cm) each having the polarizing plate bonded to the glass plate in such a manner that the cellulose acylate film according to the invention is in the glass plate side are prepared. The single plate transmittance is measured by setting the film side of the samples toward a light source. Two samples are measured respectively and the mean is referred to as the transmittance of single plate.

(Moisture-Proofed Bag)

In the invention, “moisture-proofed bag (bag having been subjected to the treatment for imparting moisture-proof properties)” is specified in terms of the moisture permeability measured based on the cup method (JIS-Z208). It is preferred to use a material which has a moisture permeability of 30 g/(m²·Day) at 40° C. and 90% RH or less. When the moisture permeability of the bag exceeds 30 g/(m²·Day), the bag fails to prevent influence of the environmental humidity outside the bag. The moisture permeability is more preferably 10 g/(m²·Day) or less, most preferably 10 g/(m²·Day) or less.

The material of the moisture-proofed bag is not particularly limited as long as it has the above-mentioned level of moisture permeability, and known materials can be used. (See, for example, “Hoso Zairyo Binran” (Shadan Hojin Nilion Hoso Gijutsu Kyokai (1995)); and “Kinosei Hoso Nyumon” (21 Seiki Hoso Kenkyukai, Feb. 28, 2002 (the first edition, first print).) In the invention, materials which have low moisture permeability and a light weight and which are easy to handle are desirable. Composite materials such as films comprising a plastic film having vacuum deposited thereon silica, alumina or a ceramic material and laminate films of a plastic film having laminated thereon an aluminum foil are particularly preferably used. The thickness of the aluminum foil is not particularly limited as long as humidity within the bag does not change depending upon the environmental humidity, and is preferably from several μm to several 100 μm, more preferably from 10 μm to 500 μm. The humidity within the bag having been made moisture-proof to be used in the invention preferably satisfies either of the following conditions:

to be 43% RH to 70% RH, more preferably 45% to 65%, still more preferably 45% to 63%, at 25° C. in a state of enveloping the polarizing plate; and

to be within 15% RH in terms of the humidity within the bag enveloping the polarizing plate, in comparison with the humidity upon stacking the polarizing plate onto a liquid crystal panel.

(Surface Treatment)

The cellulose acylate film of the invention can be subjected to surface treatment, as needed, to improve adhesion between the cellulose acylate film and respective functional layers (e.g., an undercoat layer and a back layer). For example, glow discharge treatment, UV ray-irradiating treatment, corona treatment, flame treatment, or treatment with an acid or an alkali may be employed. The glow discharge treatment may be treatment with a low-temperature plasma generated in the presence of a low pressure gas of 10⁻³ to 20 Torr, or may preferably be a plasma treatment under atmospheric pressure. A plasma-generating gas means a gas which can be excited to generate plasma under the above conditions, and includes argon, helium, neon, cripton, xenon, nitrogen, carbon dioxide, Flons such as tetrafluoromethane and a mixture thereof. Detailed descriptions are given in Hatsumei Kyokai Gokai Giho (Kogi No. 2001-1745 issued on Mar. 15, 2001 by Hatsumei Kyokai) on pages 30 to 32. Additionally, in plasma treatment under atmospheric pressure which has been attracted attention in recent years, an irradiation energy of, for example, from 20 to 500 Kgy is employed under 10 to 1,000 Kev and, more preferably, an irradiation energy of from 20 to 300 Kgy is employed under 30 to 500 Kev. Among them, alkali saponification treatment is particularly preferred and is extremely effective as the surface treatment of cellulose acylate film.

The alkali saponification treatment is preferably conducted by directly dipping a cellulose acylate film into a tank retaining a saponifying solution or by coating a saponifying solution on a cellulose acylate film. As the coating method, there can be illustrated a dip coating method, a curtain coating method, an extrusion coating method, a bar coating method and an extrusion slide coating method. As the solvent for the coating solution to be used in the alkali saponification treatment, those solvents which impart to the saponifying solution a good wetting property for the transparent support and which do not form unevenness on the surface of the transparent support and maintain the surface state in a good condition are preferred. Specifically, alcoholic solvents are preferred, with isopropyl alcohol being particularly preferred. It is also possible to use an aqueous solution of a surfactant as the solvent. As the alkali to be used in the alkali-saponifying solution, alkalis soluble in the above solvent are preferred, and KOH and NaOH are more preferred. The pH of the saponifying coating solution is preferably 10 or more, more preferably 12 or more. As to reaction conditions upon saponification with alkali, the saponification is preferably conducted at room temperature for 1 second to 5 minutes, more preferably for 5 seconds to 5 minutes, particularly preferably for 20 seconds to 3 minutes. After the saponification reaction with alkali, the saponifying solution-coated surface is preferably washed with water or an acid.

(Antireflective Layer)

A functional film such as anantireflective layer is preferably provided on the transparent protective film to be provided on the opposite side to a liquid crystal cell. In the invention, anantireflective layer formed by superposing at least a light-scattering layer and a low refractive index layer in this order on the transparent protective film or anantireflective layer formed by superposing a middle refractive index layer, a high refractive index layer and a low refractive index layer in this order on the transparent protective layer is preferably used. Preferred examples thereof are described below.

A preferred embodiment of the antireflective layer formed by providing the light-scattering layer and the low refractive index layer on the transparent protective film is described below.

Matting particles are dispersed in the light-scattering layer of the invention, and the refractive index of the materials in the light-scattering layer other than the matting particles is preferably in the range of from 1.50 to 2.00. The refractive index of the low refractive index layer is preferably in the range of from 1.35 to 1.49. In the invention, the light-scattering layer has both an antiglare function and a hard coat function, and may be constituted by a single layer or a plurality of layers, for example, 2 to 4 layers.

The antireflective layer is preferably designed so that the surface unevenness is 0.08 to 0.40 μm in center-line average roughness Ra, 10 times as much as Ra or less than that in 10-point average roughness Rz, 1 to 100 μm in average peak-to-bottom distance Sm, 0.5 μm or less in standard deviation of projection heights from the deepest position, 20 μm or less in standard deviation of the average peak-to-bottom distance Sm based on the center line, and 10% or more in the proportion of planes having an inclined angle of 0 to 5 degrees, whereby a sufficient glare-reducing ability and visually uniform mat appearance can be obtained.

Also, as to the color tone of reflected light under a C light source, the color tone of reflected light becomes neutral when a* value is from −2 to 2, b* value is −3 to 3 and the ratio of the minimum reflectivity to the maximum reflectivity in the range of from 380 mm to 780 nm is from 0.5 to 0.99, thus such values being preferred. Also, when the b* value of transmitted light under the C light source is from 0 to 3, yellowing of white portions when applied to a display device is reduced, thus such value being preferred.

Further, when standard deviation of luminance distribution measured on the film with inserting a 120 μm×40 μm lattice between a plane light source and the antireflective film of the invention is 20 or less, glaring defect is reduced which might occur when the film of the invention is applied to highly fine panels, thus such standard deviation being preferred.

The antireflective layer of the invention preferably has optical characteristics of 2.5% or less in specular reflectivity, 90% or more in transmission ratio and 70% or less in 60-degree glossiness, because such antireflective layer can depress reflection of outer light and improve viewability. In particular, the specular reflectivity is more preferably 1% or less, most preferably 0.5% or less. The glaring defect on a highly fine LCD panel and blurring of a letter can be reduced by adjusting the haze value to 20% to 50%, the internal haze/total haze ratio to 0.3 to 1, the reduction in haze value after formation of the low refractive index layer from the haze value up to the light-scattering layer to within 15%, distinctness of a transmitted image of 0.5 in comb width to 20% to 50%, and the ratio of vertically transmitted light/transmitted light 2-degree inclined from the vertical line to 1.5 to 5.0, thus such adjustment being preferred.

(Low Refractive Index Layer)

The refractive index of the low refractive index layer in the antireflective film of the invention is from 1.20 to 1.49, preferably from 1.30 to 1.44. Further, in view of reducing refractivity, the low refractive index layer preferably satisfies the following formula (IX):
(m/4)×0.7<n1d1<(m/4)×1.3
wherein m represents a positive odd number, n1 represents the refractive index of the low refractive index layer, and d1 represents the thickness (nm) of the low refractive index layer. λ represents wavelength, and is a value of from 500 to 550 nm.

Materials forming the low refractive index layer of the invention are described below.

The low refractive index layer of the invention contains a fluorine-containing polymer as a binder with a low refractive index. As the fluorine-containing polymer, fluorine-containing polymers having a kinetic friction coefficient of from 0.03 to 0.20, a contact angle to water of from 90 to 120° and a slide-down angle for pure water of 70° or less and being cross-linkable by heat or by irradiation with ionizing radiation are preferred. The peeling forth necessary for peeling a commercially available adhesive tape from the antireflective film of the invention to be mounted on an image display device is preferably as small as possible because a seal or a memo adhesively applied thereto can easily be peeled therefrom, and is preferably 500 gf or less, more preferably 300 gf or less, most preferably 100 gf or less. Also, a higher surface hardness measured by means of a microhardness tester provides a less flaw-susceptible surface, and the surface hardness is preferably 0.3 GPa or more, more preferably 0.5 GPa or more.

The fluorine-containing polymer to be used for the low refractive index layer includes hydrolyzates and dehydration condensates of a perfluoroalkyl group-containing silane compound (e.g., (heptadecafluoro-1,1,2,2-tetrahydrodecyl)triethoxysilane), and fluorine-containing copolymers having as constituents a fluorine-containing monomer unit and a constituting unit for imparting cross-linking ability.

Specific examples of the fluorine-containing monomer include fluoroolefines (e.g., fluoroethylene, vinylidene fluoride, tetrafluoroethylene, perfluorooctylethylene, hexafluoropropylene and perfluoro-2,2-dimethyl-1,3-dioxole), partially or completely fluorinated alkyl ester derivatives of (meth)acrylic acid (e.g., Viscote 6FM (manufactured by Osaka Yuki Kagaku) and M-2020 (manufactured by Daikin) and completely or partially fluorinated vinyl ethers, with perfluoro-olefines being preferred. In view of refractive index, solubility, transparent property and availability, hexafluoropropylene is particularly preferred.

As the constituting unit for imparting cross-linking ability, there are illustrated a constituting unit obtained by polymerization of a monomer previously having within the molecule a self-crosslinkable functional group such as glycidyl (meth)acrylate or glycidyl vinyl ether, a constituting unit obtained by polymerization of a monomer having a carboxyl group, hydroxyl group, amino group or sulfo group (e.g., (meth)acrylic acid, methylol (meth)acrylate, hydroxyalkyl (meth)acrylate, allyl acrylate, hydroxyethyl vinyl ether, hydroxybutyl vinyl ether, maleic acid or crotonic acid), and a constituting unit obtained by introducing into these constituting units a cross-linkable group such as a (meth)acryloyl group by high molecular reaction (for example, by acting acrylic acid chloride on hydroxyl group).

It is also possible to properly copolymerize a fluorine-free monomer in addition to the above-mentioned fluorine-containing monomer and the constituting unit for imparting cross-linkable ability, in view of solubility in a solvent and transparent property. Such copolymerizable monomer units are not particularly limited, and examples thereof include olefins (e.g., ethylene, propylene, isoprene, vinyl chloride and vinylidene chloride), acrylates (e.g., methyl acrylate, ethyl acrylate and 2-ethylhexyl acrylate), methacrylates (e.g., methyl methacrylate, ethyl methacrylate, butyl methacrylate and ethylene glycol dimethacrylate), styrene derivatives (e.g., styrene, divinylbenzene, vinyltoluene and α-methylstyrene), vinyl ethers (e.g., methyl vinyl ether, ethyl vinyl ether and cyclohexyl vinyl ether), vinyl esters (e.g., vinyl acetate, vinyl propionate and vinyl cinnamate), acrylamides (e.g., N-tert-butylacrylamide and N-cyclohexylacrylamide), methacrylamides and acrylonitrile derivatives.

Curing agents may properly be used for the above-mentioned polymers as described in JP-A-10-25388 and JP-A-10-147739.

(Light-Scattering Layer)

The light-scattering layer is provided for the purpose of improving light-scattering properties due to surface scattering and/or internal scattering and imparting hard-coat properties for improving anti-scratch properties of the film. Therefore, it comprises a binder for imparting hard-coat properties, matting particles for imparting light-scattering ability and, as needed, inorganic fillers for imparting a high refractive index, preventing contraction due to cross-inking and enhancing strength.

The thickness of the light-scattering layer is preferably from 1 to 10 μm, more preferably from 1.2 to 6 μm, in view of imparting hard-coat properties and depressing generation of curling and deterioration of anti-fragile properties.

The binder for the light-scattering layer is preferably a polymer having a saturated hydrocarbon chain or a polyether chain as a main chain, with a polymer having a saturated hydrocarbon chain being more preferred. Also, the binder polymer preferably has a cross-linkable structure. As the binder polymer having a saturated hydrocarbon chain as a main chain, a polymer of an ethylenically unsaturated monomer is preferred. As the binder polymer having a saturated hydrocarbon chain as a main chain and having a cross-linkable structure, (co)polymers of a monomer having two or more ethylenically unsaturated groups are preferred. In order to enhance refractive index of the binder polymer, it is possible to introduce into the monomer structure an aromatic ring or a member containing at least one atom selected from among a halogen atom other than fluorine, a sulfur atom, a phosphorus atom and a nitrogen atom.

The monomer having two or more ethylenically unsaturated groups includes an ester between a polyhydric alcohol and (meth)acrylic acid (e.g., ethylene glycol di(meth)acrylate, butanediol (meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate or polyester polyacrylate), ethylene oxide-modified products thereof, vinylbenzene and the derivative thereof (e.g., 1,4-divinylbenzene, 2-acryloylethyl 4-vinylbenzoate or 1,4-divinylcyclohexanone), vinylsulfone (e.g., divinylsulfone), acrylamide (e.g., methylenebisacrylamide) and methacrylamide. These monomers may be used in combination of two or more thereof.

Specific examples of the monomer having a high refractive index include bis(4-methacryloylthiophenyl)-sulfide, vinylnaphthalene, vinylphenylsulfide and 4-methacryloxyphenyl-4′-methoxyphenylthioether. These monomers may also be used in combination of two or more thereof.

Polymerization of the monomer having ethylenically unsaturated group can be conducted by irradiating with ionizing radiation or heating in the presence of a photo radical initiator or a thermal radical initiator.

Accordingly, the antireflective layer can be formed by preparing a coating solution containing a monomer having ethylenically unsaturated group, a photo radical initiator or a thermal radical initiator, matting particles and an inorganic filler, coating the coating solution on a transparent support and polymerizing the monomer by irradiating with ionizing radiation or heating to cure the coat. As the photo radical initiator and the like, known ones may be used.

The polymer having polyether as a main chain is preferably a ring-opening polymerization product of a multi-functional epoxy compound. Ring-opening polymerization of the multi-functional epoxy compound can be conducted by irradiation with ionizing radiation or by heating in the presence of a photo acid generator or a thermal acid generator.

Accordingly, the antireflective layer can be formed by preparing a coating solution containing the multi-functional epoxy compound, a photo acid generator or a thermal acid generator, matting particles and an inorganic filler, coating the coating solution on a transparent support and polymerizing the monomer by irradiating with ionizing radiation or heating to cure the coat.

In place of, or in addition to, the monomer having two or more ethylenically unsaturated groups, it is possible to introduce a cross-linkable functional group into the polymer by using a monomer having a cross-linkable functional group and introduce a cross-linkable structure into the binder polymer through reaction of the cross-linkable group.

Examples of the cross-linkable functional group include an isocyanato group, an epoxy group, an aziridine group, an oxazoline group, an aldehydo group, a carbonyl group, a hydrazine group, a carboxyl group, a methylol group and an active methylene group. Vinylsulfonic acid, an acid anhydride, a cyanoacrylate derivative, melamine, an etherified methylol, an ester, urethane and a metal alkoxide such as tetramethoxysilane can also be utilized as monomers for introducing a cross-linkable structure. A functional group which shows a cross-linkable ability as a result of decomposition reaction, such as a blocked isocyanato group, may also be used. That is, in the invention, the cross-linkable functional group may be a group which does not immediately exhibit the cross-linkable function but exhibits the function as a result of decomposition.

The binder polymer having such cross-linkable functional group can form a cross-linked structure when heated after coating.

The light-scattering layer contains matting particles for imparting antiglare properties, which are larger than filler particles and have an average particle size of from 1 to 10 sun, preferably from 1.5 to 7.0 μm, and examples thereof include particles of an inorganic compound and resin particles.

Specific preferred examples of the matting particles include particles of an inorganic compound such as silica particles and TiO₂ particles; and resin particles such as acryl particles, cross-linked acryl particles, polystyrene particles, cross-linked styrene particles, melamine resin particles and benzoquanamine resin particles. Of these, cross-linked styrene particles, cross-linked acryl particles, cross-linked acrylstyrene particles and silica particles are more preferred. Regarding shape of the matting particles, either of spherical particles and indeterminate form particles may be used.

Also, two or more kinds of matting particles different from each other in particle size may be used in combination. It is possible to impart antiglare properties by the matting particles having a larger particle size and impart other optical properties by the matting particles having a smaller particle size.

Further, as to the particle size distribution of the matting particles, monodisperse distribution is most preferred and, the nearer the particle sizes of respective particles to the same size, the more preferred. For example, in the case of specifying particles having a particle size larger than the average particle size by 20% or more as coarse particles, the proportion of the coarse particles is preferably 1% or less, more preferably 0.1% or less, still more preferably 0.01% or less, in number based on the number of total particles. Matting particles having such particle size distribution can be obtained by classifying after common synthesizing reaction. A matting agent having a more preferred distribution can be obtained by repeating the classifying procedure many times or by strengthening the degree of classification.

The matting particles are incorporated in the light-scattering layer so that the amount of the matting particles in the formed light-scattering layer becomes preferably from 10 to 1,000 mg/m², more preferably 100 to 700 mg/m².

The particle size distribution of the matting particles is measured by the Coulter counter method, and the measured distribution is converted to a particle number distribution.

In the light-scattering layer is preferably incorporated, in addition to the matting particles, an inorganic filler comprising an oxide of at least one metal selected from among titanium, zirconium, aluminum, indium, zinc, tin and antimony and having an average particle size of 0.2 μm or less, preferably 0.1 μm or less, more preferably 0.06 μm or less, in order to enhance the refractive index of the layer.

Also, to the contrary, it is preferred to use silicon oxide in the light-scattering layer using high refractive index matting particles in order to keep the refractive index of the layer at a low level and to enlarge difference between the refractive index of the matting particles and that of the filler. Preferred particle size of silicon oxide is the same as with the aforementioned inorganic fillers.

Specific examples of the inorganic filler to be used in the light-scattering layer include TiO₂, ZrO₂, Al₂O₃, In₂O₃, ZnO, SnO₂, Sb₂O₃, ITO and SiO₂. TiO₂ and ZrO₂ are particularly preferred in the point of enhancing refractive index. It is also preferred that the surface of the inorganic filler is subjected to silane coupling treatment or titanium coupling treatment. A surface treating agent having a functional group capable of reacting with the binder is preferably used on the surface of the filler.

The addition amount of the inorganic filler is preferably from 10 to 90%, more preferably from 20 to 80%, particularly preferably from 30 to 75%, based on the total weight of the light-scattering layer.

Additionally, such filler has a particle size enough smaller than the wavelength of light not to cause scattering, and hence the dispersion of the filler in the binder polymer behaves as an optically uniform substance.

The refractive index of the bulk of a mixture of the binder and the inorganic filler for the light-scattering layer is preferably from 1.48 to 2.00, more preferably from 1.50 to 1.80. In order to adjust the refractive index to the above range, it suffices to properly select the kinds and the amounts of the binder and the inorganic filler. Which one to select can previously be known with ease through experiments.

In order to ensure surface uniformity by removing coating unevenness, drying unevenness and spot defect of the light-scattering layer, either of a fluorine-containing surfactant and a silicone-based surfactant, or both of them are incorporated in the coating composition for forming the antiglare layer. In particular, a fluorine-containing surfactant is preferably used because it can provide the effect of removing surface troubles of the antireflective film such as coating unevenness, drying unevenness and spot defect. An object of the use of the surfactant is to enhance surface uniformity and impart adaptability for high-speed coating, thus increasing productivity.

Next, the antireflective layer formed on the transparent protective film by superposing a middle refractive index layer, a high refractive index layer and a low refractive index layer in this order is described below.

The antireflective film comprising a substrate having formed thereon the layered structure of the middle refractive index layer, the high refractive index layer and the low refractive index layer (outermost layer) in this order is described to have refractive indexes satisfying the following relation: refractive index of the high refractive index layer>refractive index of the middle refractive index layer>refractive index of the transparent support>refractive index of the low refractive index layer.

A hard coat layer may be provided between the transparent support and the middle refractive index layer. Further, the antireflective layer may comprise a middle refractive index hard coat layer, a high refractive index layer and a low refractive index layer (see, for example, JP-A-8-122504, JP-A-8-110401, JP-A-10-300902, JP-A-2002-243906 and JP-A-2000-111706). Also, other function may be imparted to each layer. For example, there are illustrated a stain-proof low refractive index layer and an antistatic high refractive index layer (e.g., JP-A-10-206603 and JP-A-2002-243906).

The haze of the antireflective film is preferably 5% or less, more preferably 3% or less. Also, the strength of the film is preferably H or more, more preferably 2H or more, most preferably 3H or more, by the pencil hardness test according to JIS K5400.

(High Refractive Index Layer and Middle Refractive Index Layer)

A layer having a high refractive index in the anti-refractive film comprises a curable film containing at least ultra-fine particles of an inorganic compound of 100 nm or less in average particle size having a high refractive index and a matrix binder.

As the fine particles of inorganic compound having a high refractive index, there are illustrated compounds having a refractive index of 1.65 or more, preferably 1.9 or more. Examples thereof include oxides of Ti, Zn, Sb, Sn, Zr, Ce, Ta, La and In, and composite oxides containing these metal atoms.

As methods for preparing such super-fine particles, there are illustrated a method of treating the particle surface with a surface treating agent (e.g., silane coupling agents described in JP-A-11-295503, JP-A-11-153703 and JP-A-2000-9908; and anionic compounds or organometallic coupling agents described in JP-A-2001-310432), a method of forming a core-shell structure wherein the high refractive index particles form the core (JP-A-2001-1661-4), and a method of using specific dispersing agents in combination (e.g., JP-A-11-153703, U.S. Pat. No. 6,210,858B1 and JP-A-2002-2776069).

As the matrix-forming material, there are illustrated conventionally known thermoplastic resins and curable resin films.

Further, at least one composition selected from between a composition containing a multi-functional compound having at least 2 radical-polymerizable and/or cation-polymerizable groups and a composition containing an organometallic compound having a hydrolyzable group and its partial condensate is preferred. For example, there are illustrated those which are described in JP-A-2000-47004, JP-A-2001-315242, JP-A-2001-31871 and JP-A-2001-296401.

Also, a curable film obtained from a composition containing colloidal metal oxide and metal alkoxide obtained from a hydrolysis condensate of a metal alkoxide is preferred. For example, it is described in JP-A-2001-293818.

The refractive index of the high refractive index layer is generally from 1.70 to 2.20. The thickness of the high refractive index layer is preferably from 5 nm to 10 μm, more preferably from 10 nm to 1 μm.

The refractive index of the middle refractive index layer is adjusted so that it falls between the refractive index of the low refractive index layer and the refractive index of the high refractive index layer. The refractive index of the middle refractive index layer is preferably from 1.50 to 1.70. Also, the thickness of the layer is preferably from 5 nm to 10 μm, more preferably from 10 nm to 1 μm.

(Low Refractive Index Layer)

The low refractive index layer is laminated on the high refractive index layer. The refractive index of the low refractive index layer is from 1.20 to 1.55, preferably from 1.30 to 1.50.

It is preferred to form the low refractive index layer as the outermost layer having scratching resistance and stain-proofing properties. As means for imparting scratching resistance, it is effective to impart sliding properties to the surface, and conventionally known means of introducing silicone or fluorine into a thin film layer may be applied.

The refractive index of the fluorine-containing compound is preferably from 1.35 to 1.50, more preferably from 1.36 to 1.47. Also, the fluorine-containing compound is preferably a compound which contains fluorine atom in the range of from 35 to 80% by weight and has a cross-linkable or polymerizable functional group.

Examples thereof include those compounds which are described in JP-A-9-222503, paragraph Nos. (0018) to (0026), JP-A-11-38202, paragraph Nos. (0019) to (0030), JP-A-2001-40284, paragraph Nos. (0027) to (0028), and JP-A-2000-284102.

The silicone compound is preferably a compound having a polysiloxane structure and having a curable functional group or a polymerizable functional group in the high molecular chain and which provides a cross-linked structure in the film. Examples thereof include reactive silicone (e.g., SILAPLANE made by Chisso Corp.) and polysiloxane having a silanol group on each end.

The cross-inking or polymerizing reaction of the fluorine-containing and/or siloxane polymer having a cross-linking or polymerizable group is preferably conducted simultaneously with or after coating a coating composition for forming the outermost layer which contains a polymerization initiator and a sensitizing agent.

Also, a sol-gel cured film is preferred which is formed by curing an organometallic compound such as a silane coupling agent and a silane coupling agent containing a specific fluorine-containing group in the presence of a catalyst through condensation reaction.

Examples thereof include a silane compound containing a polyfluoroalkyl group or the partially hydrolyzed condensate (compounds described in JP-A-58-142958, JP-A-58-147483, JP-A-58-147484, JP-A-9-157582 and JP-A-11-106704), and a silyl compound containing a fluorine-containing long chain group of poly“perfluoroalkyl ether” group (compounds described in JP-A-2000-117902, JP-A-2001-48590 and JP-A-2002-53804).

The low refractive index layer can contain, other than the above-mentioned additives, a filler such as a low refractive index inorganic compound of 1 to 150 nm in average size as primary particles (e.g., silicon dioxide (silica), fluorine-containing particles (magnesium fluoride, calcium fluoride or barium fluoride) and organic fine particles described in JP-A-11-3820, paragraph Nos. (0020) to (0038), a silane coupling agent, a sliding agent and a surfactant.

In the case where the low refractive index layer is positioned under the outermost layer, the low refractive index layer may be formed by the gas phase method (e.g., vacuum deposition method, sputtering method, ion plating method or plasma CVD method). The coating method is preferred in the point that it can form the layer inexpensively.

The thickness of the low refractive index layer is preferably from 30 to 200 nm, more preferably from 50 to 150 nm, most preferably from 60 to 120.

(Other Layers of the Antireflective Layer)

Further, a hard coat layer, a forward scattering layer, a primer layer, an antistatic layer, an undercoat layer and a protective layer may be provided.

(Hard Coat Layer)

The hard coat layer is provided on the surface of the transparent support for imparting physical strength to the transparent protective film having provided thereon the antireflective layer. It is particularly preferred to provide the hard coat layer between the transparent support and the aforementioned high refractive index layer. The hard coat layer is preferably formed by cross-linking reaction or polymerization reaction of a compound which can be cured by light and/or heat. As the curable functional group, a photo-polymerizable functional group is preferred, and the organometallic compound containing a hydrolysable functional group is preferably an organic alkoxysilyl compound.

Specific examples of these compounds are the same as have been illustrated with respect to the high refractive index layer.

As a specific composition for constituting the hard coat layer, there are illustrated those which are described in, for example, JP-A-2002-144913, JP-A-2000-9908 and WO00/46617.

The high refractive index layer can also function as the hard coat layer. In such case, it is preferred to form the layer by incorporating fine particles in a finely dispersed state in the hard coat layer using the technique employed for the high refractive index layer.

The hard coat layer may contain particles of 0.2 to 10 μm in average particle size to function as a glare-reducing layer (to be described hereinafter) having a glare-reducing function (antiglare function).

The thickness of the hard coat layer can be properly determined depending upon the use thereof. The thickness of the hard coat layer is preferably from 0.2 to 10 μm, more preferably from 0.5 to 7 μm.

The strength of the hard coat layer is preferably H or more, more preferably 2H or more, most preferably 3H or more, measured by the pencil hardness test according to JIS K5400. Also, the smaller the amount of abrasion of a sample after the taper test according to JIS K5400, the more preferred.

(Antistatic Layer)

In the case of providing an antistatic layer, it is preferred to impart a conductivity of 10⁻⁸ (Ωcm⁻³) in terms of volume resistivity. The volume resistivity of 10⁻⁸(Ωcm⁻³) can be imparted by using a hygroscopic substance, a water-soluble inorganic salt, a certain kind of surfactant, a cation polymer, an anion polymer or colloidal silica. However, these compounds are so temperature-dependent and humidity-dependent that they involve the problem that a sufficient conductivity can not be obtained under the circumstances of a low humidity. Therefore, metal oxides are preferred as the material for the conductive layer. Some of the metal oxides are colored, and are not preferred because they color the whole film when used as materials for the conductive layer. Examples of metals which form a colorless metal oxide include Zn, Ti, Al, In, Si, Mg, Ba, Mo, W and V. It is preferred to use metal oxides containing these metal oxides as a major component. As specific examples thereof, ZnO, TiO₂, SnO₂, Al₂O₃, in₂O₃, SiO₂, MgO, BaO, MoO₃, V₂O₅ and the composite oxides thereof are preferred, with ZnO, TiO₂ and SnO₂ being particularly preferred. As examples of methods for incorporating a hetero atom, addition of Al or In to ZnO, addition of Sb, Nb or halogen element to SnO₂ and addition of Nb or TA to TiO₂ are effective. Further, as is described in JP-B-59-6235, materials prepared by depositing the metal oxide onto other crystalline metal particles or fibrous material (e.g., titanium oxide) may be used. Additionally, though the volume resistivity and the surface resistivity are different physical values and can not simply be compared with each other, the surface resistivity of the conductive layer of about 10⁻⁴⁰ (Ω/□) or less suffices for obtaining a conductivity of 10⁻⁸(Ωcm⁻³), with the surface resistivity of 10⁻⁸ (Ω/□) being more preferred. The surface resistivity of the conductive layer must be measured with respect to the antistatic layer formed as the outermost layer, and can be measured in the course of formation of the laminate film described in the invention.

(Liquid Crystal Display)

The cellulose acylate film of the invention, the optical compensatory sheet comprising the film, and the polarizing plate using the film can be used for liquid crystal cells and liquid crystal displays of various display modes. There have been proposed various display modes such as TN (Twisted Nematic), EPS (In-Plane Switching), FLC (Ferroelectric Liquid Crystal), AFLC (Anti-ferroelectric Liquid Crystal), OCB (Optically Compensatory Bend), STN (Super Twisted Nematidc), VA (Vertically Aligned) and HAN (Hybrid Aligned Nematic). Of these, OCB mode and VA mode are preferred for the invention to apply.

The OCB mode liquid crystal display is a liquid crystal display using a bend alignment mode liquid crystal cell wherein rod-like liquid crystalline molecules are aligned in substantially reverse directions (symmetrically) between the upper portion and the lower portion of the liquid crystal cell. The OCB mode liquid crystal cell is disclosed in U.S. Pat. Nos. 4,583,825 and 5,410,422. Since the rod-like molecules are aligned symmetrically between the upper portion and the lower portion of the liquid crystal cell, the bend mode liquid crystal cell exhibits a self optical compensatory function. Thus, the liquid crystal mode is also referred to as OCB (Optically Compensatory Bend) liquid crystal mode. The bend alignment mode liquid crystal display has the advantage of a high response speed.

In the VA mode liquid crystal cell, the rod-like liquid crystalline molecules are aligned substantially vertically when no voltage is applied thereto.

The VA mode liquid crystal cell includes (1) a liquid cell of VA mode in the narrow sense wherein rod-like liquid crystal molecules are aligned substantially vertically when no voltage is applied thereto and are aligned substantially horizontally upon applying thereto voltage (JP-A-2-176625); (2) a multi-domain VA mode (AWA mode) liquid crystal cell (described in SID97, Digest of tech. Papers 28 (1997), 845); (3) a liquid crystal cell wherein rod-like liquid crystalline molecules are aligned substantially vertically when no voltage is applied thereto and are aligned in a twisted multi-domain alignment mode (n-ASM mode) (described in Nihon Ekisho Toronkai, Yokoshu, 58-59 (1998); and (4) a SURVAIVA mode liquid crystal cell (published in LCD International 98).

The VA mode liquid crystal display comprises a liquid crystal cell and two polarizing plates, wherein the liquid crystal cell is provided between the two polarizing plates. The liquid crystal cell carries a liquid crystal between two electrode substrates. In one embodiment of the transmission type liquid crystal display of the invention, one optical compensatory sheet of the invention is provided between the liquid crystal cell and one of the polarizing plates, or one of two optical compensatory sheets is provided between the liquid crystal cell and one polarizing plate and the other of two optical compensatory sheets is provided between the liquid crystal cell and the other polarizing plate.

In another embodiment of the transmission type liquid crystal display of the invention, an optical compensatory sheet comprising the cellulose acylate film of the invention is provided between the liquid crystal cell and the polarizer as a transparent protective film for the polarizing plate. The optical compensatory sheet may be used as the transparent protective film (between the liquid crystal cell and the polarizer) only for one of the polarizing plates, or may be used as the transparent protective films (between the liquid crystal cell and the polarizer) for each of two polarizing plates. In the case of using the optical compensatory sheet only for one of the polarizing plate, it is particularly preferred to use the sheet as a protective film on the liquid crystal side of the polarizing plate on the back right side. The cellulose acylate film of the invention is preferably stacked onto the VA cell side. The protective film may be a common cellulose acylate film, and is preferably thinner than the cellulose acylate film of the invention. The thickness is preferably from 40 to 80 Sun, and there are illustrated commercially available KC4UX2M (40 μm; made by Konica Opto K.K.), KC5UX (60 μm; made by Konica Opto K.K.), and TD80 (80 μm; made by Fuji Photo Film Co., Ltd.), though not being limited thereto.

### EXAMPLES

The invention is specifically described below by reference to Examples which, however, are not to be construed as limiting the invention.

(Measuring Method)

Various characteristic properties of the cellulose acylate film are measured as follows.

(Retardation Re and Rth)

After leaving in a humidistat at 25° C. and 60% RH for 24 hours, Re of a cellulose acylate film was measured by means of an ellipsometer 4-150; manufactured by Nihon Bunko K.K.) using He—Ne laser. The retardation value in the thickness direction (Rth) and the retardation value in the film plane (Re) were calculated according to the following formulae (2) and (3), respectively:
Re=(nx−ny)×d formula (2)
Rth={(nx+ny)/2−nz}×d formula (3)
wherein nx represents a refractive index in the x direction (slow axis direction) of the film plane, ny represents a refractive index in the y direction (fast axis direction) of the film plane, nz represents a refractive index in the vertical direction of the film plane, and d represents the thickness (nm) of the film.

Also, Retardation value was measured by the following manner. Re(λ) was measured by means of KOBRA 21ADH (manufactured by Oji Keisokukiki K.K.) with irradiating the film with a light of λnm in wavelength in the direction normal to the film. Also, Rth(λ) was calculated based on three retardation values of the Re(λ), the retardation value measured by irradiating the film with a light of λnm in the direction +40° inclined with respect to the normal direction to the film with taking the inplane slow axis as the inclined axis, and the retardation value measured by irradiating the film with a light of λnm in the direction −40° inclined with respect to the normal direction to the film with taking the inplane slow axis as the inclined axis, by inputting 1.48 which is the hypothetical value of average refractive index and the film thickness. Retardation value measured by means of the ellipsometer and retardation value measured by means of KOBRA 21ADH were substantially the same.

(Water Content)

After humidity conditioning of a 7 mm×35 nm sample at 25° C. and 80% RH for 2 hours, water content of the sample was measured using a water content-measuring device (manufactured by Hiranuma Sangyo Co., Ltd.) according to the Karl Fischer's method. The water content was calculated by dividing the weight of water (g) by the weight of the sample (g).

(Water Vapor Permeability)

Water vapor permeability of a sample was measured using an apparatus described in JIS-Z208 (the cup method), where the moisture transmission amount for 24 hours at 60° C. and 95% RH was measured.

(Heat-Shrinking Ratio)

After humidity conditioning of a 30 mm×120 mm sample at 25° C. and 60% RH for 2 hours, 6 mmφ holes were made at 100 mm intervals on both edges of the sample and the original distance (L1) of the interval was measured to the order of 1/1000 mm by means of an automatic pin gauge (Shinto Kagaku). Further, after leaving the sample at 60° C. and 90% RH or 90° C. and 3% RH for 24 hours and once again leaving the sample at 25° C. and 60% RH for 2 hours, the distance of the punch interval (L2) was measured after. The heat-shrinking ratio was determined by the formula of {(L1−L2)/L1}×100.

(Glass Transition Temperature Tg)

A 5 mm×30 mm film sample was left in a humidistat for 2 hours or longer at 25° C. and 60% RH, then was subjected to measurement by a dynamic elastoviscometer (Vibron DVA-225; made by IT Keisoku Seigyo K.K.) with a clip-to-clip distance of 20 mm, a temperature-increasing rate of 2° C./min, a measuring temperature range of from 30° C. to 200° C. and a frequency of 1 Hz. When the storage elastic modulus is plotted as ordinate (logarithmic axis) and temperature (° C.) as abscissa (linear axis), a sharp reduction of the storage elastic modulus is observed as the storage modulus elasticity shifts from the solid zone to the glass transition zone. A straight line 1 can drawn in the solid zone, and a straight line 2 can be drawn in the glass transition zone. The intersection point of the lines 1 and 2 is a temperature at which the storage elastic modulus sharply decreases and the film starts being softened upon raising the temperature and shifts to the glass transition zone, thus the temperature being taken as the glass transition temperature (Tg) (dynamic viscoelasticity).

(Elastic Modulus)

A 10 mm×200 mm sample was left in a humidistat for 2 hours at 25° C. and 60% RH, and was subjected to measurement using a tensile tester (Strograph-R2; made by Toyo Seiki) with an initial sample length of 100 mm and a stretching rate of 100 mm/min. The elastic modulus was calculated from the stress at the initial stretching and elongation.

(Photoelastic Coefficient)

A tensile stressing was applied to a 10 mm×100 mm film sample in the longitudinal direction, and the Re retardation at the occasion was measured by an ellipsometer (M150; made by Nihon Bunko K.K.), and the photoelastic coefficient was calculated from the variation of retardation versus stress.

(Haze)

The haze of a 40 mm×80 mm sample was measured at 25° C. and 60% RH using a haze meter (HGM-2DP; made by Suga Shikenki) according to JIS K6714.

### Example 1

1. Preparation of a Cellulose Acylate Film

(1) Cellulose Acylate

Cellulose acylates different from each other in acyl substitution degree described in Table 1 were prepared. Acylation reaction was conducted at 40° C. by adding sulfuric acid (7.8 parts by weight per 100 parts by weight of cellulose) and adding a carboxylic acid. Subsequently, the whole substitution degree and the substitution degree at 6-position were adjusting by adjusting the amount of sulfuric acid catalyst, the amount of water and the ripening time. The ripening was conducted at 40° C. Further, a low molecular component of the cellulose acylate was removed by washing with acetone.

(2) Preparation of Dope

The cellulose acylate described in Table 1, a plasticizer (2:1 mixture of triphenyl phosphate and biphenyldiphenyl phosphate) and a retardation-producing agent of the following structure were thrown into a mixed solvent of dichloromethane/methanol (87/13 by weight) in a solid content of 19% by weight, followed by stirring under heating to dissolve. In this occasion, 0.05 part by weight of fine particles [silicon dioxide (primary particle size: 20 nm; Moh's scale of hardness: about 7)], 0.375 part by weight of ultraviolet absorber B (TINUVIN327; manufactured by Ciba Specialty Chemicals) and 0.75 part by weight of ultraviolet absorber C (TINUVIN328; manufactured by Ciba Specialty Chemicals) were simultaneously added, and stirred under heating. The proportions of added plasticizer and the retardation-producing agent are shown in Table 2 in terms of parts by weight per 100 parts by weight of cellulose acylate. From the thus prepared dopes were prepared films of F1 to F10 and F14 to F17 in the following manner.
Retardation-Producing Agent:

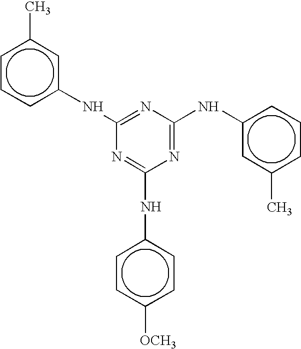

Also, cellulose acylate CA3 described in Table 1, a plasticizer (2:1 mixture of triphenyl phosphate and biphenyldiphenyl phosphate) and a retardation-producing agent of the above structure were thrown into a mixed solvent of methyl acetate/acetone/ethanol/butanol (81/8/7/4 by weight) in a solid content of 16.4% by weight, followed by stirring to swell. In this occasion, 0.05 part by weight of fine particles (silicon dioxide (primary particle size: 20 nm; Moh's scale of hardness: about 7)), 0.04 part by weight of ethyl citrate (1:1 mixture of monoester and diester) were simultaneously added, and stirred. The proportions of added plasticizer and the retardation-producing agent are shown in Table 2 in terms of parts by weight per 100 parts by weight of cellulose acylate. The swelling solution was cooled to −70° C., and then heated to dissolve at 40° C. The resulting dope was filtered, and was subjected to flash concentration to adjust the solid concentration in the dope to about 21%. From the thus prepared dopes were prepared films of F11 to F13 in the following manner.

(Casting)

Each of the dopes was cast using a band casting machine. Films peeled from the band with a residual solvent amount being from 25 to 35% by weight were stretched in the width direction with a stretching ratio of from 15% to 23% (Table 2) to produce cellulose acylate films. In the tenter, each film was stretched in the width direction while drying by applying thereto a hot air, then was shrunk about 5%. Then, the film was moved from tenter conveyance to roll conveyance, further dried, knurled and wound up. As the stretching ratio, values, calculated from the film width at the inlet of the tenter and the film width at the outlet of the tenter, are shown in Table 2. The thus prepared cellulose acylate films (optical compensatory sheets) were subjected to measurement of Re retardation value and Rth retardation value at a wavelength of 630 nm at 25° C. and 60% RH by means of an ellipsometer (M-150; made by Nihon Bunko K.K.) or KOBRA 21ADH (manufactured by Oji Keisokukiki K.K.). Also, the Re retardation value and the Rth retardation value were measured with a sample film being sandwiched between two glass plates via silicone after being left in a humidistat for 2 hours or longer at 25° C. and 80% RH. The variations of retardation of the cellulose acylate film between the retardation value measured at 10% RH at the wavelength of 630 nm and that measured at 80% at the wavelength of 630 nm (Re(10% RH)-Re(80% RH); Rth(10% RH)-Rth(80% RH)) are shown as ΔRe and ΔRth, respectively.

TABLE 1

| | | Acetyl | Propionyl | 6-Position | 6-Position substitution |
|---|---|---|---|---|---|
| | Raw Cotton | Substitution | Substitution | Substitution | degree/whole substitution |
| | No. | Degree | Degree | Degree | degree |
| Example | CA1 | 2.849 | 0.000 | 0.934 | 0.328 |
| Example | CA2 | 2.847 | 0.000 | 0.947 | 0.333 |
| Example | CA3 | 2.785 | 0.000 | 0.910 | 0.327 |
| Example | CA4 | 2.753 | 0.000 | 0.903 | 0.328 |
| Example | CA5 | 2.745 | 0.000 | 0.882 | 0.321 |
| Example | CA6 | 1.952 | 0.808 | 0.897 | 0.325 |
| Comparative | CA7 | 2.751 | 0.000 | 0.844 | 0.307 |
| Example | | | | | |

The whole substitution degree is the sum of the 2-position substitution degree, 3-position substitution degree and 6-position substitution degree. Also, the whole substitution degree is equal to the value obtained by adding the acetyl substitution degree to the propionyl substitution degree.

TABLE 2

| | | Addition | | | | Film | |
|---|---|---|---|---|---|---|---|
| | Faw | Amount of | Addition Amount of | | Tenter | Thickness | |
| Film | Cotton | Plasticizer | Retardation-producing | Stretching | Temperature | After Drying | Re |
| No. | No. | (%) | Agent (%) | Ratio (%) | (° C.) | (μm) | (nm) |
| F1 | CA1 | 11.7 | 4.0 | 23 | 135 | 92 | 51 |
| F2 | CA2 | 11.7 | 5.0 | 20 | 135 | 92 | 47 |
| F3 | CA3 | 11.7 | 0.0 | 20 | 140 | 92 | 16 |
| F4 | CA3 | 11.7 | 5.0 | 15 | 135 | 92 | 62 |
| F5 | CA3 | 11.7 | 6.5 | 14 | 135 | 92 | 65 |
| F6 | CA3 | 11.7 | 6.5 | 25 | 135 | 110 | 140 |
| F7 | CA3 | 5.7 | 6.5 | 15 | 145 | 92 | 68 |
| F8 | CA3 | 11.7 | 6.5 | 15 | 130 | 80 | 63 |
| F9 | CA3 | 11.7 | 6.5 | 15 | 130 | 92 | 72 |
| F10 | CA3 | 11.7 | 5.0 | 23 | 135 | 60 | 48 |
| F11 | CA3 | 11.7 | 0.0 | 20 | 135 | 80 | 17 |
| F12 | CA3 | 11.7 | 5.0 | 22 | 135 | 86 | 58 |
| F13 | CA3 | 11.7 | 6.5 | 20 | 135 | 110 | 80 |
| F14 | CA4 | 11.7 | 5.0 | 20 | 135 | 92 | 51 |
| F15 | CA5 | 11.7 | 5.0 | 20 | 135 | 92 | 52 |
| F16 | CA6 | 11.7 | 5.0 | 20 | 135 | 80 | 55 |
| F17 | CA7 | 11.7 | 5.0 | 15 | 135 | 92 | 66 |

| | | | | | Water Vapor | | |
|---|---|---|---|---|---|---|---|
| Film | | | | Water Content | Permeability | | |
| No. | Rth (nm) | ΔRe (nm) | ΔRth (nm) | (%) | (g/m²/day) | Tg (° C.) | Note |
| F1 | 130 | 10.5 | 29.3 | 2.96 | 850 | 143 | Example |
| F2 | 211 | 10.3 | 28.7 | 2.94 | 854 | 143 | Example |
| F3 | 114 | 12.1 | 41.0 | 3.36 | 1500 | 145 | Comparative |
| | | | | | | | Example |
| F4 | 211 | 8.8 | 28.2 | 2.96 | 1144 | 142 | Example |
| F5 | 216 | 8.3 | 26.6 | 2.95 | 1037 | 142 | Example |
| F6 | 303 | 10.1 | 31.8 | 2.95 | 867 | 142 | Example |
| F7 | 274 | 8.4 | 29.1 | 2.95 | 1444 | 147 | Example |
| F8 | 223 | 8.2 | 26.4 | 2.95 | 1190 | 142 | Example |
| F9 | 256 | 8.5 | 26.5 | 2.95 | 1035 | 142 | Example |
| F10 | 132 | 7.5 | 24.6 | 2.96 | 1689 | 142 | Example |
| F11 | 155 | 10.3 | 44.2 | 3.36 | 1725 | 145 | Comparative |
| | | | | | | | Example |
| F12 | 275 | 10.2 | 27.9 | 2.96 | 1265 | 142 | Example |
| F13 | 298 | 11.5 | 26.8 | 2.95 | 954 | 142 | Example |
| F14 | 274 | 8.8 | 28.4 | 3.17 | 1127 | 142 | Example |
| F15 | 277 | 8.8 | 30.8 | 3.18 | 1130 | 142 | Example |
| F16 | 121 | 8.9 | 25.5 | 2.34 | 1420 | 138 | Example |
| F17 | 278 | 8.8 | 34.5 | 3.18 | 1136 | 141 | Comparative |
| | | | | | | | Example |

The glass transition temperature (Tg) and water content after conditioning humidity at 25° C. and 80% RH, and water vapor permeability at 60° C. and 95% RH for 24 hours of the prepared films were also measured, and the results are shown in Table 2. Also, all of the films had a haze in the range of from 0.1 to 0.9, a secondary average particle size of the matting agent of 1.0 μm or less and an elastic modulus of 4 GPa or more, and showed a weight variation of from 0 to 3% when allowed to stand for 48 hours at 80° C. and 90% RH. Dimensional change was −1.2 to 0.2% when allowed to stand for 24 hours at 60° C. and 95% RH and at 90° C. and 5% RH. Further, all samples had a photoelastic coefficient of 50×10⁻¹³ cm²/dyne or less.

Two cellulose acylate films was prepared in the same manner as F13 as shown in Table 2, except that the film thickness of one film after drying was 143 μm corresponding to 1.3 times as thick as F13 and the film thickness of the other film after drying was 176 μm corresponding to 1.6 times as thick as F13. Re values of these films increased approximately depending on the thickness, Rth values of these films increased approximately depending on the thickness, and the water vapor permeabilities of these films were in approximately inverse proportion to the thickness. ΔRe, ΔRth, glass transition temperature and water content of these films each was the same as F13 without relation to the film thickness.

When Re and Rth each was measured at 25° C. and 60% RH with respect to different wavelengths by means of the ellipsometer (M-150; made by Nihon Bunko K.K.), cellulose acylate films except F3 and F11 satisfied 0.90≦Rth₍₄₅₀₎/Rth₍₅₅₀₎≦1.10 and 0.90≦Rth₍₆₅₀₎/Rth₍₅₅₀₎≦1.10, and 0.90≦Rth₄₅₀/Rth₍₅₅₀₎≦1.25 and 0.90≦Rth₍₆₅₀₎/Rth₍₅₅₀₎≦1.10. F3 and F11 satisfied 0.7≦Rth₍₄₅₀₎/Rth₍₅₅₀₎≦0.8 and 1.1≦Rth₍₆₅₀₎/Rth₍₅₅₀₎≦1.2, and 0.90≦Rth₍₄₅₀₎/Rth₍₅₅₀₎≦1.25 and 0.90≦Rth₍₆₅₀₎/Rth₍₅₅₀₎≦1.10.

### Example 2

2-1-1>

(Preparation of Polarizing Plate-1)

A polarizer was prepared by adsorbing iodine onto a stretched polyvinyl alcohol film.

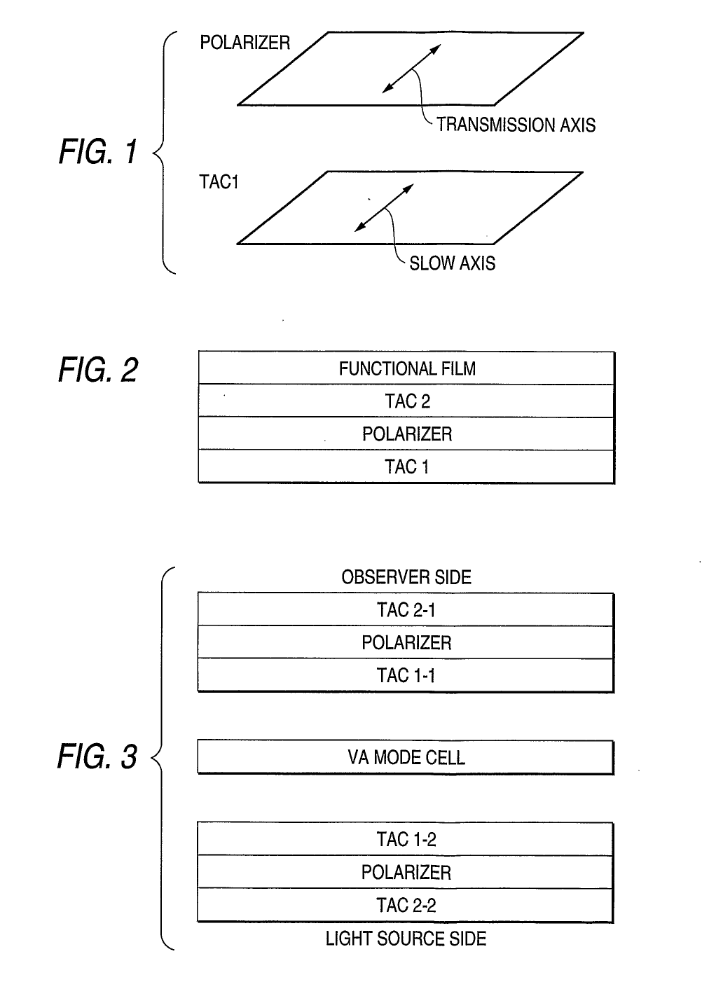

Each of the cellulose acylate films prepared in Example 1 (F1 to F17; corresponding to TAC1 in FIGS. 1 and 2, TAC1-1 or TAC1-2 in FIG. 3) was superposed on one side of the polarizer using a polyvinyl-based adhesive. Additionally, saponification treatment was conducted under the following conditions.

A 1.5N sodium hydroxide aqueous solution was prepared and kept at 55° C. A 0.01N dilute sulfuric acid aqueous solution was prepared and kept at 35° C. Each of the prepared cellulose acylate films was dipped in the sodium hydroxide aqueous solution for 2 minutes, then dipped in water to sufficiently wash away the sodium hydroxide aqueous solution. Subsequently, the film was dipped in the dilute sulfuric acid aqueous solution for 1 minute, then dipped in water to sufficiently wash away the dilute sulfuric acid aqueous solution. Finally, the samples were sufficiently dried at 120° C.

A commercially available cellulose triacylate film (Fujitac TD80UF; manufactured by Fuji Photo Film Co., Ltd.; corresponding to the functional film TAC2 in FIG. 2, TAC2-1 or 2-2 in FIG. 3) was subjected to the saponification treatment, and superposed on the opposite side of the polarizer using a polyvinyl-based adhesive, followed by drying at 70° C. for 10 minutes or longer.

The polarizer and the cellulose acylate film were disposed so that the transmission axis of the polarizer and the slow axis of the cellulose acylate film prepared in Example 1 became parallel to each other (FIG. 1). The polarizer and the commercially available triacylate film were disposed so that the transmission axis of the polarizer and the slow axis of the commercially available cellulose acylate film crossed at right angles to each other.

One part of each of the thus prepared polarizing plates A1 to A19 (polarizing plate integral with the optical compensatory film, having no functional film shown in FIG. 2) was placed as such in a moisture-proofed bag and stored, and the other part thereof was placed in the moisture-proofed bag after conditioning the moisture at 25° C. and 60% RH for 2 hours. The moisture-proofed bag was an enveloping material comprising a laminate structure of polyethylene terephthalate/aluminum/polyethylene having a water vapor permeability of 0.01 mg/m² (24 hrs) or less.

<2-2-1>

(Preparation of a Coating Solution for a Light-Scattering Layer)

50 g of a mixture of pentaerythritol triacrylate and pentaerythritol tetraacrylate (PETA; made by Nihon Kayaku K.K.) was diluted with 38.5 g of toluene. Further, 2 g of a polymerization initiator (Irgacure 184; manufactured by Ciba Specialty Chemicals) was added thereto and stirred to mix. The coat formed by coating the solution and curing with UV rays had a refractive index of 1.51.

To this solution were further added 1.7 g of a 30% toluene dispersion of cross-linked polystyrene particles of 3.5 μm in average particle size (refractive index: 1.60; SX-350; manufactured by Soken Kagaku K.K.) having been dispersed for 20 minutes in a polytron dispersing machine at 10,000 rpm and 13.3 g of a 30% toluene dispersion of cross-linked acryl-styrene particles of 3.5 μm in average particle size (refractive index: 1.55; manufactured by Soken Kagaku K.K.) and, finally, 0.75 g of a fluorine-containing surface-modifying agent (FP-1) and 10 g of a silane coupling agent (KBM-5103; manufactured by Shin-etsu Kagaku Kogyo K.K.) to prepare a complete solution.

Each of the mixed solution was filtered through a 30-μm polypropylene-made filter to prepare a coating solution for the light-scattering layer. 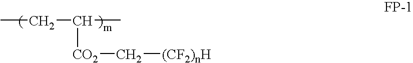
m is about 36, and n is 6.
<2-2-2>
(Preparation of a Coating Solution for a Low Refractive Index Layer)

First, a sol solution a was prepared as set below. In a reactor provided with a stirrer and a reflux condenser, 120 parts of methyl ethyl ketone, 100 parts by weight of acryloyloxypropyltrimethoxysilane (KBM-5103, manufactured by SIHN-ETSU CHEMICAL Co., Ltd.) and 3 parts by weight of diisopropoxyalminum ethyl acetoacetate were mixed. After adding 30 parts by weight of ion-exchanged water, the mixture was reacted at 60° C. for 4 hours and then cooled to room temperature to give a sol solution a. The weight-average molecular weight thereof was 1600 and components with molecular weight of from 1000 to 20,000 amounted to 100% of oligomer components and higher. When analyzed by gas chromatography, no starting acryloyloxypropyltrimethoxysilane remained.

13 g of a thermally cross-linkable, fluorine-containing polymer of 1.42 in refractive index (JN-7228; concentration of solids: 6%; manufactured by JSR), 1.3 g of silica sol (silica; product different from MEK-ST in particle size; average particle size: 45 nm; concentration of solids: 30%; manufactured by Nissan Kagaku K.K.), 0.6 g of the sol solution a, 5 g of methyl ethyl ketone and 0.6 g of cyclohexanone were added to a vessel and, after stirring the mixture, filtered through a polypropylene-made filter of 1 μm in pore size to prepare a coating solution for a low refractive index layer.

<2-2-3>

(Preparation of Transparent Protective Film 01 Having a Light-Scattering Layer)

A 80-μm thick triacetyl cellulose film (TAC-TD80U; manufactured by Fuji Photo Film Co., Ltd.) in a roll form was unrolled and coated with the coating solution for the functional layer (light-scattering layer) using a micro-gravure roll of 50 mm in diameter having a pattern of 180 lines/inch in line number and 40 μm in depth and a doctor blade under the condition of 30 rpm in gravure roll-rotating number and 30 m/min in conveying speed and, after drying at 60° C. for 150 seconds, the coat was irradiated with UV rays with an illuminance of 400 mW/cm² and an irradiation amount of 250 mJ/cm² while purging with nitrogen using a 160 W/cm, air-cooled metal halide lamp (manufactured by EYE GRAPHICS Co., Ltd.) to cure and form a 6-μm thick functional layer, followed by rolling up the film.

The triacetyl cellulose film on which the functional layer (light-scattering layer) had been coated was again unrolled, and coated with the above-prepared solution for the low refractive index layer using a micro-gravure roll of 50 mm in diameter having a pattern of 180 lines/inch in line number and 40 μm in depth and a doctor blade under the condition of 30 rpm in gravure roll-rotating number and 15 m/min in conveying speed and, after drying at 120° C. for 8 minutes, the coat was irradiated with UV rays with an illuminance of 400 mW/cm² and an irradiation amount of 900 mJ/cm² while purging with nitrogen using a 240 W/cm, air-cooled metal halide lamp (manufactured by EYE GRAPHICS Co., Ltd.) to cure and form a 100-nm thick low refractive index layer, followed by rolling up the film (corresponding to the functional film and TAC2 in FIG. 2 or TAC2-1 in FIG. 3.)

<2-3-1>

(Preparation of Polarizing Plate-2)

A polarizer was prepared by adsorbing iodine onto a stretched polyvinyl alcohol film.

The prepared transparent protective film 01 having the light-scattering layer was subjected to the same saponification treatment as described in <2-1-1>, and the prepared transparent protective film 01 was superposed on the polarizer, wherein the functional film-free side of the film 01 was faced to one side of the polarizer using a polyvinyl-based adhesive.

Each of the cellulose acylate films prepared in Example 1 (F1 to F17; corresponding to TAC1 in FIG. 1) was subjected to the same saponification treatment and was superposed on the opposite side of the polarizer, followed by drying at 70° C. for 10 minutes or longer. (Constitution shown in FIG. 2 was completed.)

The polarizer and the cellulose acylate film were disposed so that the transmission axis of the polarizer and the slow axis of the cellulose acylate film prepared in Example 1 became parallel to each other (FIG. 1). The polarizer and the transparent protective film 01 having the light-scattering layer film were disposed so that the transmission axis of the polarizer and the slow axis of the transparent protective film having the light-scattering layer crossed at right angles to each other. Thus, polarizing plates (B1 to B19; integral with the functional film and the optically compensatory film as shown in FIG. 2) were prepared. Similarly in preparation of polarizing plates <2-1-1>, one part of each sample was placed in the moisture-proofed bag after conditioning the moisture at 25° C. and 60% RH for 2 hours, and the other part thereof was placed in the moisture-proofed bag without conditioning the moisture.

A polarizer was prepared by adsorbing iodine onto a stretched polyvinyl alcohol film.

A 80-μm thick triacetyl cellulose film (TAC-TD80U; manufactured by Fuji Photo Film Co., Ltd.) not having coated thereon the functional layer and the transparent protective film 01 having the light-scattering layer prepared in <2-2-3> was subjected to the same saponification treatment as described hereinbefore and was superposed on the polarizer as described hereinbefore using a polyvinyl-based adhesive. Thus, there was prepared a polarizing plate (B0; integral with the functional film and the optically compensatory films as shown in FIG. 2) was prepared. Similarly in preparation of polarizing plates <2-1-1>, one part of each sample was placed in the moisture-proofed bag after conditioning the moisture, and the other part thereof was placed in the moisture-proofed bag without conditioning the moisture.

The spectral reflectivity at an incident angle of 5° was measured from the functional film side in the wavelength region of from 380 to 780 nm using a spectrophotometer (made by Nihon Bunko K.K.). Thus, the integrating-sphere average reflectivity in the range of from 450 to 650 nm was determined to be 2.3%.

<2-4-1>

(Preparation of a Coating Solution for a Hard Coat Layer)

To 750.0 parts of trimethylolpropane triacrylate (TMPTA; made by Nihon Kayaku K.K.) were added 270.0 parts by weight of poly(glycidyl methacrylate) having a weight-average molecular weight of 3,000, 730.0 g of methyl ethyl ketone, 500.0 g of cyclohexanone and 50.0 g of a photo polymerization initiator (Irgacure 184; manufactured by Nihon Ciba Geigy K.K.), followed by stirring the mixture. The resulting mixture was filtered through a polypropylene-made filter of 0.4 μm in pore size to prepare a coating solution for a hard coat layer.

<2-4-2>

(Preparation of a Dispersion of Fine Particles of Titanium Dioxide)

As the fine particles of titanium dioxide, fine particles of titanium dioxide (NT-129; made by Ishihara Sangyo K.K.) which contain cobalt and have been surface-treated with aluminum hydroxide and zirconium hydroxide were used.

To 257.1 g of the particles were added 38.6 g of the following dispersing agent and 704.3 g of cyclohexanone, and dispersion was conducted in a dynomil to prepare a dispersion of titanium dioxide having a weight-average size of 70 nm.

<2-4-3>

(Preparation of a Coating Solution for a Middle Refractive Index Layer)

58.4 g of a mixture (DPHA) of dipentaerythritol pentaacrylate and dipentaerythritol hexaacrylate, 3.1 g of a photo polymerization initiator (Irgacure 907), 1.1 g of a photo-sensitizer (Kayacure DETX; made by Nihon Kayaku K.K.), 482.4 g of methyl ethyl ketone and 1869.8 g of cyclohexanone were added to 88.9 g of the dispersion of the above-described titanium dioxide, and the resulting mixture was stirred. After sufficient stirring, the mixture was filtered through a polypropylene-made filter of 0.4 μm in pore size to prepare a coating solution for a middle refractive index layer.

<2-4-4>

(Preparation of a Coating Solution for a High Refractive Index Layer)

47.9 g of a mixture (DPHA) of dipentaerythritol pentaacrylate and dipentaerythritol hexaacrylate, 4.0 g of a photo polymerization initiator (Irgacure 907; made by Nihon Ciba Geygy), 1.3 g of a photo-sensitizer (Kayacure DETX; made by Nihon Kayaku K.K.), 455.8 g of methyl ethyl ketone and 1427.8 g of cyclohexanone were added to 586.8 g of the dispersion of the above-described titanium dioxide, and the resulting mixture was stirred. The resultant mixture was filtered through a polypropylene-made filter of 0.4 μm in pore size to prepare a coating solution for a high refractive index layer.

<2-4-5>

(Preparation of a Coating Solution for a Low Refractive Index Layer)

A copolymer of the following structure was dissolved in methyl isobutyl ketone in a concentration of 7% by weight and 3% by weight (based on solids) of a terminal methacrylate group-containing silicone resin X-22-164C (manufactured by Shin-etsu Kagaku K.K.) and 5% by weight (based on solids) of a photo radical generator Irgacure 907 (trade name) were added thereto to prepare a coating solution for a low refractive index layer. 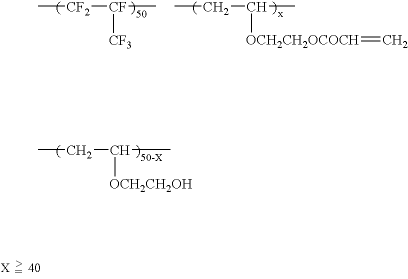
<2-4-6>
(Preparation of Transparent Protective Film 02 Having Anantireflective Layer)

A coating solution for a hard coat layer was coated on a 80-μm thick triacetyl cellulose film (TD-80UF; manufactured by Fuji Photo Film Co., Ltd.) using a gravure coater. After drying at 100° C., UV rays of 400 mW/cmμ in illuminance and 300 mJ/cm² in irradiation amount were irradiated to the coat using a 160 W/cm air-cooled metal halide lamp (made by EYE GRAPHICS Co., Ltd.) while purging with nitrogen so that concentration of oxygen in the atmosphere was kept at a level of 1.0% by volume or less to thereby cure the coat. Thus, there was formed an 8-μm thick hard coat layer.

On the hard coat layer were continuously coated the coating solution for a middle refractive index layer, the coating solution for a high refractive index layer and the coating solution for a low refractive index layer using a gravure coater having three coating stations.

Drying for the middle refractive index layer was conducted at 100° C. for 2 minutes, and UV curing was conducted with an illuminance of 400 mW/cm² and an irradiation amount of 400 mJ/cm² using an air-cooled 180 W/cm metal halide lamp (made by EYE GRAPHICS Co., Ltd.) while purging with nitrogen so that concentration of oxygen in the atmosphere was kept at a level of 1.0% by volume or less. The cured middle refractive index layer had a refractive index of 1.630 and a thickness of 67 nm.

Drying of both the high refractive index layer and the low refractive index layer was conducted at 90° C. for 1 minute, then at 100° C. for 1 minute, and UV curing was conducted with an illuminance of 600 mW/cm² and an irradiation amount of 600 mJ/cm² using an air-cooled 240 W/cm metal halide lamp (made by EYE GRAPHICS Co., Ltd.) while purging with nitrogen so that concentration of oxygen in the atmosphere was kept at a level of 1.0% by volume or less.

The cured high refractive index layer had a refractive index of 1.905 and a thickness of 107 mm, and the low refractive index layer had a refractive index of 1.440 and a thickness of 85 nm. Thus, there was prepared a transparent protective film 02 having anantireflective layer (corresponding to the functional film and TAC2 in FIG. 2 or TAC2-1 shown in FIG. 3).

<2-5-1>

(Preparation of Polarizing Plate-3)

Polarizing plates (C1 to C19; integrated with a functional layer and an optical compensatory film (FIG. 2)) were prepared in the same manner as in <2-3-1> except for using the transparent protective film 02 having the antireflective layer in place of the transparent protective layer 01 having the light-scattering layer. Also, a polarizing plate (C0) was prepared in the same manner comprising the transparent protective film 02 having the antireflective layer, the polarizer and a 80-μm thick triacetyl cellulose film (TAC-TD80U; manufactured by Fuji Photo Film Co., Ltd.) not having coated thereon the functional layer.

The spectral reflectivity at an incident angle of 5° was measured from the functional film side in the wavelength region of from 380 to 780 nm using a spectrophotometer (made by Nihon Bunko K.K.). Thus, the integrating-sphere average reflectivity in the range of from 450 to 650 nm was determined to be 0.4%.

### Example 3

(Mounting on a Panel)

### Example 3-1

(Mounting on a VA Panel) (One-Sheet Type)

A liquid crystal display shown in FIG. 3 was prepared. That is, an upper polarizing plate (comprising TAC2-1 (having or not having a functional film), a polarizer, and TAC1-1), a VA mode liquid crystal cell and a lower polarizing plate (comprising TAC-1-2, a polarizer and TAC-2-2) were superposed in this order from the viewing side (upper side) and, further, a backlight source was provided. In the following embodiment, a commercially available polarizing plate (HLC2-5618) was used as the upper polarizing plate, and a polarizing plate integrated with an optical compensatory film was used as the lower polarizing plate. However, a reversely disposed device involves no functional problems. In view of production yield, however, the integrated polarizing plate used as the lower polarizing plate can provide a higher production yield (because, when used as the upper polarizing plate, it is necessary to provide the functional film on the viewing side (upper side), which would lead to reduction in production yield). Thus, in a preferred embodiment, the integrated polarizing plate is used as the lower polarizing plate.

<Preparation of Liquid Crystal Cell>

A liquid crystal cell was prepared by dropwise adding liquid crystal material (NC6608; made by Merck) having a negative dielectric constant anisotropy to a space formed between substrates held with a cell gap of 3.6 μm, and sealing the cell to form a liquid crystal layer between the substrates. The retardation of the liquid crystal layer (i.e., the product between the thickness of the liquid crystal layer d (smu) and the refractivity index anisotropy Δn, Δn·d) was adjusted to 300 nm. Additionally, the liquid crystal material was aligned in a vertical alignment.

As the upper polarizing plate (on the viewer's side) for the liquid crystal display (FIG. 3) using the vertical alignment type liquid crystal cell, a commercially available super-high contrast product (e.g., HLC2-5618; manufactured by San Ritz) was used. As the lower polarizing plate (on the backlight side), the polarizing plate (A4, A5, or A8) prepared in Example 2, <2-1-1>, using the optical compensatory sheet (F4, F5, or F8) prepared in Example 1 was disposed so that the cellulose acylate film (corresponding to TAC1-2 shown in FIG. 3) prepared in Example 1 faced the liquid crystal side. The upper polarizing plate and the lower polarizing plate were respectively superposed onto the liquid crystal cell via an adhesive. The two plates were disposed in a cross-Nicol position wherein the transmission axis of the upper polarizing plate was in the vertical direction and the transmission axis of the lower polarizing plate was in the horizontal direction. As the polarizing plates for preparing the liquid crystal displays, two samples were prepared for each plate: one having previously been stored in a state sealed in a moisture-proofed bag after being moisture-conditioned for 2 hours at 25° C. and 60% RH; the other being sealed in the bag without being moisture-conditioned.

Additionally, a commercially available product was used as the upper polarizing plate, and the integrated polarizing plate of the invention was used as the lower polarizing plate and, as a result of observing the thus prepared liquid crystal displays, it was found that neutral black display was realized in both the front direction and the viewing angle direction. Also, the viewing angle (scope wherein gradation reversal does not take place on the black side when the contrast ratio is 10 or more) was measured in 8 steps of from black display (L1) to white display (L8) by using a measuring machine (EZ-Contrast 160D; made by ELDIM Co.).

Next, color tone of the liquid crystal display screen was measured when the screen displayed black color in the direction of 45° in terms of bearing angle based on the horizontal direction of the screen and in the direction of 60° in terms of polar angle based on the normal direction of the screen using a measuring machine (EZ-Contrast 160D; made by ELDIM Co.) to obtain initial values. Subsequently, this panel was allowed to stand for 1 week in a room of ordinary temperature and ordinary humidity (about 25° C. and 60% RH without humidity control), and the color tone upon black color display was again measured.

Results of the measurement of viewing angle and change in color tone are shown in the following Table 3. All of the samples of the Example showed a wide viewing angle and less change in color tone. The polarizing plates having been subjected to humidity conditioning before assembling the liquid crystal display suffered particularly less change in color tone.

### Example 3-2

As the lower polarizing plated in the liquid crystal display (FIG. 3) wherein the above-mentioned vertical alignment type liquid crystal cell was used, each of the polarizing plates (A4, A5, or A8) prepared in Example 2 by using each of the optical compensatory sheets (F4, F5 or F8) was superposed onto the cell via an adhesive and, as the upper polarizing plate, the polarizing plate (B0) prepared in Example 2, <2-3-1> was laminated via the adhesive. The plates were disposed in the cross-Nicol position wherein the transmission axis of the polarizing plate on the viewer's side was in the vertical direction and the transmission axis of the polarizing plate on the back light side was in the horizontal direction. In this occasion, the working area was air-conditioned so that the temperature was from 20 to 25° C. and the humidity was from 50 to 70% RH. As the polarizing plates to be used, both the plate having been stored in the moisture-proofed bag after being moisture-conditioned at 25° C. and 60% RH for 2 hours and the plate having been stored in the bag without moisture conditioning were used to prepare liquid crystal displays.

Observation of the thus prepared liquid crystal displays revealed that neutral black display was realized in the front direction and the viewing angle direction. Also, like in Example 3-1, the viewing angle and the change in color tone were measured, and the results are shown in Table 3.

### Example 3-3

As the lower polarizing plated in the liquid crystal display (FIG. 3) wherein the above-mentioned vertical alignment type liquid crystal cell was used, each of the polarizing plates (A4, A5 or A8) prepared in Example 2 by using each of the optical compensatory sheets (F4, F5 or F8) prepared in Example 1 was superposed onto the cell via an adhesive and, as the upper polarizing plate, the polarizing plate (C0) prepared in Example 2, <2-5-1> was laminated via the adhesive. The plates were disposed in the cross-Nicol position wherein the transmission axis of the polarizing plate on the viewer's side was in the vertical direction and the transmission axis of the polarizing plate on the back light side was in the horizontal direction. In this occasion, the working area was air-conditioned so that the temperature was from 20 to 25° C. and the humidity was from 50 to 70% RH. As the polarizing plates to be used, both the plate having been stored in the moisture-proofed bag after being moisture-conditioned at 25° C. and 60% RH for 2 hours and the plate having been stored in the bag without moisture conditioning were used to prepare liquid crystal displays.

Observation of the thus prepared liquid crystal displays revealed that neutral black display was realized in the front direction and the viewing angle direction. Also, like in Example 3-1, the viewing angle and the change in color tone were measured, and the results are shown in Table 3.

### Comparative Example 3-1

The same procedures as in Example 3-1 were conducted except for using A19, B19 or C19 as the lower polarizing plate in Example 3-1. Additionally, the polarizing plates used here had not been moisture-conditioned.

Observation of the thus prepared liquid crystal displays revealed that neutral black display was realized in the front direction and the viewing angle direction. Also, like in Example 3-1, the viewing angle and the change in color tone were measured, and the results are shown in Table 3.

TABLE 3

| | Viewing Angle | | |
|---|---|---|---|
| | | Direction | |
| | | 45° Off The | Change in Color Tone of |
| Liquid crystal | Transmission | Transmission | Black 1 Week After |
| display | Axis Direction | Axis | Assembly (ΔE*) |
| Example 3-1 | >80° | >80° | 0.010 to 0.013 (without |
| | | | moisture conditioning) |
| | | | 0.001 (with moisture |
| | | | conditioning) |
| Example 3-2 | ″ | ″ | 0.010 to 0.013 (without |
| | | | moisture conditioning) |
| | | | 0.001 (with moisture |
| | | | conditioning) |
| Example 3-3 | ″ | ″ | 0.010 to 0.013 (without |
| | | | moisture conditioning) |
| | | | 0.001 (with moisture |
| | | | conditioning) |
| Comparative | >80° | >80° | 0.020 to 0.032 (without |
| Example 3-1 | | | moisture conditioning) |

### Example 3-4

(Mounting on a VA Panel) (Two-Sheet Type)

A liquid crystal display shown in FIG. 3 was prepared. That is, an upper polarizing plate (comprising TAC2-1 (not having a functional film), a polarizer, and TAC1-1), a VA mode liquid crystal cell and a lower polarizing plate (comprising TAC1-2, a polarizer and TAC2-2) were superposed in this order from the viewing side (upper side) and, further, a backlight source was provided.

<Preparation of Liquid Crystal Cell>

A liquid crystal cell was prepared by dropwise adding liquid crystal material (MLC6608; made by Merck) having a negative dielectric constant anisotropy to a space formed between substrates held with a cell gap of 3.6 μm, and sealing the cell to form a liquid crystal layer between the substrates. The retardation of the liquid crystal layer (i.e., the product between the thickness of the liquid crystal layer d (μm) and the refractivity index anisotropy Δn, Δn·d) was adjusted to 300 nm. Additionally, the liquid crystal material was aligned in a vertical alignment.

As the upper and lower polarizing plates for the liquid crystal display (FIG. 3) using the vertical alignment type liquid crystal cell, the polarizing plates (A1, A10 or A16) prepared in Example 2, <2-1-1>, using the optical compensatory sheets (F11, F10 or F16) prepared in Example 1 were superposed onto the cell via an adhesive, with one plate on the viewer's side and one plate on the back light side, so that the cellulose acylate film (corresponding to TAC1-1 and TAC1-2 shown in FIG. 3) prepared in Example 1 faced the liquid crystal side. The polarizing plate on the viewer's side and the polarizing plate on the backlight side were disposed in a cross-Nicol position wherein the transmission axis of the polarizing plate on the viewer's side was in the vertical direction and the transmission axis of the polarizing plate on the backlight side was in the horizontal direction. In this occasion, the working area was air-conditioned so that the temperature was from 20 to 25° C. and the humidity was from 50 to 70% RH. As the polarizing plates for preparing the liquid crystal displays, two samples were prepared for each plate: one having previously been stored in a state sealed in a moisture-proofed bag after being moisture-conditioned for 2 hours at 25° C. and 60% RH; the other having been stored in a state of being sealed in the bag without being moisture-conditioned.

As a result of observing the thus prepared liquid crystal displays, it was found that neutral black display was realized in both the front direction and the viewing angle direction. Also, the viewing angle (scope wherein gradation reversal does not take place on the black side when the contrast ratio is 10 or more) was measured in 8 steps of from black display (L1) to white display (L8) by using a measuring machine (EZ-Contrast 160D; made by ELDIM Co.).

Next, color tone of the liquid crystal display screen was measured when the screen displayed black color in the direction of 45° in terms of bearing angle based on the horizontal direction of the screen and in the direction of 60° in terms of polar angle based on the normal direction of the screen using a measuring machine (EZ-Contrast 160D; made by ELDIM Co.) to obtain initial values. Subsequently, this panel was allowed to stand for 1 week in a room of ordinary temperature and ordinary humidity (about 25° C. and 60% RH without humidity control), and the color tone upon black color display was again measured.

Results of the measurement of viewing angle and change in color tone are shown in the following Table 4. All of the samples of the Example showed a wide viewing angle and less change in color tone. The polarizing plates having been subjected to humidity conditioning before assembling the liquid crystal display suffered particularly less change in color tone.

### Comparative Example 3-2

As the upper and lower polarizing plates for the liquid crystal display (FIG. 3) using the vertical alignment type liquid crystal cell, the polarizing plates (A3 or A17) prepared in Example 2, <2-1-1>, using the optical compensatory sheets (F3 or F17) prepared in Comparative Example were superposed onto the cell via an adhesive, with one plate on the upper side and one plate on the lower side, so that the cellulose acylate film (TAC1) prepared in Example 1 faced the liquid crystal side. The polarizing plate on the upper side and the polarizing plate on the lower side were disposed in a cross-Nicol position wherein the transmission axis of the polarizing plate on the upper side was in the vertical direction and the transmission axis of the polarizing plate on the lower side was in the horizontal direction.

In this occasion, the working area was air-conditioned so that the temperature was from 20 to 25° C. and the humidity was from 50 to 70% RH. Additionally, the polarizing plates used here had not been moisture-conditioned.

### Comparative Example 3-3

As the lower polarizing plate for the liquid crystal display (FIG. 3) using the vertical alignment type liquid crystal cell, the polarizing plates (A3 or A17) prepared in Example 2, <2-1-1>, using the optical compensatory sheets (F3 or F17) prepared in Example 1 were superposed onto the cell via an adhesive and, as the upper polarizing plate, the polarizing plate (B3 or B17) prepared in Example 2, <2-3-1> was superposed onto the cell via an adhesive so that the cellulose acylate film (TAC1) prepared in Example 1 faced the liquid crystal side. The polarizing plate on the upper side and the polarizing plate on the lower side were disposed in a cross-Nicol position wherein the transmission axis of the polarizing plate on the upper side was in the vertical direction and the transmission axis of the polarizing plate on the lower side was in the horizontal direction.

In this occasion, the working area was air-conditioned so that the temperature was from 20 to 25° C. and the humidity was from 50 to 70% RH. Additionally, the polarizing plates used here had not been moisture-conditioned.

### Comparative Example 3-4

As the lower polarizing plate for the liquid crystal display (FIG. 3) using the vertical alignment type liquid crystal cell, the polarizing plates (A3 or A17) prepared in Example 2, <2-1-1>, using the optical compensatory sheets (F3 or F17) prepared in Example 1 were superposed onto the cell via an adhesive and, as the upper polarizing plate, the polarizing plate (C3 or C17) prepared in Example 2, <2-3-1> was laminated onto the cell via an adhesive so that the cellulose acylate film (TAC1) prepared in Example 1 faced the liquid crystal side. The polarizing plate on the upper side and the polarizing plate on the lower side were disposed in a cross-Nicol position wherein the transmission axis of the polarizing plate on the upper side was in the vertical direction and the transmission axis of the polarizing plate on the lower side was in the horizontal direction.

In this occasion, the working area was air-conditioned so that the temperature was from 20 to 25° C. and the humidity was from 50 to 70% RH. Additionally, the polarizing plates used here had not been moisture-conditioned.

Results are shown in Table 4. In comparison with the case of using the polarizing plate of the invention, the samples of using the polarizing plates of these Comparative Examples suffered change in color tone.

TABLE 4

| | Viewing Angle | | |
|---|---|---|---|
| | | Direction | |
| | | 45° Off The | Change in Color Tone of |
| Liquid crystal | Transmission | Transmission | Black 1 Week After |
| display | Axis Direction | Axis | Assembly (ΔE*) |
| Example 3-4 | >80° | >80° | 0.010 to 0.013 (without |
| | | | moisture conditioning) |
| | | | 0.002 (with moisture |
| | | | conditioning) |
| Comparative | >80° | >80° | 0.020 to 0.032 (without |
| Example 3-2 | | | moisture conditioning) |
| Comparative | >80° | >80° | 0.020 to 0.032 (without |
| Example 3-3 | | | moisture conditioning) |
| Comparative | >80° | >80° | 0.020 to 0.032 (without |
| Example 3-4 | | | moisture conditioning) |

It will be apparent to those skilled in the art that various modifications and variations can be made to the described preferred embodiments of the invention without departing from the spirit or scope of the invention. Thus, it is intended that the present invention cover all modifications and variations of this invention consistent with the scope of the appended claims and their equivalents.

This application is based on Japanese Patent Application Nos. JP2004-49142 and JP2004-175077, filed on Feb. 25, 2004 and Jun. 14, 2004, respectively, the contents of which is incorporated herein by reference.

### INDUSTRIAL APPLICABILITY

An polarizing plate according to the present invention can be used as liquid crystal display which undergoes less change in viewing angle characteristics.

1. A cellulose acylate film, which comprises a cellulose acylate having a glucose unit of cellulose, wherein a hydroxyl group of the glucose unit is substituted by an acyl group having 2 or more carbon atoms,
wherein
DS2, DS3 and DS6 respectively representing degrees of substitution of the hydroxyl groups at 2, 3 and 6 positions of the glucose unit by the acyl group satisfy formulae (I) and (II); and
Re(λ) and Rth(λ) defined by formulae (III) and (IV) satisfy formulae (V) and (VI):
2.00≦DS2+DS3+DS6≦3.00 (I)
DS6/(DS2+DS3+DS6)≧0.315 (II)
Re(λ)=(nx−ny)×d (III)
Rth(λ)={(nx+ny)/2−nz}×d (IV)
46≦Re(630)≦200 (V)
70≦Rth(630)≦350 (VI)
wherein Re(λ) represents a retardation value by nm in a film plane of the cellulose acylate film with respect to a light having a wavelength of λ nm;
Rth(λ) represents a retardation value by nm in a direction perpendicular to the film plane of the cellulose acylate film with respect to the light having the wavelength of λ nm;
nx is a refractive index in a slow axis direction in the film plane;
ny is a refractive index in a fast axis direction in the film plane;
nz is a refractive index in the direction perpendicular to the film plane; and
d is a thickness of the cellulose acylate film.

2. The cellulose acylate film according to claim 1, wherein Rth(λ) satisfies formula (VII):
160≦Rth(630)≦350 (VII)

3. The cellulose acylate film according to claim 1, wherein the acyl group is an acetyl group.

4. The cellulose acylate film according to claim 1, which comprises a retardation-producing agent comprising one of a rod-like compound and a discotic compound.

5. The cellulose acylate film according to claim 1, which comprises at least one of a plasticizer, an ultraviolet ray absorbent and a peeling accelerator.

6. The cellulose acylate film according to claim 1, which has a thickness of from 40 to 110 μm.

7. The cellulose acylate film according to claim 1, which has an additive amount of from 10 to 30% by weight, the additive amount being based on a weight of the cellulose acylate.

8. The cellulose acylate film according to claim 1, which has ΔRe of 12 nm or less and ΔRth of 32 nm or less,
wherein ΔRe represents a difference between a Re value at 25° C. and 10% RH and another Re value at 25° C. and 80% RH, and
ΔRth represents a difference between a Rth value at 25° C. and 10% RH and another Rth value at 25° C. and 80% RH.

9. The cellulose acylate film according to claim 1, which has an equilibrium moisture content at 25° C. and 80% RH of 3.4% or less.

10. The cellulose acylate film according to claim 1, which has a water vapor permeability of from 400 g/m²·24 hr to 2,300 g/m²·24 hr in terms of a film thickness of 80 μm, the water vapor permeability being measured at 60° C. and 95% RH for 24 hours.

11. The cellulose acylate film according to claim 1, which undergoes change in weight of from 0 to 5% when allowed to stand for 48 hours under a condition of 80° C. and 90% RH.

12. The cellulose acylate film according to claim 1, which undergoes change in dimension of from −2 to 2% when allowed to stand for 24 hours each of a condition of 60° C. and 95% RH and another condition of 90° C. and 5% RH.

13. The cellulose acylate film according to claim 1, which has a glass transition temperature Tg of from 80 to 180° C.

14. The cellulose acylate film according to claim 1, which has an elastic modulus of from 1,500 to 5,000 MPa.

15. The cellulose acylate film according to claim 1, which has a photoelasticity coefficient of 50×10⁻¹³ cm²/dyne or less.

16. The cellulose acylate film according to claim 1, which has a haze of from 0.01 to 2%.

17. The cellulose acylate film according to claim 1, which comprises a silicon dioxide particle having a secondary average particle size of from 0.2 to 1.5 μm.

18. The cellulose acylate film according to claim 1, wherein Re₍₆₃₀₎ and Rth₍₆₃₀₎ at 25° C. and 60% RH satisfy formulae (A) to (C):
46≦Re₍₆₃₀₎≦100 (A)
Rth₍₆₃₀₎=a−5.9Re₍₆₃₀₎ (B)
580≦a≦670. (C)

19. The cellulose acylate film according to claim 1, wherein Re and Rth measured at 25° C. and 60% RH with respect to different wavelengths satisfy formulae (D) and (E):
0.90≦Rth₍₄₅₀₎/Rth₍₅₅₀₎≦1.10 and 0.90≦Rth₍₆₅₀₎/Rth₍₅₅₀₎≦1.10 (D)
0.90≦Rth₍₄₅₀₎/Rth₍₅₅₀₎≦1.10 and 0.90≦Rth₍₆₅₀₎/Rth₍₅₅₀₎≦1.10 (E)

20. A polarizing plate comprising:
a polarizer; and
a protective film comprising a cellulose acylate film according to claim 1.

21. The polarizing plate according to claim 20, which satisfies at least one of formulae (a) to (d):
40.0≦TT≦45.0 (a)
30.0≦PT≦40.0 (b)
CT≦2.0 (c)
95.0≦P (d)
wherein TT represents a single plate transmittance at 25° C. and 60% RH;
PT represents a parallel transmittance at 25° C. and 60% RH;
CT represents a cross transmittance at 25° C. and 60% RH; and
P represents a polarization degree at 25° C. and 60% RH.

22. The polarizing plate according to claim 20, which satisfies at least one of formulae (e) to (g):
CT₍₃₈₀₎≦2.0 (e)
CT₍₄₁₀₎≦0.1 (f)
CT₍₇₀₀₎≦0.5 (g)
wherein CT(λ) represents a cross transmittance at the wavelength of λ nm.

23. The polarizing plate according to claim 20, which satisfies at least one of formulae (j) and (k):
−6.0≦ΔCT≦6.0 (j)
−10.0≦ΔP≦0.0 (k)
wherein ΔCT and ΔP represents a change in cross transmittance and polarization degree, respectively, in a test that the polarizing plate is allowed to stand at 60° C. and 95% RH for 500 hours; and the change means a value calculated by subtracting a measurement value before the test from a measurement value after the test.

24. The polarizing plate according to claim 20, which comprises at least one of a hard coat layer, a glare-reducing layer and an antireflective layer.

25. The polarizing plate according to claim 20, which is packaged in a moisture-proofed bag, wherein the moisture-proofed bag has an internal humidity of from 43 to 70% RH at 25° C.

26. The polarizing plate according to claim 20, which is packaged in a moisture-proofed bag, wherein the moisture-proofed bag has a first humidity within a range of ±15% RH with respect to a second humidity, wherein the polarizing plate is superposed on a liquid crystal cell at the second humidity.

27. A liquid crystal display comprising:
a liquid crystal cell of OCB-mode or VA-mode; and
at least one of a cellulose acylate film according to claim 1.

28. The liquid crystal display according to claim 27, wherein the liquid crystal cell is a liquid crystal cell of VA-mode, and
the liquid crystal cell contains only one cellulose acylate film.

29. The liquid crystal display according to claim 27, which comprises a backlight,
wherein the liquid crystal cell is a liquid crystal cell of VA-mode, and
the at least one of the cellulose acylate film and the polarizing plate is between the liquid crystal cell and the backlight.
